(19) United States
(12) Patent Application Publication
(10) Pub. No.: US 2016/0260107 A1
(43) Pub. Date: Sep. 8, 2016

(54) Sales Management System

(71) Applicant: Nits Solutions, Inc., Farmington Hills, MI (US)

(72) Inventors: Sanjay Seth, Novi, MI (US); Neetu Seth, Novi, MI (US)

(73) Assignee: Nits Solutions, Inc., Farmington Hills, MI (US)

(21) Appl. No.: 15/060,770

(22) Filed: Mar. 4, 2016

Related U.S. Application Data
(60) Provisional application No. 62/128,617, filed on Mar. 5, 2015.

(51) Int. Cl. G06Q 30/02

(52) U.S. Cl. CPC G06Q 30/0201

(57) ABSTRACT

A method includes receiving a set of seller records, each seller record corresponding to one or more transactions between a seller and one or more customers. The method includes associating seller metrics with the seller records. Each seller metric includes a quantitative representation of transactions between the seller and the one or more customers. Each transaction includes selling at least one of a service or merchandise of the seller to a customer. The method includes receiving a report type defined as a parts report or a loyalty report. The method includes analyzing the seller records in the data store based on the report type, the seller metrics, and seller information in the data store; generating a report based on the report type and the seller metrics; and displaying the report on a display in communication with the data processing device.

### CROSS REFERENCE TO RELATED APPLICATIONS

This U.S. patent application claims priority under 35 U.S.C. §119(e) to U.S. Provisional Application 62/128,617, filed on Mar. 5, 2015, which is hereby incorporated by reference in its entirety.

### TECHNICAL FIELD

This disclosure relates to a sales management system for managing the wholesale of goods and merchandise to intermediate customers and individual purchases.

### BACKGROUND

Wholesaling or distributing goods or merchandise is the process of selling the goods or merchandise to retailers; industrial, commercial, institutional, or other professional business users; or to other wholesalers and related sub coordinated services. In other words, wholesaling or distributing is the sale of goods or merchandise to anyone other than the end-user or the consumer. In some examples, wholesalers or distributors sell the goods or merchandise to one layer of intermediary customers before reaching the end customer. In other examples, the wholesalers or distributors sell the goods or merchandise to multiple layers of intermediary customers before the goods or merchandise reach the end customer. Sometimes, the wholesalers monitor the goods being sold to the different intermediary customers. Maintaining a record of such information may be cumbersome and difficult due to the large amount of information.

### SUMMARY

An aspect of the disclosure provides a method for managing a sales management system. The method includes analyzing seller transactional data and displaying them on a display. The method also includes receiving, at a data processing device, a set of seller records. Each seller transactional data or seller record includes one or more transactions between a seller and one or more customers (e.g., transactional data). The method further includes storing, in a non-transitory data store in communication with the processing device, the seller transactional data. The method also includes associating seller metrics with the seller transactional data, each seller metric includes a quantitative representation of transactions between the seller and the one or more customers. Each transaction is associated with transactional information (including sales information and service information) and includes selling at least one of a service or merchandise (e.g., product, part, accessories) of the seller to a customer. The method further includes receiving, at the data processing device, a report type defined as a parts report or a loyalty report, the parts report associated with a number of merchandise sold by the seller to the one or more customers, the loyalty report associated with merchandise bought by the seller from a manager. The method further includes analyzing the seller transactional data in the data store, using the data processing device, based on the report type, the seller metrics, and seller information (e.g., internal seller data) in the data store. The method also includes generating, using the data processing device, a report based on the report type and the seller metrics. Finally, the method includes displaying the report on a display in communication with the data processing device.

Implementations of the disclosure may include one or more of the following optional features. In some implementations, the method includes receiving, at the processing device, a user name and a password; and authenticating the user name and password by comparing the user name and password with a user name and password previously stored in the data store. The method may also include determining a report type based on the user name and password.

The method may include grouping the seller records into modules. The modules are defined as categorizing seller records based on one or more metrics. In some implementations, the merchandise includes vehicles, vehicle parts, and vehicle accessories, and the seller is a vehicle dealership. The merchandise may be associated with one or more vehicle brands. In some examples, the method further includes analyzing the seller transactional data in the data store, using the data processing device based on one or more dimensions, the dimensions defined as data elements categorizing the seller metrics of the seller transactional data into non-overlapping regions.

In some implementations, the existing seller information (e.g., internal seller data) defines information associated with the seller. The existing seller information includes at least one of: seller master data including a seller name and a seller address; a seller purchase objective defining an amount of sales within a period of time; a part master file defining vehicle part numbers; a part item categories file; a seller purchases file defining purchases made by the seller from the manager; a seller vehicle-in-operation file defining a number of vehicles sold by the seller to customers that are on the road; an area and region master file defining area and region codes associated with seller locations; or a tactical segment master file defining merchandise classification. In some examples, the loyalty reports includes at least one of: a comparison of sales of a first seller and sales of a second seller during a time period, a region, or an area; a comparison of sales of a seller during a first time period and a second time period; or a comparison of sales of a seller of a first merchandise and a second merchandise. The parts report may include a total number of sales corresponding to at least one of: a period of time, a seller geographical region; or a specific brand.

Another aspect of the disclosure provides a system for managing a sales management system. The system includes a non-transitory data store and a data processing device. The data processing device is in communication with the data store and executes a set of instructions. The set of instructions cause the data processing device to receive a set of seller records, store the seller records in the data store and associate seller metrics with the seller records. Each seller record corresponds to one or more transactions between a seller and one or more customers. Each seller metric includes a quantitative representation of transactions between the seller and the one or more customers. Each transaction includes selling at least one of a service or merchandise of the seller to the customer. The data processing device further receives a report type defined as a parts report or a loyalty report, analyzes the seller records in the data store based on the report type, the seller metrics, and seller information in the data store, generates a report based on the report type and the seller metrics and displays the report on a display in communication with the data processing device. The part report is associated with a number of merchandise sold by the seller to the one or more customers. The loyalty report is associated with merchandise bought by the seller from a manager.

In some implementations the data processing device receives a user name and a password, authenticates the user name and password by comparing the user name and password with a previously stored user name and password and determines a report type based on the user name and password. The data processing device may group the seller records into modules, with the modules defined as categorizing seller records based on one or more metrics. In some examples, the merchandise includes vehicles, vehicle parts, and vehicle accessories, and the seller is a vehicle dealership. Additionally or alternatively, the merchandise is associated with one or more vehicle brands.

In some examples, the data processing device analyzes the seller records in the data store, using the data processing device based on one or more dimensions, the dimensions defined as data elements categorizing the seller metrics of the seller records into non-overlapping regions. The seller information may define information associated with the seller. The seller information may include at least one of a seller master data defining one or more seller information including a seller name and a seller address, a seller purchase objective defining an amount of sales within a period of time and a part master file defining vehicle part numbers and a part item categories file. The seller information may further include a seller purchases file defining purchases made by the seller from the manager, seller vehicle-in-operation file defining a number of vehicles sold by the seller to customers that are on the road, area and region master filing defining area and region codes associated with seller locations or a tactical segment master file defining merchandise classification.

In some implementations, the loyalty report includes at least one of a comparison of sales of a first seller and sales of a second seller during a period of time, a region, or an area. The loyalty report may further include a comparison of sales of a seller during a first time period and a second time period or a comparison of sales of a seller of a first merchandise and a second merchandise. In some examples, the parts report includes a total number of sales corresponding to at least one of a period of time, a seller geographical region or a specific brand.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary sales management system.

FIGS. 2A-2C are schematic views of an exemplary sales management system.

FIG. 3 is a schematic view of an exemplary analyzer of the sales management system.

FIG. 4 is a schematic view of an exemplary arrangement of operations for a user logging in to the sales management system.

FIGS. 5A-5C are schematic views of exemplary views showing a result set.

FIG. 5D is a schematic view of example sales trends.

FIG. 6 is a schematic view of an exemplary sales management system.

FIG. 7 is a schematic view of an exemplary arrangement of operations for managing customer records.

Like reference symbols in the various drawings indicate like elements.

### DETAILED DESCRIPTION

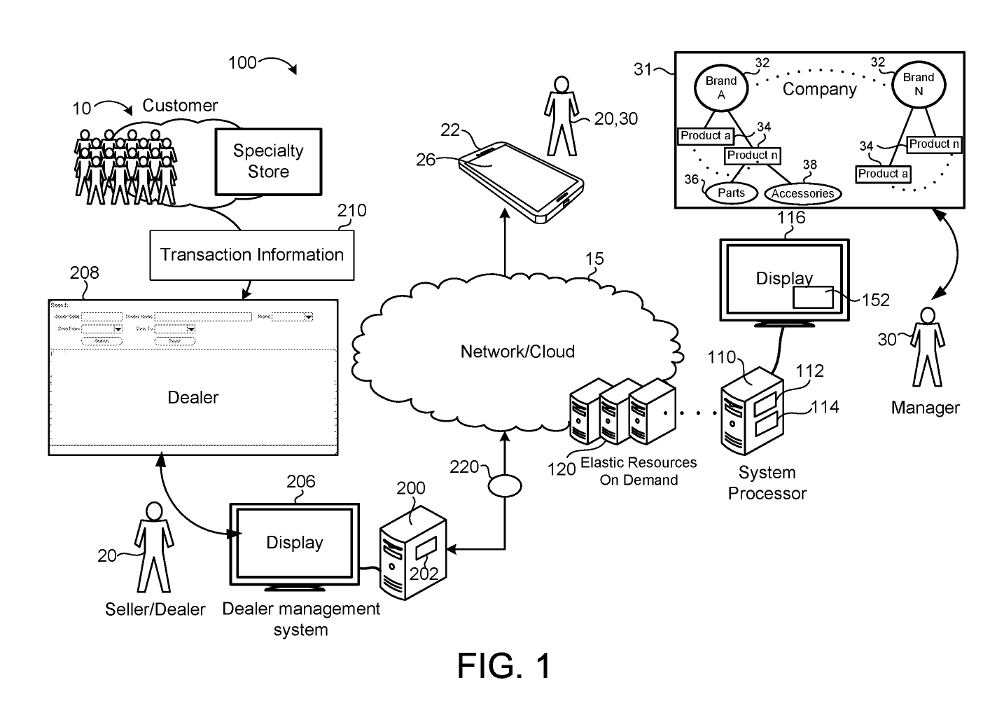

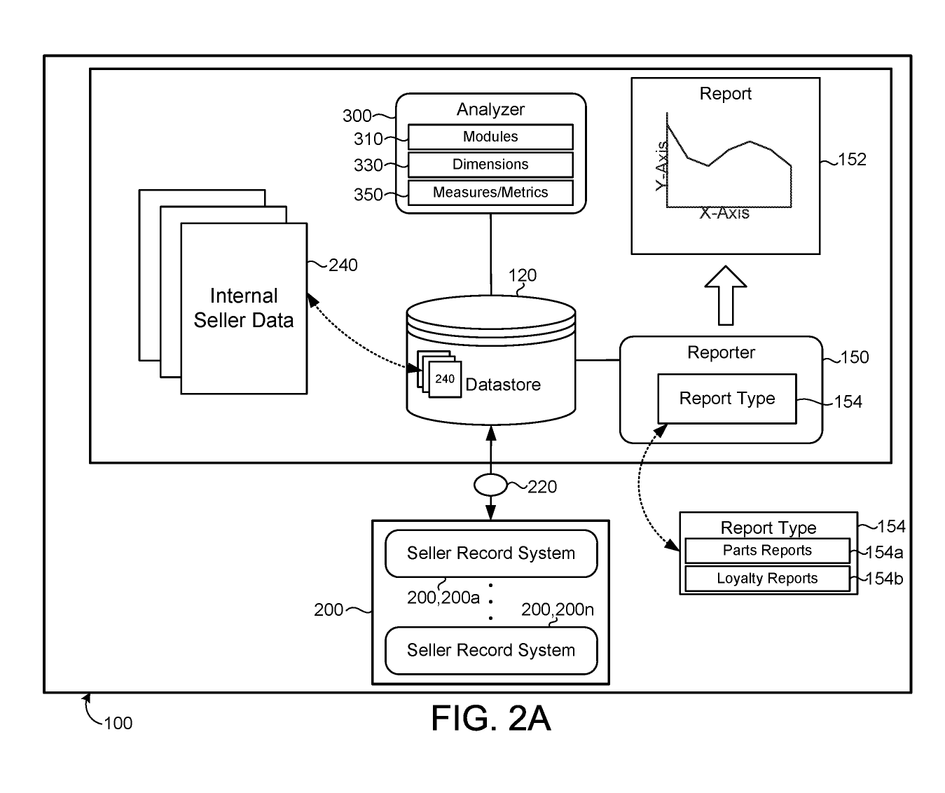

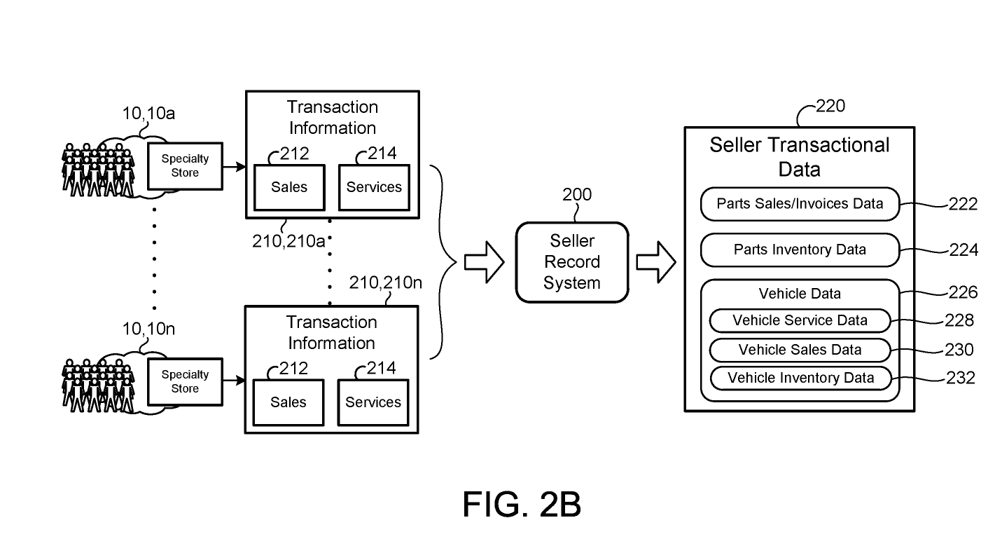

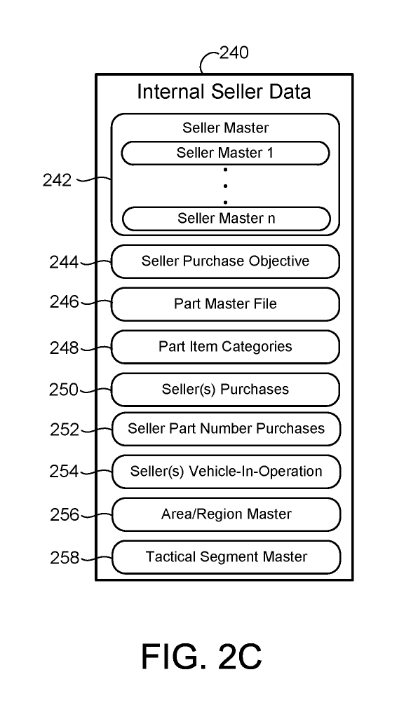

Referring to FIGS. 1-2C, in some implementations, a system 100 organizes purchases and services made by customers 10 from a seller 20 (e.g., a dealer) so that a manager 30 (e.g., wholesale or company) can monitor transactions between the seller 20 and customers 10 relating to the goods/merchandise 31 provided by the manager 30 to the seller 20. The customer 10 may be an individual purchaser or a specialty shop. The system 100 retrieves information from one or more sellers 20 relating to purchases by customers 10 and services performed by sellers 20 and organizes the retrieved information. The system 100 analyzes the information and reports that information to a user (e.g., the manager 30 and/or the one or more sellers 20) based on a specific report type 154. The system 100 can receive information pertaining to customers 10 from the seller 20 (via a seller display 206) and store the information in a master data store 120, which may include other information to the customers 10. The system allows: customer segmentation and filtering; reporting and tracking of sales and services; turnkey and inventory support; identifying new growth opportunities at the seller 20 relating to specific purchases and/or services; and viewing the growth opportunities via reports 152. The system 100 may process data received from the seller 20 and the manager 30 continuously, providing information accurate as of the moment retrieved. In some examples, the system 100 processes the received data on daily, weekly, monthly, or a custom period of time. The system 100 may be used by the seller 20 or the manager 30 or any other user 20, 30 to gain a quantitative understanding of sales and services provided by the seller 20 and to identify growth areas of sales and services. In some examples, the manager 30 provides the seller(s) 20 with more than one brand 32 of a product 34. For example, if the manager 30 is a vehicle company, the manager 30 may provide the seller 20 with different brands 32 of vehicles associated with the company (e.g., Brand A, Brand B, etc.). In such cases, the specific types 154 of reports 152 may depend on the specific brand 32. In some examples, the managers 30 provide the sellers 20 with a product 34 (e.g., a vehicle), a part 36 of the product 34 (e.g., product replacement part, such as an engine, windshield wipers, or any other parts relating the vehicle), and accessories 38 (e.g., bike rack vehicle attachment, or any other vehicle part that is not essential for the function of the vehicle). As used herein, a good 34, 36, 38 refers to any one or all of the items sold by the manager 30 to the seller 20, such as products 34, parts 36, and accessories 38.

The system 100 retrieves transactional information 210 (including sales information 212 and service information 214) from one or more sellers 20 and analyzes transactional information 210 based on each one of its individual sellers 20, or a combination of multiple sellers 20. Moreover, the system 100 may analyze the sales 212 and services 214 based on specific goods 31, brands 32, products 34, parts 36, or accessories 38, or a combination thereof, sold or based on a specific service 214 rendered by the seller 20 to the customer 10. For example, if a manager 30 (e.g., company) sells automotive parts 36 to a seller 20 (e.g., car dealership having a car service division) who in turn sells the automotive parts to customers 10, and in some cases services the vehicle to install and/or repair the part, the system 100 facilitates tracking and analyzing the transactions made between the seller 20 and the customer 10. Therefore, the system 100 can track which of its sellers 20 is selling the most products 34, parts 36, and accessories 38 and to whom (i.e., individual seller or specialty store) and which good 31 among all the sellers 20 is being purchased the most or the least. Although most of the description relates to an automotive wholesale manager 30, an automotive seller 20, such as an automotive dealer selling products 34 (e.g., vehicles), parts 36 (e.g., automotive parts), and accessories 38 (e.g., automotive accessories) based on different brands 32, and a customer 10 buying the automotive parts (as an individual or for resale), the system 100 may be applied to any customers 10 buying from a seller 20, who is in turn buying from a manager 30 or being managed by a wholesaler 30. Therefore, the system 100 may be applied to any goods or services sold having a middle man (i.e., the seller 20).

The system 100 includes one or more data processing devices 110 (e.g., computing device) having a non-transitory memory 112. The one or more data processing devices 110 execute a software application 114 configured to receive the seller transactional data or seller record(s) 220 and provide a report 152 to a user 20, 30. A software application 114 (i.e., a software resource) may refer to computer software that causes a computing device to perform a task. In some examples, a software application is referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The system 100 includes a data store 120 (e.g., non-transitory memory) in communication with the one or more sellers 20 via a network 15. The data store 120 stores seller transactional data 220 that include transaction information 210 received from multiple sellers 20. Non-transitory memory 112, 120 may be physical devices used to store programs (e.g., sequences of instructions) or data (e.g., program state information) on a temporary or permanent basis for use by a computing device 110. The non-transitory memory 112, 120 may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The network 15 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The network 15 may include one or more of a Wide Area Network (WAN), a Local Area Network (LAN), and a Personal Area Network (PAN). In some examples, the network 15 includes a combination of data networks, telecommunication networks, and a combination of data and telecommunication networks. In some examples, the network 15 provides access to cloud computing resources, which may be elastic/on-demand computing and/or storage resources available over the network 15. The term ‘cloud’ services generally refers to a service performed not locally on a user's device, but rather delivered from one or more remote devices accessible via one or more networks 15.

Referring to FIGS. 1 and 2B, in some examples, to accumulate the transaction information 210, each seller 20 has a seller management system 200 that allows the seller 20 to collect transaction information 210 and generate seller transactional data 220 that includes all the received transaction information 210. The seller 20 interacts with multiple individual customers 10 purchasing a good 31 or service from the seller 20. The seller 20 is the seller or provider of a good 31 or service, and the customer 10 purchases goods or services from the seller 20. The seller transactional data 220 includes an aggregation of all the information collected from each individual customer 10. The seller management system 200 is a system data processor (e.g., computing device) having non-transitory memory 202. The seller management system 200 includes a customer display 206 for displaying a customer interface 208 that allows the seller 20 to input transaction information 210 of customers 10. The transaction information 210 that may be entered in the seller management system 200 and stored in the non-transitory memory 202 of the seller management system 200 (retrieved by the data store 120 or periodically sent to the data store) may include a purchaser name, address, phone number, date of service or purchase, good 31, brand 32, product 34, part 36, or accessory 38 purchased, type of service rendered, or any other information. In some examples, the customer display 206 is in communication with the seller management system 200 and displays the interactive report 152 generated by the reporter 150. The display 206 may be a part of a handheld device 22 or a display wirelessly or non-wirelessly connected to the seller management system 200. In some examples, certain portions of the report are only available to one or the other of the handheld device 22 or the wirelessly connected display 116, 206.

The data store 120 receives seller transactional data 220 from the seller(s) 20. In some examples, the data store 120 continuously receives the seller transactional data 220, while in other examples, the data store 120 periodically receives the seller transactional data 220, where periodically may refer to any period of time interval. In some examples, the seller data includes parts invoice data 222, parts inventory data 224, and vehicle data 226 (e.g., vehicle service data 228, vehicle sales data 230, and vehicle inventory data 232). The system 100 may be flexible to accommodate more or less data included in the seller transactional data 220. The seller transactional data 220 may be a pipe delimited flat file, a comma delimited flat file, a comma-separated values (CSV) file, an extensible markup language file (xml), or any other file type capable of being received by the data store 120.

Table 1 below provides seller transactional data 220, such as the parts sales/invoices data 222 that includes detail information of goods 31 sold by the seller 20 to the customer 10, and a merchandise number level (i.e., each good sold includes product). As shown, Table 1 provides details on seller's (e.g., dealership's) wholesale customer sales including counter, body shop and repair shops. In some examples, the seller transactional data 220 provided in Table 1 is sent to the data store 120 daily.

TABLE 1
Parts Sales/Invoices Data 222

| Field Name | Definition |
|---|---|
| Dealer ID | Unique Dealer Identification Number |
| Invoice Number | A unique alphanumeric identifier assigned to each |
| | merchandise (including, but not limited to, vehicle, |
| | parts, and accessories) invoice record within a |
| | dealership. |
| Repair Order | The Repair Order (RO) Number of the service record |
| Number | tied to the merchandise invoice. |
| Total Cost | The total cost of the merchandise on the invoice. This |
| | field is calculated as the sum of the Net Cost amounts |
| | for all line items. |
| Total List Price | The total list price for all line items listed on the |
| | invoice. This field is calculated as the sum of the Net |
| | List Price amounts for all line items. |
| Total Price | The total selling price for all line items listed on the |
| | invoice. This field is calculated as the sum of the Net |
| | Price amounts for all line items. |
| Total Core Cost | The total core cost of all line items listed on the |
| | invoice. This field is calculated as the sum of the Net |
| | Core Cost amounts for all line items. |
| Total Core Price | The core selling price for a single unit of each core |
| | part on an invoice. If the dealer management system |
| | (DMS) (e.g., seller management system) value is null, |
| | this field is calculated as the Net Core Price divided by |
| | the Core Quantity. |
| Total Tax | The total tax of all line items on the invoice. This field |
| | is calculated as the sum of the Net Tax amounts for all |
| | line items plus the invoice-level Invoice Tax amount. |
| Total | The total miscellaneous charges for all line items listed |
| Miscellaneous | on the invoice. This field is calculated as the sum of |
| | the Net Miscellaneous amounts for all line items plus |
| | the invoice-level Invoice Misc. amount. |
| Total Freight | The total freight charges for all line items listed on the |
| | invoice. This field is calculated as the sum of the Net |
| | Freight amounts for all line items plus the invoice- |
| | level Invoice Freight amount. |
| Total Restock | The total restock charges for all line items listed on the |
| | invoice. This field is calculated as the sum of the Net |
| | Restock amounts for all line items plus the invoice- |
| | level Invoice Restock amount. |
| Total Net | The total of all net charges for each line item contained |
| | on a part invoice record. This field is calculated as the |
| | sum of the Net Total amounts for all line items. |
| Total Invoice | The grand total charged on the invoice. This field is |
| | calculated as the sum of the Total Net, Invoice Tax, |
| | Invoice Miscellaneous, Invoice Freight, and Invoice |
| | Restock amounts. |
| Invoice Tax | The total tax charges applicable to the invoice that are |
| | over and above the tax charges applied at the line-item |
| | level. |
| Invoice | The total of miscellaneous charges on the invoice that |
| Miscellaneous | are over and above the miscellaneous charges applied |
| | at the line-item level. |
| Invoice Freight | The total of any freight charges applicable to the |
| | invoice that are over and above the freight charges |
| | applied at the line-item level. |
| Invoice Restock | The total of any restocking charges applicable to the |
| | invoice that are over and above the restocking charges |
| | applied at the line-item level. |
| Payment | The method(s) of payment on the invoice, up to three |
| Methods— | (3) of the following types: |
| multi-value field | Charge |
| | Credit Card |
| | Check |
| | Cash |
| | Other |
| | Pending |
| Account | The total of any restocking charges applicable to the |
| (Invoice-Level | invoice that are over and above the restocking charges |
| Value) | applied at the line-item level. |
| Invoice Open | The date that the invoice was opened. |
| Date | |
| Invoice Close | The date that the invoice was closed. |
| Date | |
| Transaction | The transaction type of the invoice, which is one of the |
| Type | following allowed values: |
| | Point Of Sale |
| | Repair Order |
| | Backorder |
| | Credit |
| | Return |
| | Repair internal |
| | Internal Parts |
| Retail/Wholesale | An indicator to determine whether the invoice is retail |
| Flag | or wholesale. The allowed values are: |
| | R (Retail) |
| | w (Wholesale) |
| | r (Internal) |
| | This information is placed at the invoice level, |
| | regardless of where it is acquired. In some cases, line- |
| | item flags will be used to set the invoice- level flag. If |
| | any line item is marked as wholesale, the entire invoice |
| | is designated as wholesale. |
| Ship Date | The date that a part on the invoice was shipped. |
| Shipping | The method by which a part on an invoice was |
| Method | shipped. |
| Parent Invoice | A related parent invoice number (if one exists). For |
| Number | instance, a Credit Memo is generally created to credit a |
| | previous sales invoice. The previous sale invoice |
| | would be the parent invoice. This may also be useful if |
| | ROs were handled separately from invoices in a DMS. |
| Billing Contact | The unique customer number associated with the |
| Customer | customer listed as the billing contact on the invoice. |
| Number | |
| Billing Contact | An indicator to determine whether the billing contact |
| Business/Person | on an invoice is an individual person or a |
| Flag | business/other entity. |
| Billing Contact | The first name of the billing contact. |
| First Name | |
| Billing Contact | The middle name of the billing contact. |
| Middle Name | |
| Billing Contact | The last name of the billing contact |
| Last Name | |
| Billing Contact | The full, first, middle, and/or last name of the billing |
| Full Customer | contact on the invoice, including any salutation, title, |
| Name | and suffix. |
| Billing Contact | The preferred salutation of the billing contact. |
| Salutation | |
| Billing Contact | The name suffix of the billing contact. |
| Suffix | |
| Billing Contact | The title of the billing contact. |
| Title | |
| Billing Contact | The name of the billing contact's company, if |
| Company Name | applicable and available. |
| Billing Contact | The name of the billing contact's department, if |
| Department | applicable and available. |
| Billing Contact | The customer's gender. The valid values are: |
| Gender | M = Male |
| | F = Female |
| Billing Contact | The customer's marital status. The valid values are: |
| Marital Status | M = Married |
| | s = Single |
| | o = Divorced |
| | w = Widowed |
| | P = Partnered |
| Billing Contact | The customer's billing street address. |
| Address | |
| Billing Contact | The customer's billing county, district, or parish. |
| District | |
| Billing Contact | The customer's billing city. |
| City | |
| Billing Contact | The customer's billing state, province, or region. |
| State | |
| Billing Contact | The customer's billing postal code or ZIP code. |
| Postal Code | |
| Billing Contact | The customer's billing country. |
| Country | |
| Billing Contact | The customer's home phone number. |
| Home Phone | |
| Number | |
| Billing Contact | The customer's home phone number extension |
| Home Phone | |
| Extension | |
| Billing Contact | The customer's country code for a home phone number |
| Home Phone | outside the United States. This is not currently being |
| Country Code | extracted for any dealers. |
| Billing Contact | The customer's work phone number. |
| Business Phone | |
| Number | |
| Billing Contact | The customer's business phone number extension |
| Business Phone | |
| Extension | |
| Billing Contact | The customer's country code for a business phone |
| Business Phone | number outside the United States. This is not currently |
| Country Code | being extracted for any dealers. |
| Billing Contact | The customer's personal email address. |
| Personal Email | |
| Address | |
| Billing Contact | The customer's business email address. |
| Business Email | |
| Address | |
| Billing Contact | A flag that indicates whether the customer allows |
| Allow | solicitation from the dealership. The allowed values |
| Solicitation | are: |
| | o = False (No) |
| | 1 = True (Yes) |
| Billing Contact | A flag that indicates whether the customer allows |
| Allow Phone | solicitation from the dealership via telephone. The |
| Solicitation | allowed values are: |
| | o = False (No) |
| | 1 = True (Yes) |
| Billing Contact | A flag that indicates whether the customer allows |
| Allow Email | solicitation from the dealership via email. The |
| Solicitation | allowed values are: |
| | o = False (No) |
| | 1 = True (Yes) |
| Billing Contact | A flag that indicates whether the customer allows |
| Allow Mail | solicitation from the dealership via mail. The |
| Solicitation | allowed values are: |
| | o = False (No) |
| | 1 = True (Yes) |
| Shipping | The unique customer number associated with the |
| Contact | customer listed as the shipping contact on the invoice. |
| Customer | |
| Number | |
| Shipping | An indicator to determine whether the shipping contact |
| Contact | on an invoice is an individual person or a |
| Business/Person | business/other entity. |
| Flag | |
| Shipping | The first name of the shipping contact. |
| Contact First | |
| Name | |
| Shipping | The middle name of the shipping contact. |
| Contact Middle | |
| Name | |
| Shipping | The last name of the shipping contact. |
| Contact Last | |
| Name | |
| Shipping | The full, first, middle, and/or last name of the shipping |
| Contact Full | contact on the invoice, including any salutation, title, |
| Customer Name | and suffix. |
| Shipping | The preferred salutation of the shipping contact. |
| Contact | |
| Salutation | |
| Shipping | The name suffix of the shipping contact. |
| Contact Suffix | |
| Shipping | The title of the shipping contact. |
| Contact Title | |
| Shipping | The name of the shipping contact's company, if |
| Contact | applicable and available. |
| Company Name | |
| Shipping | The name of the shipping contact's department, if |
| Contact | applicable and available. |
| Department | |
| Shipping | The customer's gender. The valid values are: |
| Contact Gender | M = Male |
| | F = Female |
| Shipping | The customer's marital status. The valid values are: |
| Contact Marital | M = Married |
| Status | s = Single |
| | o = Divorced |
| | w = Widowed |
| | P = Partnered |
| Shipping | The customer's shipping street address. |
| Contact Address | |
| Shipping | The customer's shipping county, district, or parish. |
| Contact District | |
| Shipping | The customer's shipping city. |
| Contact City | |
| Shipping | The customer's shipping state, province, or region. |
| Contact State | |
| Shipping | The customer's shipping postal code or ZIP code. |
| Contact Postal | |
| Code | |
| Shipping | The customer's shipping country. |
| Contact Country | |
| Shipping | The customer's home phone number. |
| Contact Home | |
| Phone Number | |
| Shipping | The customer's home phone number extension |
| Contact Home | |
| Phone Extension | |
| Shipping | The customer's country code for a home phone number |
| Contact Home | outside the United States. This is not currently being |
| Phone Country | extracted for any dealers. |
| Code | |
| Shipping | The customer's work phone number. |
| Contact | |
| Business Phone | |
| Number | |
| Shipping | The customer's business phone number extension |
| Contact | |
| Business Phone | |
| Extension | |
| Shipping | The customer's country code for a business phone |
| Contact | number outside the United States. This is not currently |
| Business Phone | being extracted for any dealers. |
| Country Code | |
| Shipping | The customer's personal email address. |
| Contact Personal | |
| Email Address | |
| Shipping | The customer's business email address. |
| Contact | |
| Business Email | |
| Address | |
| Shipping | An indicator to determine whether the customer has |
| Contact Tax | tax exempt status. This field references the status of |
| Exempt Status | the contact, not the status of the invoice. |
| Shipping | A flag that indicates whether the customer allows |
| Contact Allow | solicitation from the dealership. The allowed values |
| Solicitation | are: |
| | o = False (No) |
| | 1 = True (Yes) |
| Shipping | A flag that indicates whether the customer allows |
| Contact Allow | solicitation from the dealership via telephone. The |
| Phone | allowed values are: |
| Solicitation | o = False (No) |
| | 1 = True (Yes) |
| Shipping | A flag that indicates whether the customer allows |
| Contact Allow | solicitation from the dealership via email. The allowed |
| Email | values are: |
| Solicitation | o = False (No) |
| | 1 = True (Yes) |
| Shipping | A flag that indicates whether the customer allows |
| Contact Allow | solicitation from the dealership via mail. The allowed |
| Mail Solicitation | values are: |
| | o = False (No) |
| | 1 = True (Yes) |

Parts Invoice Line Items—multi-set, multi-value field that may include
one or more of the following fields:

| | |
|---|---|
| Part Number | The unique part number identifier for each part listed |
| | on the invoice. This is the processed number that has |
| | been cleaned and matched as well as possible to |
| | standard manufacturer part numbers. |
| Part Number | The unique part number identifier for each part listed |
| (DMS Value) | on the invoice as originally loaded from the DMS. |
| Part Description | The description of each part listed on the invoice. |
| Manufacturer | The manufacturer of each part on the invoice. This is |
| | the processed name that has been cleaned and matched |
| | as well as possible to standard manufacturer names. |
| Manufacturer | The manufacturer of each part on the invoice as |
| (DMS Value) | originally loaded from the DMS. |
| Source Code | The supplier code of each part on the invoice. |
| Source | The part source description (usually the supplier code) |
| Description | of each part on the invoice. |
| Account (Line- | OMS sale account recorded at time of sale for the |
| Item Value) | invoice as a whole. |
| Line Number | The invoice line item number for this item. |
| Quantity | The quantity of parts sold on this line item. A negative |
| | quantity indicates a return. |
| Core Quantity | The quantity of the given core part on a single line on |
| | an invoice. |
| Unit Cost | The cost for a single unit of each part on an invoice. If |
| | the DMS value is null, this field is calculated as the |
| | Net Cost divided by the Quantity. |
| Unit List Price | The list price for a single unit of each part on an |
| | invoice. If the DMS value is null, this field is |
| | calculated as the Net List Price divided by the |
| | Quantity. |
| Unit Price | The selling price for a single unit of each part on an |
| | invoice. If the DMS value is null, this field is |
| | calculated as the Net Price divided by the Quantity. |
| Unit Core Cost | The core cost for a single unit of each core part on an |
| | invoice. If the DMS value is null, this field is |
| | calculated as the Net Core Cost divided by the Core |
| | Quantity. |
| Unit Core Price | The core selling price for a single unit of each core |
| | part on an invoice. If the DMS value is null, this field |
| | is calculated as the Net Core Price divided by the Core |
| | Quantity. |
| Net Cost | The cost for the specified quantity of parts on this line. |
| | If the DMS value is null, this field is calculated as the |
| | Unit Cost multiplied by the Quantity. |
| Net List Price | The list price for the specified quantity of parts on this |
| | line. If the DMS value is null, this field is calculated as |
| | the Unit List Price multiplied by the Quantity. |
| Net Price | The selling price for the specified quantity of parts on |
| | this line. If the DMS value is null, this field is |
| | calculated as the Unit Price multiplied by the Quantity. |
| Net Core Cost | The core cost for the specified quantity of parts on this |
| | line. If the DMS value is null, this field is calculated as |
| | the Unit Core Cost multiplied by the Core Quantity. |
| Net Core Price | The core selling price for the specified quantity of |
| | parts on this line. If the DMS value is null, this field is |
| | calculated as the Unit Core Price multiplied by the |
| | Core Quantity. |
| Net Tax | The tax charged for this line item. |
| Net | The miscellaneous charges for this line item. |
| Miscellaneous | |
| Net Freight | The freight charged for this line item. |
| Net Restock | The restocking fees for this line item. |
| Net Total | The total of all net charges on this line item. If the |
| | DMS value is null, this field is calculated as the sum of |
| | the Net Core Price, Net Price, Net Tax, Net |
| | Miscellaneous, Net Freight, and Net Restock amounts. |
| Sold Date | The date this item was sold. |
| Return Code | DMS-specific code that indicates why an item was |
| | returned. |
| Employee ID | The unique employee number of the counterperson |
| Number | who sold the parts on the invoice. |
| Employee Full | The full name of the counterperson who sold the parts |
| Name | on the invoice. |

Table 2 provides seller transactional report(s) 220, such as the parts inventory data 224 that includes merchandise 31 stocked at the seller 20 (e.g., dealer) including, but not limited to, quantity on hand, lost sales, bin location, stocking status, and last sold date. In some examples, the data store 120 receives the parts inventory data 224 provided in Table 2, e.g., on a daily basis.

TABLE 2
Parts Inventory 224

| Field Name | Description |
|---|---|
| Dealer Number | Unique Dealer Identification Number |
| Dealer Country | Country in which dealer operates |
| Creation Date Time | Date and time when document was created |
| Destination Name Code | Brand of dealer |
| Document Date Time | Effective date and time of data. |
| Inventory Type | Full |
| Item Id | Part number from DMS |
| Quantity On Hand | Quantity in stock at document date |
| Uom (11.) | Unit of measurements for quantity |
| UnitPrice | Per piece price |
| currency | Currency type of price |
| Quantity Available | Quantity of parts not already reserved for |
| | customers or repair orders |
| uom | unit of measurement for Quantity Available |
| Last Sold Date | Date that the part was last sold |
| Quantity Reserved | Quantity of parts reserved for customers or |
| | repair orders |
| uom3 | Unit of measurement for Quantity reserved |

Vehicle data 226 includes vehicle service data 228, vehicle sales data 230, and vehicle inventory data 232. Table 3 provides vehicle data 228, specifically vehicle service data 28 that includes repair order information from servicing the merchandise, e.g., vehicle servicing. In some examples, the data store 120 receives the parts inventory data 224 provided in Table 2 on a daily basis.

TABLE 3
Vehicle Service Data 228

| Field Name | Description |
|---|---|
| Repair Order Number | The unique alphanumeric identifier assigned |
| | to each repair order record by the dealer. This |
| | unique number will be used to identify |
| | individual repair order records. |
| Repair Order Open Date | The date the service repair order was opened. |
| Repair Order Close Date | The date the service repair order was |
| | completed. |
| Customer | The customer listed on the service repair |
| | order. See the “Contact Information Fields” |
| | section in Table 1 for details on the specific |
| | contact fields defined for the customer. |
| Vehicle Pick-Up Date | The date the serviced vehicle was picked up |
| | by the customer. |
| Odometer In | The vehicle mileage when repair order is |
| | opened. |
| Odometer Out | The vehicle mileage when repair order is |
| | closed. |
| Payment Methods | The customer's method(s) of payment. The |
| | defined values are: |
| | CHARGE |
| | CREDIT CARD |
| | CHECK |
| | CASH |
| Appointment Flag | A flag that indicates whether the customer had |
| | a service appointment. The valid values are: |
| | 0 = False (No) |
| | 1 = True (Yes) |
| Extended Service | The names of the extended service contract |
| Contract Names | companies with which the vehicle owner |
| | contracts for extended warranty work. |
| Service Technician | A free-text field that captures any comments |
| Comments | entered by the service technician to describe |
| | the service repair order. |
| Customer Comments | A free-text field that captures any customer |
| | comments submitted for the service repair |
| | order. |
| Total Actual Labor | The total, actual number of labor hours |
| Hours | performed on this service repair order. If it is |
| | not populated or listed as a field in the DMS, |
| | this field is calculated as the sum of the |
| | individual Operation Actual Labor Hours field |
| | amounts from the separate repair operations |
| | associated with this repair order. |
| Total Billed Labor | The total, billed number of labor hours |
| Hours | associated with this service repair order. If it |
| | is not populated or listed as a field in the |
| | DMS, this field is calculated as the sum of the |
| | individual Operation Billed Labor Hours field |
| | amounts from the separate repair operations |
| | associated with this repair order. |
| Department | The repair order operation department. The |
| | defined values include: |
| | S = Service |
| | B = Body Shop |
| | P = Pre-Delivery (Pre-delivery is the work |
| | that was done before a vehicle delivery, |
| | usually involved with a vehicle sale.) |
| Service Advisor | The person who advised the customer on the |
| | vehicle's service under the current repair |
| | order. See the “Contact Information Fields” |
| | section for details on the specific contact |
| | fields defined for the service advisor. |
| Vehicle | The vehicle associated with the current repair |
| | order. See the “Core Vehicle Fields” section |
| | for details on the vehicle fields. |
| Operations | The set of all individual repair order |
| | operations performed under the current repair |
| | order. See the “Repair Order Operations |
| | Fields” section for further details. |
| Total Customer Parts | The total amount the customer paid for parts. |
| Price | If it is not populated or listed as a field in the |
| | DMS, this field is calculated as the sum of the |
| | individual Operation Parts Price field amounts |
| | with the Customer pay type from the separate |
| | repair operations associated with this repair |
| | order. |
| Total Customer Labor | The total amount the customer paid for labor |
| Price | charges. If it is not populated or listed as a |
| | field in the DMS, this field is calculated as the |
| | sum of the individual Operation Labor Price |
| | field amounts with the Customer pay type |
| | from the separate repair operations associated |
| | with this repair order. |
| Total Customer | The total amount the customer paid for |
| Miscellaneous Price | miscellaneous charges. If it is not populated or |
| | listed as a field in the DMS, this field is |
| | calculated as the sum of the individual |
| | Operation Miscellaneous Price field amounts |
| | with the Customer pay type from the separate |
| | repair operations associated with this repair |
| | order. |
| Total Customer Sublet | The total amount the customer paid for sublet |
| Price | items. Sublet items are jobs that were sent |
| | outside the dealership, such as body shop |
| | work. |
| Total Customer Gas, Oil, | The total amount the customer paid for gas, |
| and Grease (GOG) Price | oil, and grease (GOG) items. |
| Total Customer | The total amount the customer paid for |
| Aggregate Miscellaneous | miscellaneous charges, sublet items, and GOG |
| Price | items. This field is calculated as the sum of |
| | these fields: |
| | Total Customer Miscellaneous Price |
| | Total Customer Sublet Price |
| | Total Customer GOG Price |
| Total Customer Price | The total amount the customer paid for all |
| | parts, labor, and miscellaneous charges. If it is |
| | not populated or listed as a field in the DMS, |
| | this field is calculated as the sum of these |
| | fields: |
| | Total Customer Parts Price |
| | Total Customer Labor Price |
| | Total Customer Aggregate Miscellaneous |
| | Price |
| Total Warranty Parts | The total amount the warranty covered for |
| Price | parts. If it is not populated or listed as a field |
| | in the DMS, this field is calculated as the sum |
| | of the individual Operation Parts Price field |
| | amounts with the Warranty (W) pay type from |
| | the separate repair operations associated with |
| | this repair order. |
| Total Warranty Labor | The total amount the warranty covered for |
| Price | labor charges. If it is not populated or listed as |
| | a field in the DMS, this field is calculated as |
| | the sum of the individual Operation Labor |
| | Price field amounts with the Warranty (W) |
| | pay type from the separate repair operations |
| | associated with this repair order. |
| Total Warranty | The total amount the warranty covered for |
| Miscellaneous Price | miscellaneous charges. If it is not populated or |
| | listed as a field in the DMS, this field is |
| | calculated as the sum of the individual |
| | Operation Miscellaneous Price field amounts |
| | with the Warranty (W) pay type from the |
| | separate repair operations. |
| Total Warranty Sublet | The total amount the warranty covered for |
| Price | sublet items. |
| Total Warranty GOG | The total amount the warranty covered for |
| Price | GOG items. |
| Total Warranty | The total amount the warranty covered for |
| Aggregate Miscellaneous | miscellaneous charges, sublet items, and GOG |
| Price | items. This field is calculated as the sum of |
| | these fields: |
| | Total Warranty Miscellaneous Price |
| | Total Warranty Sublet Price |
| | Total Warranty GOG Price |
| Total Warranty Price | The total amount the warranty covered for all |
| | parts, labor, and miscellaneous charges. If it is |
| | not populated or listed as a field in the DMS, |
| | this field is calculated as the sum of these |
| | fields: |
| | Total Warranty Parts Price |
| | Warranty Labor Price |
| | Total Warranty Aggregate Miscellaneous |
| | Price |
| Total Internal Parts Price | The total amount paid for parts by internal |
| | payments at an operations level. If it is not |
| | populated or listed as a field in the DMS, this |
| | field is calculated as the sum of the individual |
| | Operation Parts Price field amounts with the |
| | Internal (I) pay type from the separate repair |
| | operations associated with this repair order. |
| Total Internal Labor | The total amount paid for labor charges by |
| Price | internal payments at an operations level. If it |
| | is not populated or listed as a field in the |
| | DMS, this field is calculated as the sum of the |
| | individual Operation Labor Price field |
| | amounts with the Internal (I) pay type from |
| | the separate repair operations associated with |
| | this repair order. |
| Total Internal | The total amount paid for miscellaneous |
| Miscellaneous Price | charges by internal payments at an operations |
| | level. If it is not populated or listed as a field |
| | in the DMS, this field is calculated as the sum |
| | of the individual Operation Miscellaneous |
| | Price field amounts with the Internal (I) pay |
| | type from the separate repair operations |
| | associated with this repair order. |
| Total Internal Sublet | The total amount paid for sublet items by |
| Price | internal payments at an operations level. |
| Total Internal GOG | The total amount paid for GOG items by |
| Price | internal payments at an operations level. |
| Total Internal Aggregate | The total amount paid for miscellaneous |
| Miscellaneous Price | charges, sublet items, and GOG items by |
| | internal payments at an operations level. This |
| | field is calculated as the sum of these fields: |
| | Total Internal Miscellaneous Price |
| | Total Internal Sublet Price |
| | Total Internal GOG Price |
| Total Internal Price | The total amount paid for all parts, labor, and |
| | miscellaneous charges by internal payments at |
| | an operations level. If it is not populated or |
| | listed as a field in the DMS, this field is |
| | calculated as the sum of these fields: |
| | Total Internal Parts Price |
| | Total Internal Labor Price |
| | Total Internal Aggregate Miscellaneous Price |
| Total Parts Price | The total amount paid for parts by the |
| | customer, the warranty, or internal payments. |
| | If it is not populated or listed as a field in the |
| | DMS, this field is calculated as the sum of |
| | these fields: |
| | Total Customer Parts Price |
| | Total Warranty Parts Price |
| | Total Internal Parts Price |
| Total Labor Price | The total amount paid for labor charges by the |
| | customer, the warranty, or internal payments. |
| | If it is not populated or listed as a field in the |
| | DMS, this field is calculated as the sum of |
| | these fields: |
| | Total Customer Labor Price |
| | Total Warranty Labor Price |
| | Total Internal Labor Price |
| Total Miscellaneous | The total amount paid for miscellaneous |
| Price | charges by the customer, the warranty, or |
| | internal payments. If it is not populated or |
| | listed as a field in the DMS, this field is |
| | calculated as the sum of these fields: |
| | Total Customer Miscellaneous Price |
| | Total Warranty Miscellaneous Price |
| | Total Internal Miscellaneous Price |
| Total Sublet Price | The total amount paid for sublet items by the |
| | customer, the warranty, or internal payments. |
| | If it is not populated or listed as a field in the |
| | DMS, this field is calculated as the sum of |
| | these fields: |
| | Total Customer Sublet Price |
| | Total Warranty Sublet Price |
| | Total Internal Sublet Price |
| Total GOG Price | The total amount paid for GOG items by the |
| | customer, the warranty, or internal payments. |
| | If it is not populated or listed as a field in the |
| | DMS, this field is calculated as the sum of |
| | these fields: |
| | Total Customer GOG Price |
| | Total Warranty GOG Price |
| | Total Internal GOG Price |
| Total Aggregate | The total amount paid for miscellaneous |
| Miscellaneous Price | charges, sublet items, and GOG items by the |
| | customer, the warranty, or internal payments. |
| | If it is not populated or listed as a field in the |
| | DMS, this field is calculated as the sum of |
| | these fields: |
| | Total Customer Aggregate Miscellaneous |
| | Price |
| | Total Warranty Aggregate Miscellaneous |
| | Price |
| | Total Internal Aggregate Miscellaneous Price |
| Total Repair Order (RO) | The total amount paid under this repair order |
| Price | by the customer, the warranty, or internal |
| | payments. If it is not populated or listed as a |
| | field in the DMS, this field is calculated as the |
| | sum of these fields: |
| | Total Customer Price |
| | Total Warranty Price |
| | Total Internal Price |
| Total Tax | The total tax amounts paid under this repair |
| | order by the customer, the warranty, or |
| | internal payments. |
| Total Customer Parts | The total cost of parts paid for by the |
| Cost | customer. If it is not populated or listed as a |
| | field in the DMS, this field is calculated as the |
| | sum of the individual Operation Parts Cost |
| | field amounts with the Customer pay type |
| | from the separate repair operations associated |
| | with this repair order. |
| Total Customer Labor | The total cost of labor items paid for by the |
| Cost | customer. If it is not populated or listed as a |
| | field in the DMS, this field is calculated as the |
| | sum of the individual Operation Labor Cost |
| | field amounts with the Customer pay type |
| | from the separate repair operations associated |
| | with this repair order. |
| Total Customer | The total cost of miscellaneous charges paid |
| Miscellaneous Cost | for by the customer. If it is not populated or |
| | listed as a field in the DMS, this field is |
| | calculated as the sum of the individual |
| | Operation Miscellaneous Price field amounts |
| | with the Customer pay type from the separate |
| | repair operations associated with this repair |
| | order. |
| Total Customer Sublet | The total cost of sublet items paid for by the |
| Cost | customer. Sublet items are jobs that were sent |
| | outside the dealership, such as body shop |
| | work. |
| Total Customer Gas, Oil, | The total cost of gas, oil, and grease (GOG) |
| and Grease (GOG) Cost | items paid for by the customer. |
| Total Customer | The cost of miscellaneous items, sublet items, |
| Aggregate Miscellaneous | and GOG items paid for by the customer. This |
| Cost | field is calculated as the sum of these fields: |
| | Total Customer Miscellaneous Cost |
| | Total Customer Sublet Cost |
| | Total Customer GOG Cost |
| Total Customer Cost | The total cost of all parts, labor, and |
| | miscellaneous charges paid for by the |
| | customer. If it is not populated or listed as a |
| | field in the DMS, this field is calculated as the |
| | sum of these fields: |
| | Total Customer Parts Cost |
| | Total Customer Labor Cost |
| | Total Customer Miscellaneous Cost |
| Total Warranty Parts | The total cost of parts covered by a warranty. |
| Cost | If it is not populated or listed as a field in the |
| | DMS, this field is calculated as the sum of the |
| | individual Operation Parts Cost field amounts |
| | with the Warranty (W) pay type from the |
| | separate repair operations associated with this |
| | repair order. |
| Total Warranty Labor | The total cost of labor items covered by a |
| Cost | warranty. If it is not populated or listed as a |
| | field in the DMS, this field is calculated as the |
| | sum of the individual Operation Labor Cost |
| | field amounts with the Warranty (W) pay type |
| | from the separate repair operations associated |
| | with this repair order. |
| Total Warranty | The total cost of miscellaneous charges |
| Miscellaneous Cost | covered by a warranty. If it is not populated or |
| | listed as a field in the DMS, this field is |
| | calculated as the sum of the individual |
| | Operation Miscellaneous Cost field amounts |
| | with the Warranty (W) pay type from the |
| | separate repair operations associated. |
| Total Warranty Sublet | The total cost of sublet items covered by a |
| Cost | warranty. |
| Total Warranty GOG | The total cost of GOG items covered by a |
| Cost | warranty. |
| Total Warranty | The cost of miscellaneous items, sublet items, |
| Aggregate Miscellaneous | and GOG items covered by a warranty. This |
| Cost | field is calculated as the sum of these fields: |
| | Total Warranty Miscellaneous Cost |
| | Total Warranty Sublet Cost |
| | Total Warranty GOG Cost |
| Total Warranty Cost | The total cost of all parts, labor, and |
| | miscellaneous charges covered by a warranty. |
| | If it is not populated or listed as a field in the |
| | DMS, this field is calculated as the sum of |
| | these fields: |
| | Total Warranty Parts Cost |
| | Total Warranty Labor Cost |
| | Total Warranty Miscellaneous Cost |
| Total Internal Parts Cost | The total cost of parts paid for by an internal |
| | payment. If it is not populated or listed as a |
| | field in the DMS, this field is calculated as the |
| | sum of the individual Operation Parts Cost |
| | field amounts with the Internal (I) pay type |
| | from the separate repair operations associated |
| | with this repair order. |
| Total Internal Labor | The total cost of labor items paid for by an |
| Cost | internal payment. If it is not populated or |
| | listed as a field in the DMS, this field is |
| | calculated as the sum of the individual |
| | Operation Labor Cost field amounts with the |
| | Internal (I) pay type from the separate repair |
| | operations associated with this repair order |
| | The total cost of labor items paid for by an |
| | internal payment. |
| Total Internal | If it is not populated or listed as a field in the |
| Miscellaneous Cost | DMS, this field is calculated as the sum of the |
| | individual Operation Labor Cost field |
| | amounts with the Internal (I) pay type from |
| | the separate repair operations associated with |
| | this repair order |
| Total Internal Sublet Cost | The total cost of sublet items paid for by an |
| | internal payment. |
| Total Internal GOG Cost | The total cost of GOG items paid for by an |
| | internal payment. |
| Total Internal Aggregate | The cost of miscellaneous items, sublet items, |
| Miscellaneous Cost | and GOG items paid for by an internal |
| | payment. This field is calculated as the sum of |
| | these fields: |
| | Total Internal Miscellaneous Cost |
| | Total Internal Sublet Cost |
| | Total Internal GOG Cost |
| Total Internal Cost | The total cost of all parts, labor, and |
| | miscellaneous charges paid for by an internal |
| | payment. If it is not populated or listed as a |
| | field in the DMS, this field is calculated as the |
| | sum of these fields: |
| | Total Internal Parts Cost |
| | Total Internal Labor Cost |
| | Total Internal Miscellaneous Cost |
| Total Parts Cost | The total cost of parts associated with all |
| | payment types. If it is not populated or listed |
| | as a field in the DMS, this field is calculated |
| | as the sum of these fields: |
| | Total Customer Parts Cost |
| | Total Warranty Parts Cost |
| | Total Internal Parts Cost |
| Total Labor Cost | The total cost of labor items associated with |
| | all payment types. If it is not populated or |
| | listed as a field in the DMS, this field is |
| | calculated as the sum of these fields: |
| | Total Customer Labor Cost |
| | Total Warranty Labor Cost |
| | Total Internal Labor Cost |
| Total Miscellaneous | The total cost of miscellaneous items |
| Cost | associated with all payment types. If it is not |
| | populated or listed as a field in the DMS, this |
| | field is calculated as the sum of these fields: |
| | Total Customer Miscellaneous Cost |
| | Total Warranty Miscellaneous Cost |
| | Total Internal Miscellaneous Cost |
| Total Sublet Cost | The total cost of sublet items associated with |
| | all payment types. If it is not populated or |
| | listed as a field in the DMS, this field is |
| | calculated as the sum of these fields: |
| | Total Customer Sublet Cost |
| | Total Warranty Sublet Cost |
| | Total Internal Sublet Cost |
| Total GOG Cost | The total cost of GOG items associated with |
| | all payment types. If it is not populated or |
| | listed as a field in the DMS, this field is |
| | calculated as the sum of these fields: |
| | Total Customer GOG Cost |
| | Total Warranty GOG Cost |
| | Total Internal GOG Cost |
| Total Aggregate | The total cost of miscellaneous charges, sublet |
| Miscellaneous Cost | items, and GOG items associated with all |
| | payment types. If it is not populated or listed |
| | as a field in the DMS, this field is calculated |
| | as the sum of these fields: |
| | Total Customer Aggregate Miscellaneous |
| | Cost |
| | Total Warranty Aggregate Miscellaneous Cost |
| | Total Internal Aggregate Miscellaneous Cost |
| Total Repair Order | The total costs associated with this repair |
| (RO) Cost | order for all payment types (customer, |
| | warranty, and internal). If it is not populated |
| | or listed as a field in the DMS, this field is |
| | calculated as the sum of these fields: |
| | Total Customer Cost |
| | Total Warranty Cost |
| | Total Internal Cost |
| Contact ID | The unique contact identifier associated with |
| | the customer or employee. |
| Full Name | The full name of the customer or employee. |
| | The first, middle, and/or last name (including |
| | any salutation, title, and suffix) are also |
| | available. |
| Company Name | The name of the customer's company, if |
| | applicable and available. |
| Residential Address | The residential address of the customer. The |
| | employee contact fields do not store address |
| | information. |
| Street Address | The street address of the customer. |
| City | The city of the customer. |
| State or Region | The state or region of the customer. |
| Postal Code | The postal code or ZIP code of the customer. |
| Country | The country of the customer. |
| District | The county, district, or parish of the customer. |
| Business Phone Number | The business phone number of the customer. |
| | If defined, the extension and country code are |
| | also available. |
| Home Phone Number | The home phone number of the customer. If |
| | defined, the country code is also available. |
| Mobile Phone Number | The mobile phone number of the customer. |
| Personal Email Address | The personal email addresses of the customer. |
| Business Email Address | The business email addresses of the customer. |
| Allow Solicitation | A general flag that indicates whether the |
| | customer allows solicitation from the |
| | dealership via any means. The allowed values |
| | are: |
| | 0 = False (No) |
| | 1 = True (Yes) |
| Allow Mail Solicitation | A flag that indicates whether the customer |
| | allows solicitation from the dealership via |
| | mail. The allowed values are: |
| | 0 = False (No) |
| | 1 = True (Yes) |
| Allow Email Solicitation | A flag that indicates whether the customer |
| | allows solicitation from the dealership via |
| | email. The allowed values are: |
| | 0 = False (No) |
| | 1 = True (Yes) |
| Allow Phone Solicitation | A flag that indicates whether the customer |
| | allows solicitation from the dealership via |
| | telephone. The allowed values are: |
| | 0 = False (No) |
| | 1 = True (Yes) |
| Business/Person Flag | An indicator to determine whether a customer |
| | is an individual person or a business or other |
| | entity. |
| Birth Date | The date of birth of the customer. |
| Department | The department, if any, associated with the |
| | customer. |
| Language Preference | The language preference for the customer, if |
| | one is available. |
| VIN | The VIN (Vehicle Identification Number) of |
| | the vehicle. |
| Make | The make of the vehicle. |
| Model | The model of the vehicle. |
| Model Year | The model year of the vehicle. |
| Transmission Description | The description of the vehicle's transmission. |
| Exterior Color | A free-text description of the vehicle's exterior |
| Description | color. |
| License Plate Number | The license plate of the vehicle. |
| Operation Code | The alphanumeric code associated with this |
| | repair order operation. |
| Operation Description | A free-text description of the work that was |
| | done for a repair order. There can be many |
| | operations to one repair order. The description |
| | could be any value assigned to a specific |
| | operation code or free text written by the |
| | service technician at the time of repair. |
| Operation Category IDs | A list of operation category ID codes |
| | associated with this repair order operation. |
| | Note that this field is not included by default |
| | and must be requested explicitly. |
| Operation Technician | A free-text field that captures any comments |
| Comments | written by the technician about this repair |
| | order operation. |
| Operation Customer | A free-text field that captures any comments |
| Comments | written by the customer about this repair order |
| | operation. |
| Operation Payment Type | The payment type associated with this |
| | operation, cleaned and matched as well as |
| | possible. The allowed values are: |
| | C = Customer |
| | W = Warranty |
| | I = Internal |
| Operation Payment Type | The payment type associated with this |
| (DMS Value) | operation, as originally loaded from the DMS. |
| Operation Actual Labor | The actual number of labor hours performed |
| Hours | on this service repair operation. If necessary, |
| | this field can be used to calculate the Total |
| | Actual Labor Hours field amount for the |
| | entire repair order. |
| Operation Billed Labor | The billed number of labor hours associated |
| Hours | with this service repair operation. If |
| | necessary, this field can be used to calculate |
| | the Total Billed Labor Hours field amount for |
| | the entire repair order. |
| Operation Labor Billing | The billing labor rate used for this service |
| Rate | repair operation. |
| Operation Labor Cost | The cost of labor items associated with this |
| | service repair operation. If it is not populated |
| | or listed as a field in the DMS, this field is |
| | calculated as follows: |
| | Operation Total Cost—(Operation Parts |
| | Cost + Operation Miscellaneous Cost). |
| Operation Labor Price | The price of labor items associated with this |
| | service repair operation. If it is not populated |
| | or listed as a field in the DMS, this field is |
| | calculated as follows: |
| | Operation Total Price—(Operation Parts |
| | Price + Operation Miscellaneous Price). |
| Operation Miscellaneous | The cost of miscellaneous items associated |
| Cost | with this service repair operation. If it is not |
| | populated or listed as a field in the DMS, this |
| | field is calculated as follows: |
| | Operation Total Cost—(Operation Parts |
| | Cost + Operation Labor Cost). |
| Operation Miscellaneous | The price of miscellaneous items associated |
| Price | with this service repair operation. If it is not |
| | populated or listed as a field in the DMS, this |
| | field is calculated as follows: |
| | Operation Total Price—(Operation Parts |
| | Price + Operation Labor Price). |
| | If the Operation Total Price is also |
| | unavailable, Operation Miscellaneous Price is |
| | left null. |
| Operation Parts Cost | The cost of vehicle parts associated with this |
| | service repair operation. If it is not populated |
| | or listed as a field in the DMS, this field is |
| | calculated as the sum of the individual Total |
| | Cost field amounts from the separate parts |
| | associated with this service repair operation. |
| Operation Parts Price | The price of vehicle parts associated with this |
| | service repair operation. If it is not populated |
| | or listed as a field in the DMS, this field is |
| | calculated as the sum of the individual |
| | Total Price field amounts from the separate |
| | parts associated with this service repair |
| | operation. |
| Total Operation Cost | The total cost associated with this service |
| | repair operation. If it is not populated or listed |
| | as a field in the DMS, this field is calculated |
| | as the sum of these fields: |
| | Operation Labor Cost |
| | Operation Miscellaneous Cost |
| | Operation Parts Cost |
| Total Operation Price | The total price associated with this service |
| | repair operation. If it is not populated or listed |
| | as a field in the DMS, this field is calculated |
| | as the sum of these fields: |
| | Operation Labor Price |
| | Operation Miscellaneous Price |
| | Operation Parts Price |
| Operation Technician | The respective contact ID of each technician |
| Contact ID | who performed work on this service repair |
| | operation. See the “Contact Information |
| | Fields” section for further details. |
| Operation Technician | The respective full name of each technician |
| Full Name | who performed work on this service repair |
| | operation. See the “Contact Information |
| | Fields” section for further details. |
| Operation Technician | The respective labor rates of each technician |
| Labor Rates | who performed work on this service repair |
| | operation. |
| Operation Parts | A list of all vehicle parts used to perform this |
| | service repair operation. See the “Part Fields” |
| | section for details on the fields for the parts. |
| Part Number | The unique part number identifier for each |
| | part. This is the processed number that has |
| | been cleaned and matched as well as possible |
| | to standard manufacturer part numbers. Note |
| | that this field is not included by default and |
| | must be requested explicitly. |
| Part Number | The unique part number identifier for each |
| (DMS Value) | part as originally loaded from the DMS. |
| Part Description | A brief description of the part. |
| Part—Manufacturer | The manufacturer of the part. This is the |
| | processed name that has been cleaned and |
| | matched as well as possible to standard |
| | manufacturer names. |
| Part—Manufacturer | The manufacturer of the part as originally |
| (DMS Value) | loaded from the DMS. |
| Quantity | The quantity of this part used in a service |
| | repair operation. |
| Total Cost | The total cost of all copies of this part used in |
| | a service repair operation. If it is not |
| | populated or listed as a field in the DMS, this |
| | field is calculated as the product of the |
| | Quantity and the Unit Cost fields for this part. |
| Total Price | The total price charged for all copies of this |
| | part used in a service repair operation. If it is |
| | not populated or listed as a field in the DMS, |
| | this field is calculated as the product of the |
| | Quantity and the Unit Price fields for this part. |
| Unit Cost | The unit cost of this part used in a service |
| | repair operation. |
| Unit Price | The unit price charged for this part used in a |
| | service repair operation. |

Vehicle data 226 includes vehicle service data 228, vehicle sales data 230, and vehicle inventory data 232. Table 4 provides vehicle sales data 230.

TABLE 4
Vehicle sales data 230

| Field Name | Description |
|---|---|
| Deal Number | The unique number assigned to each vehicle sales |
| | record by the dealer. |
| Contract Type | A field that denotes the type of contract, which is |
| | one of the following allowed values: |
| | Purchase |
| | Lease |
| Sale Type | A field that denotes the type of sale. The following |
| | values are currently defined, but unknown values are |
| | exported without being changed: |
| | Retail |
| | Wholesale |
| | House |
| | Fleet |
| | Commercial |
| | Business Preferred |
| Contract Date | The date that the contract was finalized and became a |
| | bookable deal in the DMS. |
| Delivery Date | The date that the customer is listed as having taken |
| | possession of the vehicle. |
| Purchase Order | The date that the customer originally signed a |
| Date | purchase order on the vehicle and the deal was |
| | entered into the DMS. |
| Deal Status Date | The date that the deal's status was last changed. |
| Deal Status | The status of the deal, which is one of the following |
| | allowed values: |
| | Finalized: indicates a deal that has been posted to |
| | accounting |
| | Closed: indicates a deal that has been finalized in the |
| | F&I system, and is awaiting posting to accounting |
| | Booked: varies slightly depending upon dealer usage, |
| | but typically indicates a deal that has been opened but |
| | not all paperwork and financing details have been |
| | completed |
| | Pending: varies slightly depending upon dealer usage, |
| | but typically indicates a deal that has been opened |
| | and is in progress, but no financing paperwork has |
| | been started yet |
| | Unwound: indicates a deal that was posted to |
| | accounting, but is 1 low being removed from |
| | accounting due to a return of the vehicle to the |
| | dealership |
| | Cleared: indicates a deal that was not yet posted to |
| | accounting that was terminated for any reason |
| Delivery Odometer | The mileage listed on the vehicle at the time of |
| | delivery to the customer. |
| Reversal Date | The date that the dealership marked the deal as |
| | unwound. |
| | The product populates the Reversal Date only if the |
| | deal is in Unwound status. |
| | The product attempts to use a date that is manually |
| | entered by the dealership as the date that the deal |
| | entered Unwound status. |
| | Otherwise, the product populates the Reversal Date |
| | with the Deal Status Date in cases where the deal is of |
| | Unwound status and the Reversal Date is otherwise |
| | null. |
| Vehicle Sale Price | The cash price of the vehicle, also known as the |
| | selling price, which does not include any fees or |
| | after-market items. |
| Total Sale Credit | The total amount for all the credits that the buyer is |
| Amount | paying to the dealer towards the cost of the deal. This |
| | amount includes all cash down payments, rebates, |
| | pickup payments, and trade-ins. If it is not populated |
| | or listed as a field in the DMS, this field is calculated |
| | as the sum of the following fields: |
| | Total Rebate Amount |
| | Total Cash Down Payment |
| | Total Pickup Payments |
| | Total Net Trade Amount |
| Total Rebate | The total amount of any rebates given to the buyer on |
| Amount | a vehicle sale. |
| Total Trades | The total amount that the dealer gives the buyer for |
| Allowance Amount | his or her trade-in vehicle(s). If it is not populated or |
| | listed as a field in the DMS, this field is calculated as |
| | the sum of the individual Allowance Amount fields |
| | from one or more trade-ins. |
| Total Net Trade | The total net trade amount that the dealership gives |
| Amount | the buyer on all of his or her trade-ins, which is then |
| | applied towards the sale. This amount is the |
| | difference between the total trade-in allowance and |
| | the total payoff that the buyer still owes on the trade- |
| | ins. If it is not populated or listed as a field in the |
| | DMS, this field is calculated as the sum of the |
| | individual Net Trade Amount fields of one or more |
| | trade-ins on a single deal. |
| Total Trades Actual | The total actual cash value of all trade-ins that a |
| Cash Value (ACV) | buyer trades in on a deal. If it is not populated or |
| | listed as a field in the DMS, this field is calculated as |
| | the sum of the individual Actual Cash Value fields of |
| | one or more trade-ins on a single deal. |
| Total Trades Payoff | The total of all payoff amounts on any liens against |
| | the trade-in vehicles on a deal. If it is not populated |
| | or listed as a field in the DMS, this field is calculated |
| | as the sum of the individual Payoff Amount fields |
| | from one or more trade-ins on a single deal. |
| Total Cash-Down | The total cash-down payment that the dealer collects |
| Payment | from the buyer at the time of the sale. |
| Total Pickup | The total amount of any down payments that the |
| Payment | buyer agrees to pay after the deal is closed. |
| Total Fees and | The total of all fees and options included on a vehicle |
| Accessories | sale. |
| Total Accessories | The total of all accessories sold on a deal. |
| Total Taxes | The total of all taxes, including sales tax, charged on |
| | a vehicle sale. |
| Total Gross Profit | The total profit realized by the dealer on a deal. This |
| | amount consists of the total of the back-end and front- |
| | end gross profit. |
| Front-End Gross | The profit that the dealer realizes solely on the sale of |
| Profit | the vehicle. This value is also known as the dealer |
| | sale profit. |
| Back-End Gross | The profit that the dealer realizes on financing and |
| Profit | insurance (F&I) associated with a deal. This value is |
| | also known as F&I reserve. |
| Total Finance | The total amount that the customer finances on the |
| Amount | sale, including any fees and after-market items that |
| | are rolled into financing. |
| Contract Term | The number of months specified on the contract that |
| | the customer shall make monthly payments. |
| Finance APR | The annual percentage rate (APR) on the financing of |
| | the deal. |
| Buy Rate | The annual percentage rate on sale from the finance |
| | source to the dealer. |
| Finance Charge | The total interest amount on the amount financed. |
| | This is the amount of interest that the buyer will have |
| | paid at the end of the contract if he or she makes only |
| | the minimum monthly payments. |
| Monthly Payment | The amount that the customer will pay each mouth to |
| | his or her lending institution toward the loan or lease. |
| First Payment Date | The date that the first payment on the contract is due. |
| Payment Frequency | The frequency with which the customer is required to |
| | make payments on his or her contract. The following |
| | are the allowed values: |
| | Monthly |
| | Weekly |
| | Semi-Monthly |
| | Biweekly |
| Expected Vehicle | The expected date on which the vehicle contract will |
| Payoff Date | be paid off. |
| | If this field is not populated or listed as a value in the |
| | DMS, then this value is derived by adding the number |
| | of months in the Contract Term field to the First |
| | Payment Date to determine a future calendar date. |
| | This field is left null in cases where it is null in the |
| | DMS and sufficient information is not available in the |
| | First Payment Date and Contract Term fields to |
| | derive this date. This would include cases where |
| | either the First Payment Date or the Contract Term is |
| | null, or where either field contains a value whose |
| | meaning is uncertain. An example of such a value |
| | would be a Contract Term of 0 or 1. |
| Payments Total | The total of all payments that the customer has agreed |
| | to pay. If it is not populated or listed as a value in the |
| | DMS, this field is calculated by multiplying the |
| | Monthly Payment amount by the Contract Term. |
| Finance Company | The identification code of the financial institution |
| Code | providing the financing on the deal as the code |
| | appears in the dealer's DMS. |
| Finance Company | The name of the financial institution providing the |
| Name | financing on the deal. |
| Comments | The comments associated with a deal that are stored |
| | in the DMS. |
| Balloon Payment | The amount of the payment on a balloon lease deal. |
| Base Rental | The base rental amount is available for ADP Elite |
| Amount | only and is determined by the Lease calculation |
| | method and displayed on the Lease information |
| | screen. |
| Expected Vehicle | The expected date on which the vehicle contract will |
| Payoff Date | be paid off. |
| | If this field is not populated or listed as a value in the |
| | DMS, then this value is derived by adding the number |
| | of months in the Contract Term field to the First |
| | Payment Date to determine a future calendar date. |
| | This field is left null in cases where it is null in the |
| | DMS and sufficient information is not available in the |
| | First Payment Date and Contract Term fields to |
| | derive this date. This would include cases where |
| | either the First Payment Date or the Contract Term is |
| | null, or where either field contains a value whose |
| | meaning is uncertain. An example of such a value |
| | would be a Contract Term of 0 or 1. |
| Payments Total | The total of all payments that the customer has agreed |
| | to pay. If it is not populated or listed as a value in the |
| | DMS, this field is calculated by multiplying the |
| | Monthly Payment amount by the Contract Term. |
| Finance Company | The identification code of the financial institution |
| Code | providing the financing on the deal as the code |
| | appears in the dealer's DMS. |
| Finance Company | The name of the financial institution providing the |
| Name | financing on the deal. |
| Comments | The comments associated with a deal that are stored |
| | in the DMS. |
| Balloon Payment | The amount of the payment on a balloon lease deal. |
| Base Rental | The base rental amount is available for ADP Elite |
| Amount | only and is determined by the Lease calculation |
| | method and displayed on the Lease information |

Vehicle data 226 includes vehicle service data 228, vehicle sales data 230, and vehicle inventory data 232. Table 5 provides vehicle inventory data 232.

TABLE 5
Vehicle Inventory Data 232

| Description | Example/Format |
|---|---|
| VIN | WAUKJAFM4DA024840 |
| Vehicle Status | 50 |
| Location Name | Tampa, FL |
| Commission Number | 560841 |
| Commission Year | 2008 |
| Bill To DealerID | 422C085 |
| Ship To DealerID | 401A678 |
| Make | AUD |
| Model Year | 2013 |
| Country | USA |
| Sale Model Code | 8PA5PX |
| Model Name | Q5 |
| Trim Level | 2.0-liter TFSI ® four-cylinder engine |
| Sub Trim Level | Premium |
| Body Style | Convertible |
| MSRP | 37895 |
| Dealer delivery date | 21092012 |
| Demo Service date | 11092012 |
| Exterior Color Code | 5F5F |
| Exterior Color | COBALT BLUE METALLIC |
| Exterior Base Color | BLUE |
| Interior Color Code | XG |
| Interior Color | BLACK WITH DIAMOND STITCHING |
| Interior Base Color | BLACK |
| Engine Displacement | 2.0 |
| Engine Displacement Unit | L |
| of Measure | |
| Engine Horsepower | 240 |
| Engine Cylinder Count | 6 |
| Engine Description | 2.0 L, 140 HP, 4 cylinder |
| Transmission Type | Tiptronic ® |
| Transmission Description | 6-Speed Automatic w/Manual Shift |
| Fuel Type | Diesel |
| MPG City | 30 |
| MPG Highway | 42 |
| MPG Combined | 36 |
| Type of Wheels | 17″ inch |
| Sale Options List | PNZ \| PPX |
| Factory Option List | D82 \| UA3 |
| Drive Type | FWD |
| Sale Order Type | SHIP - Deliverable Inventory Order |
| FILLER | |

Referring to FIGS. 2A and 2C, in some implementations, the data store 120 includes internal seller data 240 previously collected from the seller 20 or from outside sources. In some examples, the internal seller data 240 includes, but is not limited to, seller master data 242 (for one or more sellers), seller purchase objective 244, a part master file 246, part item categories 248, seller(s) purchases 250, seller part number purchases 252, seller vehicle-in-operation 254, area/region master 256, and tactical segment master 258.

Seller master data 242 includes details relating to the seller 20 (e.g., dealer), such as seller code, seller name, seller address, seller region and area. Table 5 provides more details relating to the information associated with the seller master data 242. In some examples, the seller master 242 may be updated monthly. In some examples, the manager 30 provides the seller 20 with merchandise 31 relating with different brands 32. One seller 20 may sell merchandise of one brand 32, e.g., Brand A, another seller 20 may sell merchandise of another brand 32, e.g., Brand B, and a third seller 20 may sell merchandise of both brands 32 e.g., Brands A and B (dual-brand seller 20). Therefore, the seller master data 242 includes information relating to what the seller 20 is selling from the brands 32 offered by the manager 30. Moreover, seller master data 242 is made available to every seller 20, and includes data pertaining to whether the seller 20 is a single, dual, or multiple brand seller 20.

TABLE 5
Seller Master 242

| Description | Example/Format | Possible Values |
|---|---|---|
| Dealer Code | 123456 | |
| Marketing Status Code | R | I—Inactive |
| | | N—Independent |
| | | R—Active |
| Dealer Region/Zone | EAZ | |
| Code | | |
| Dealer Area/District | 22 | |
| Code | | |
| Dealer Division | Vehicle Brand A | Vehicle Brand |
| | | A - Brand N |
| Dealer Name | Hometown Vehicle Brand A | |
| Dealer Storefront | 123 Main Street | |
| Address | | |
| Dealer Storefront City | Melbourne | |
| Dealer Storefront State | MI | |
| Dealer Storefront Zip | 12345 | |
| Dealer Storefront Zip + | 1234 | |
| 4 | | |
| Corporate phone number | 1234567890 | |
| Dealer Corporate fax | 2345678901 | |
| number | | |
| Dealer primary | E | E—English |
| language | | F—French |
| Dealer country code | USA | USA—USA |
| | | CAN—Canada |
| Dealer Type Code | V | V—Brand A |
| | | A—Brand B |
| | | S—Service Point |
| Area/District Name | Metro Chicago | |
| Region/Zone Name | VW East | |
| Buying Dealer | 765432 | |
| Date of last dealer | MMDDYYYY | |
| status change | | |
| Dealer dual status | 0′ | |
| indicator | | |
| LMC Code | 211 | |
| LMC Description | Chicago LMC | |
| Actual Status Code | T | I—Inactive |
| | | N—Independent |
| | | R—Active |
| | | T—Temporary |
| FILLER1 | Blank | |
| Sub Region | EAR | |
| Sub Region Name | VW Eastern | |
| Sub Area Code | 84b | |
| Sub Area Name | 84b Carolina | |
| Dealer Corp Name | Tracy Vehicle Brand A, Inc. | |
| Dual Dealer ID | 765432 | |
| Franchise Date | MMDDYYYY | |
| Termination Date | MMDDYYYY | |
| Selling Dealer ID | 765432 | |
| File creation date | MMDDYYYY | |
| Dealer Corporate Url | www.DealerVechileBrandA. | |
| | com | |
| Dealer Sales Fax | 1234567890 | |
| Number | | |
| Dealer Sales Phone | 1234567890 | |
| Number | | |
| Primary Fax Number | 1234567890 | |
| Primary Phone Number | 1234567890 | |
| Dealer Parts Phone | 1234567890 | |
| Number | | |
| Dealer Parts Fax | 1234567890 | |
| Number | | |
| Service Phone Number | 1234567890 | |
| Service Fax Number | 1234567890 | |
| DMA Code | 506 | |
| DMA Description | Boston | |
| Dealer Tier | 1 | 1, 2, 3, 4, 5 |
| Brand B flagship Dealer | Y | Y or N |
| Indicator | | |
| FILLER2 | Blank | |

The seller purchases objective 244 lists the seller's monthly objectives (see Table 6). The seller purchase objectives 244 may be updated from the seller 20 once a year, for example.

TABLE 6
Seller Purchase objective 244

| Field Name | Description |
|---|---|
| Dealer Code | 6 Digit Dealer Code (e.g.: 401052) |
| Bill Period | Year Month of Objective (e.g.: 201311) |
| Retail Objective | Dealer Objective $ Amount |

The part master file 246 provides details on the parts 36 of a specific product 34 of a brand 32, including part number, pricing, description, and OEM (Original part manufacture) specific part categorization. The part categorization includes: part numbers, part category code (HTG), minor tactical segment, major tactical segment, and product group. The part master file 246 may be updated once a month. Table 7 provides an exemplary part master file 246.

TABLE 7
Part Master File 246

| Field Name | Description |
|---|---|
| PART_NUMBER | The unique part number identifier of each part by |
| | the OEM |
| PART_MATERIAL | Alternate version of part number, which includes |
| | hyphens and spaces |
| PART_DESCRIPTION | Description of the part |
| PART_VOA_COST | OEM cost |
| PART_LCF | Landed Cost Factor |

The part item category 248 provides category assignment of parts for calculating parts stocking breadth. The part master file 246 may be updated once a month. Table 8 provides an exemplary part master file 246.

TABLE 8
Part item category 248

| Field Name | Description |
|---|---|
| Part Number | The unique part number identifier for each part listed |
| | on the invoice. This is the processed number that has |
| | been cleaned and matched as well as possible to |
| | standard manufacturer part numbers. |
| Category Code | It is a unique alpha numeric code, which is used to |
| | identify the parts hierarchical categories. (e.g.: LWA) |
| Category Description | It is description of the part category. (e.g.: Universal |
| | Water Paint) |

The seller purchases data 250 provides monthly aggregate seller level purchases (not part or accessory level details). The seller purchases data 250 may be updated once a year. Table 9 provides an exemplary seller purchases data 250.

TABLE 9
Seller purchases data 250

| Field Name | Description |
|---|---|
| Dealer Code | 6 Digit Dealer Code |
| As of Date | Date data is applicable for |
| Total Purchase Amount | Sum of all purchases for dealer |
| Warranty Purchase | Sum of warranty purchases for dealer |
| Amount | |
| Engine Oil Purchase | Sum of engine oil purchases for dealer |
| Amount | |
| Battery Purchase Amount | Sum of battery purchases for dealer |
| Tire Purchase Amount | Sum of tire purchases for dealer |
| Drop ship Purchase | Sum of drop ship purchases for dealer |
| Amount | |
| Monthly Objective | Objective dollar amount as of ″As of Date″ for |
| Amount | the file. |

The seller parts number purchase data 252 includes details on purchases by the seller 20 from the manager 30 including, but not limited to, part number, quantities, and pricing. The seller part number purchase data 246 may be updated once a week. Table 10 provides an exemplary seller parts number purchase data 252.

TABLE 10
Seller Part Number purchase data 252

| Field Name | Description |
|---|---|
| DLR_CODE | 6 Digit Dealer Code |
| PURCHASE_YYYYMM | Year month purchase |
| PART_NUMBER | The unique part number identifier for each part |
| | purchased by the dealer |
| PURCHASE_QTY | Quantity of parts purchased by the dealer |
| PURCHASE_AMOUNT | The price at which the parts are purchased by |
| | the dealer from OEM |
| WARRANTY_QTY | Quantity of purchased parts under warranty by |
| | the OEM |
| WARRANTY_AMOUNT | Cost of warrant parts |
| RETURN_QTY | Quantity of purchased parts returned to the |
| | OEM |
| RETURN_AMOUNT | Cost of parts returned |

The seller(s) vehicle-in-operation (VIO) data 254 includes data relating to the number of vehicles based on brand 32 that are on the road by a seller 20, regionally or nationally. The VIO metric is usually calculated as a 7-year-VIO, which means the previous 7 model years (MYs), and 15-year-VIO (previous 15 MYs). The seller(s) vehicle-in-operation data 254 may be updated monthly.

TABLE 11
Seller(s) Vehicle-in-Operation 254

| Field Name | Description |
|---|---|
| Dealer | Dealer number with ″E00″ prefix |
| Dealer Name | Name that dealer operates under |
| Region | Region Code that dealer is assigned to |
| Area | Area that dealer is assigned to |
| Weighted VIO | Weighted total for segments 1-3 |
| SEG 1 (2010-2013) | Segment 1 VIO total |
| Weighted SEG 1 | Weighted segment 1 VIO |
| (2010-2013) | |
| SEG 2 (2007-2009) | Segment 2 VIO total |
| Weighted SEG 2 | Weighted segment 2 VIO |
| (2007-2009) | |
| SEG 3 (2001-2006) | Segment 3 VIO total |
| Weighted SEG 3 | Weighted segment 3 VIO |
| (2001-2006) | |
| MY + 7 | VIO for the prior 7 model years |
| 2013 | Total for model year 2013 |
| 2012 | Total for model year 2012 |
| 2011 | Total for model year 2011 |
| 2010 | Total for model year 2010 |
| 2009 | Total for model year 2009 |
| 2008 | Total for model year 2008 |
| 2007 | Total for model year 2007 |
| 2006 | Total for model year 2006 |
| 2005 | Total for model year 2005 |
| 2004 | Total for model year 2004 |
| 2003 | Total for model year 2003 |

The area/region master data 256 includes data relating to the currently active area codes, area name, region code, and region names. The area and region codes are codes indicative of areas and regions of the location of the sellers 20. The area/region master data 256 may be updated as frequently as needed. See Table 12.

TABLE 12
Area/Region Master 256

| Field Name | Description |
|---|---|
| BRAND | Brand A |
| RGN CODE | Three digit region code. (e.g.: MWR) |
| RGN NAME | Full Region Name. (e.g.: Mid-West Region) |
| AREA_CODE | 2 digit area code. (e.g.: 3G) |
| AREA_NAME | Full Area Name |

The tactical segment master data 258 includes data relating to the brand(s) 32 tactical part segments including, but not limited to HTG (part category code), and major and minor tactical segments. The tactical segment master data 258 may be updated as frequently as needed. See Table 13.

TABLE 13
Tactical segment master 258

| Field Name | Description |
|---|---|
| PCAT_HTG | Part category code |
| PCAT_HTG_DESC | Part category code description |
| PCAT_MINOR_ | Parts classification by Minor tactical segment |
| TACT_SEGMENT | (e.g., brakes, air filters, shocks, oil filter, etc.) |
| PCAT_MAJOR_ | Parts classification by major tactical segment |
| TACT_SEGMENT | (e.g., maintenance, light repair, heavy repair) |
| PCAT_PRODUCT_ | Parts classification by product group |
| GROUP | |

Referring back to FIGS. 1, 2A, and 3, the system 100 also includes an analyzer 300 and a reporter 150 executing on the one or more data processing devices 110 and in communication with the data store 120. The analyzer 300 is in communication with the data store 120. The analyzer 300 analyzes data (e.g., seller transactional data 220 and internal seller data 240) from the data store 120 to provide a report by way of the reporter 150. The analyzer 300 includes a modules portion 310, a dimensions portion 330, and a metrics/measures portion 350, all of which act in concert to analyze the data 220, 240 and generate a report 152 by way of the reporter 150.

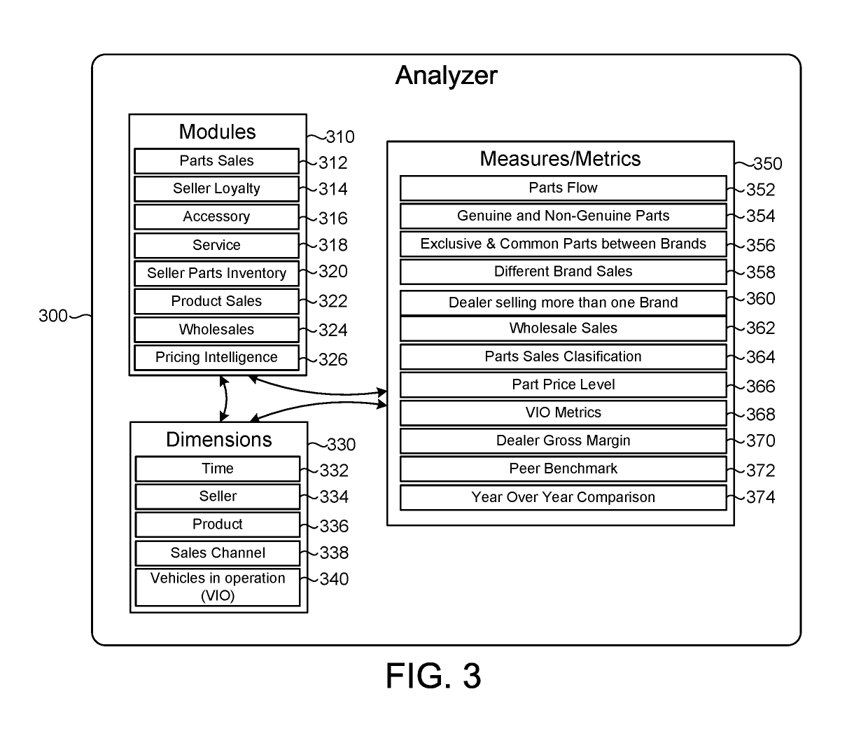

Referring to FIG. 3, the module portion 310 defines ways to group and categorize the measures/metrics 350 of the seller transactional data 220 and internal seller data 240 before reporting the analyzed data by way of the reporter 150 to a user 20, 30. The module portion 310 includes multiple sub-modules 312-326 such as, a parts sales module 312, a dealer loyalty module 314, an accessory module 316, a service module 318, a dealer parts inventory module 320, a vehicle sales module 322, a wholesale module 324, and a pricing intelligence module 326. Other modules may also be available. The parts sales module 312 includes measures retrieved from the seller transactional data 220 and internal data 240 relating to parts sales information of one or more sellers 20, i.e., the parts sales module 312 reflects the amount of sales that one or more sellers 20 have sold to customers 10. The parts sales module 312 is indicative of the performance of the seller 20. In some examples, the parts sales module 312 reflects the sales of a specific brand 32, specific product 34, specific part 36, or specific accessory 38 sold by the seller 20 to customers 10. Thus, the parts sales module 312 analyzes the data 220, 240 and provides the reporter 150 with data relating to the parts sales that may be reported to the user 20, 30.

The seller loyalty module 314 includes measures based on data 220, 240 stored on the data store 120 relating to seller sales loyalty information. For example, if the seller 20 provides its customers 10 with merchandise 31 from more than one manager 30, one of the managers 30 may determine a percentage of its parts being sold by the seller 20 from the total percentage of merchandise sales of the seller 20. Another example may be when the seller 20 sells different brands of goods from the same manager 30, the seller loyalty module 314 determines the percentage of that specific brand of parts sold from a total number of parts from the manager 30, or the total number of parts sold by the seller 20. Thus, the seller loyalty module 314 analyzes the data 220, 240 and provides the reporter 150 with data relating to seller loyalty that may be reported to the user 20, 30.

The accessories module 316 includes measures for accessory sales information, such as a total number of accessories 38 sold by the seller 20. The accessories module 316 reflects the performance of the seller 20. As previously explained, parts 36 and accessories 38 are different; parts 36 are needed for the product to function, while accessories 38 are additional parts that a customer 10 chooses to add to the product 34 and does not affect its performance/functionality. As an example, a part 36 may be an engine while an accessory 38 may be a vehicle bike attachment. Thus, the seller accessories module 314 analyzes the data 220, 240 and provides the reporter 150 with data relating to the accessories 38 sold that may be reported to the user 20, 30.

The service module 318 includes measures for vehicle service information and service productivity, such as parts sales per repair order (RO), and the average days to close a repair order. Therefore, the service module 318 determines measures associated with the service repair order information and provides the reporter 150 with data relating to services that may be reported to the user 20, 30

The seller parts inventory module 320 includes measures relating to the seller's inventory information, such as quantity of merchandise 31 on hand, gross inventory turns (i.e., how many times the inventory of the seller 20 is sold and replaced over a period of time). The seller parts inventory module 320 determines measures associated with of merchandise 31 stocked at the seller 20. Therefore, the seller parts inventory module 320 determines measures associated with the inventory of the seller 20 and provides the reporter 150 with data relating to the inventory of the seller 20 may be reported to the user 20, 30.

The product sales module 322 includes measures for product sales information, such as how fast a product 34 (i.e., a vehicle) is sold from the time the seller 20 receives the product 34 in his inventory, i.e., the difference between a first time when the seller 20 receives the product 34 and a second time when the seller 20 sold the product 34 to a customer 10. The product sales module 322 determines measures associated with the sales of the products 34 and provides the reported 150 with data relating to the product sales, which are later reported to the user 20, 30 via a report 152.

The wholesales module 324 includes measures for wholesale sales information, such as trends in wholesale (e.g., mechanical and collision sales) that the seller(s) 20 purchase from the manager 30. For example, the wholesale module 324 may determine that during the summer season, the seller 20 purchases less windshield wipers from the manager 30 than during the winter season. The wholesales module 324 provides the reporter 150 with information relating to wholesale based on the data 220, 240 analyzed, and the reported 150 may in turn include the analyzed data in its report 152 to the user 20, 30.

The pricing intelligence module 326 includes measures and reports for pricing intelligence information, such as a manufacturer suggested retail price (MSRP) of a part, a dealer retail price, a transaction price, and/or a core price. Other information is possible as well.

The dimensions portion 330 includes dimensions each defined as a data element that categorizes items in a data set (e.g., seller data 220 and internal data 240) into non-overlapping regions. The dimensions portion 330 provides the means to organize (i.e., slice and dice) the data 220, 240 in a report 152. For example, the dimensions portion 330 allows a user 20, 30 to filter the data 230, 240 of a report 152 based on the dimensions 350. The following are the key dimensions identified for key analytics and reporting: time dimension 322; seller dimension 334; product dimension 336; sales channel dimension 338; and vehicles-in-operation (VIO) dimension 340. Other dimensions may be possible as well. Therefore, the modules 310 and the dimensions 330 analyze the data 220, 240 to provide the analyzed data to the reporter 150 and report to the user 20, 30.

The time dimension 332 includes the breakdown of time for queries when specifying a date or date range (by year, month, quarter). For example, a user 20, 30 may want a report 152 for a specified period of time, the time module 332 analyzes the data 220, 240 and provides the user 20, 30 with the requested information based on the specified dates. The seller dimension 334 includes the breakdown and grouping of data associated by seller information, such as brand 32, region, area, programs enrolled, or any related seller information. For example, the user 20, 30 may want a report for all sellers 30 who sell a specific brand 32; the seller dimension 334 allows the user 20, 30 to view that report since it analyzes the data 220, 240 and groups the data based on seller information. The product dimension 336 includes the breakdown and grouping of data associated by part type, such as tactical segments (e.g., mechanical, brakes, etc.), HTG, part number, etc. The sales channel dimension 338 includes the breakdown and grouping of data associated to seller merchandise sales, through various channels, such as workshop, customer pay, warranty, wholesale, or any other channels. The VIO dimension 340 includes the breakdown and grouping of data by VIO segments (e.g. Segment 1, Segment 2, . . . where each segment includes one or more vehicle model years).

Table 14 below and FIGS. 2C and 3 show each listed dimension 332-340 broken down into at least one category (sub-dimensions), where each sub-dimension further narrows the dimension 330 to further categorize and group items in the data set (e.g., seller data 220 and internal data 240) into non-overlapping regions

TABLE 14

| | | | | Data |
|---|---|---|---|---|
| Dimension | Category | Description | Example | Source |
| Time 332 | From - To | Date Range with a | 201401-201409 | Calendar |
| | (Month) | defined beginning | | |
| | | month and defined | | |
| | | ending month | | |
| Time 332 | MTD | Month To Date | 201401 | Calendar |
| | | (Single Month) | | |
| Time 332 | QTD | Quarter to Date | 201404-201406 | Calendar |
| | | (Range from | | |
| | | beginning of | | |
| | | quarter to defined | | |
| | | ending month) | | |
| Time 332 | YTD | Year to Date | 201401-201410 | Calendar |
| | | (Range from | | |
| | | January of year | | |
| | | for defined | | |
| | | ending month) | | |
| Time 332 | R12 | Rolling 12 Month | 201305-201404 | Calendar |
| | | (Range from - 12 | | |
| | | Months from | | |
| | | defined ending | | |
| | | month) | | |
| Seller 334 | National | Country of Data | USA | Seller |
| | | source | | Master |
| | | | | 242 |
| Seller 334 | Region | Subset of national | Eastern | Seller |
| | | that is assigned | Southern | Master |
| | | to be managed | Western | 242 |
| | | via a regional | | |
| | | office. | | |
| Seller 334 | Area | Subset of Region | 73 | Seller |
| | | that is assigned | 76 | Master |
| | | to an area | 79 | 242 |
| | | manager/team | | |
| Seller 334 | Dealer | Single operating | 401158 | Seller |
| | | point that services | 401865 | Master |
| | | the end consumer | 409348 | 242 |
| Product | Product | Make of the | Brand A | Seller |
| 336 | Brand | product being | Brands B | Master |
| | | sold | Both | 242 |
| | | | Other | |
| Product | Product | Breakdown of | Accessories | Parts |
| 336 | Group | parts into the | Collision | Category |
| | | highest level of | Mechanical | Master |
| | | categorization. | | 246, 248 |
| Product | Major | Subset of product | Brake Fluid | Parts |
| 336 | Tactical | groups. Provides a | Transmission Oil | Category |
| | | more detailed | Other Oil/Fluids | Master |
| | | grouping | | 246, 248 |
| | | of products. | | |
| Product | Minor | Subset of major | Chassis kits | Parts |
| 336 | Tactical | tactical. Provides | Springs | Category |
| | | a more detailed | Chassis kit | Master |
| | | grouping | | 246, 248 |
| | | of products. | | |
| Product | HTG | Subset of Minor | Infotainment | Parts |
| 336 | | Tactical. Provides | Comfort and | Category |
| | | a more detailed | Safety | Master |
| | | grouping | Light and Vision | 246, 248 |
| | | of products. | | |
| Product | Part | Part number | 8A2919253E | Parts |
| 336 | Number | assigned to part | 3059192551 | Category |
| | | | 4L0919257D | Master |
| | | | | 246, 248 |
| Product | Part Type | Delineates parts by | TACHOMETER | Parts |
| 336 | | Genuine OEM, | WARN LAMP | Category |
| | | Genuine Economy, | MOUNTING | Master |
| | | Aftermarket | | 246, 248 |
| Sales | Warranty | Sales that were | | Dealer |
| Channel | | covered | | Purchases |
| 338 | | under OEM | | 250 |
| | | manufacturers | | |
| | | warranty | | |
| Sales | Customer | Sales that are | | Seller |
| Channel | Pay | paid for by the | | Parts |
| 338 | | end customer | | Invoices |
| | | | | 312 |
| Sales | Wholesale | Sales that are | | Seller |
| Channel | | made to a | | Parts |
| 338 | | wholesale | | Invoices |
| | | customer | | 312 |
| | | (counter) | | |
| Sales | Workshop | Sales that were | | Seller |
| Channel | | a result of a | | Parts |
| 338 | | workshop RO | | Invoices |
| | | | | 312 |
| Sales | Returns | Sales that have a | | Seller |
| Channel | | negative value | | Parts |
| 338 | | | | Invoices |
| | | | | 312 |
| VIO 340 | 15 Year | Vehicles within | | Brand |
| | | a specific | | A/B |
| | | market for the | | VIO 254 |
| | | prior 15 model | | |
| | | years | | |
| VIO 340 | Segment 1 | (MY prior | | Brand |
| | | Year-4) - (MY | | A/B |
| | | prior Year) | | VIO 254 |
| VIO 340 | Segment 2 | (MY prior | | Brand |
| | | Year-7) - (MY | | A/B |
| | | prior Year-5) | | VIO 254 |
| VIO 340 | Segment 3 | (MY prior | | Brand |
| | | Year-13) - (MY | | A/B |
| | | prior Year-8) | | VIO 254 |

The measures portion 350 includes measures that define a property on which calculations (e.g., sum, count, average, minimum, and maximum) are made. The measures portion 350 includes metrics 352-374, such as sales, margin, quantity sold, etc. The analyzer 300 calculates and the reporter 150 reports on a variety of measures related to aftersales of merchandise 31 of one or more brands 32. The following section provides an overview and details of these metrics.

Parts 36 that are ultimately installed on a product 34 may change hands multiple times before the part 36 is actually installed on a customer's vehicle. For example, a customer 10 purchases brakes at a seller 20 and requests that the seller 20 install the brakes. In some cases, the seller 20 may not have the brakes in his inventory, and might need to contact another seller 20 or the manager 30 to get the brakes that the customer 10 needs. The parts flow (transactions) metrics 352 classifies the flow of the parts into the following two major categories: Sell In Transactions/Purchases (Dealer Purchases; and Sell Out Transactions/Sales (Dealer Sales/Invoices).

The Sell In Transactions/Purchases (Seller Purchases) includes parts 36 that the seller 20 purchases from a manager that exclusively sells merchandise 31 of a specific brand 32. These parts 36 may be further divided into: PDC Shipped (Part Distribution Center, parts shipped from a manager 30 of a specific brand 32 to the seller 20); Direct/Vendor Shipping (parts shipped from vendor warehouses); or Port Installed Accessories (accessories 36 that are installed on the product 34 by the manager 30 of the specific brand 32 (e.g., at a port after shipment).

Sell Out Transactions/Sales (Seller Sales/Invoices) includes merchandise 31 that sellers 20 sell to their customers 10 including vehicle owners, repair/body shops and do-it-yourself individuals. These sales may be further classified into following categories: Warranty Sales, which are parts 36 sold/used for repairs that are covered by a manager warranty; Customer Pay Sales, which are parts sold/used for repairs that are not covered by manager warranty (usually paid for by the customer 10 out of pocket); Workshop Sales, which are parts sold by a parts department of the seller 20 to a service department of the seller 20, which may be either warranty parts or customer pay parts; Wholesale Sales, which are parts 36 sold to a seller parts department to trade accounts (repair/body shops, do-it-yourself individuals, other sellers 20, specialty stores, etc.). These parts 36 may either be warranty or customer pay, although most of them are customer pay.

Genuine and Non-Genuine Parts 354 is another metrics in the measures portion 350 of the analyzer 300. The analyzer 300 determines a part 36 is a genuine part if it is sold by a seller 20 and its part number matches the part master file 246 (FIG. 3). The analyzer 300 compares the part number received from the seller management system 200 and compares the received part number to the part numbers stored in the part master file 246. In some examples, the analyzer 300 removes dashes and spaces from one of the part numbers before comparing the remaining string of data. If the two part numbers match, then the part with the part number from the seller management system 200 is considered as a genuine part (i.e., supplied by the manager 30 of a specific brand 32), otherwise, the part 36 is considered non-genuine or in other words an after-market part. Aftermarket parts are parts produced by a different manager 30 than the manager providing the product 34. For example, if a customer 10 has a product 34 (e.g., a vehicle) of brand A, and the customer 10 needs to replace a part 36 of the vehicle 34, then the part may also be supplied (i.e., and manufactured) by Brand A that is the same brand 32 as the product, or the part 36 may be provided by a different brand i.e., aftermarket or non-genuine part.

In some examples, the seller 20 sells merchandise for two or more brands 32. The two or more brands 32 may have shared parts 36 and accessories 38 that may be simultaneously used for the products 34 of both brands 32. Therefore, the analyzer 300 may determine the Exclusive and Common Parts amongst the different brands 356. Exclusive parts are parts that are only for one brand 32. Common parts are parts that are common to two or more brands 32. In some instances, sellers 20 may be exclusive sellers 20 and only sell and carry merchandise 31 relating to a specific brand 32, which includes merchandise 31 that may be common to more than one brand 32. For example, and exclusive Brands A seller 20 may only sell Brand A merchandise or Brand A merchandise 31 and any Brand B merchandise that may also be used on any Brand A products 34. This metrics 356 provides an overview of the brand 32 specific parts sales.

Brand sales metrics 358 of the measures portion 350 includes sales of sellers 20 of a specific brand 32. For example, each sales of merchandise 31 of a specific brand 32 may include sales of parts of that specific brand 32 or sales of parts that are common to one or more brands 32.

Dual Branded Dealers 360 include multiple brands. Brand A and Brand B brands may be international companies that operate in the USA as a national sales company (NSC) with a larger network of independent authorized sellers 20 as their consumer retail channel for vehicle sales, service and parts wholesale. These sellers 20 operate as either exclusive Brand A, exclusive Brand B or as a dual branded facility (Brand A and Brand B under the same rooftop). For the purposes of this application Brand A and Brand B are brands and are reported completely independent.

Wholesale Sales metrics 362 includes sales identified by the seller 20 on its seller invoice to a customer 10 as ‘wholesale’ sales. The seller data management system 200 identifies the ‘wholesale’ sales based on a “Sales Type”, which is identified when the seller 20 first enters the information of a new customer 10 and identifies the customer 10 as a specialty shop or a resale shop.

The system 100 is configured to classify and measure the sales of merchandise 31 made by the seller 20 based on the type of merchandise 31 (e.g., product 34, part 36, accessories 38) and based on the channel that the merchandise went through before being sold to the customer 10. Parts Sales Classification metrics 364 includes multiple sub-metrics that include, but are not limited to: Total Sales are sales of all parts including genuine and non-genuine, net of returns; Total Wholesale Sales are sales of parts including genuine and non-genuine, net of returns to wholesale customers 10; Total Returns are returns of all parts including genuine and non-genuine, net of returns; OEM/Brand Sales: are sales of genuine parts, net of returns. For each brand, the sales of genuine parts includes sales of a part that is configured for use in one or more brand 32 of the same manager 30. In some implementations, the brand/OEM sales are further divided into the following components: Brand Warranty Sales, which are OEM/Brand parts sales for warranty repairs, and are calculated using parts claimed by a seller 20 on warranty claims (e.g., of a part 36); Brand Wholesale Sales are OEM/Brand parts sales to wholesale customers; Brand Workshop Sales are OEM/Brand parts sales less wholesale sales; Brand Customer Pay Sales are OEM/Brand parts sales less the warranty sales; Brand Workshop Customer Pay Sales are OEM/Brand parts sales less the warranty sales and wholesale sales (in some examples, all wholesale sales are non-warranty sales; Brand Customer Returns are OEM/Brand parts returned by the customer 10.

The metrics portion 350 is configured to analyze data 220, 240 and determine price information of merchandise at different levels of the system 100, for example, the price of a specific part 36 at the manager 30, then at the seller 20, and finally the price that the customer 10 pays. Part Price Levels metrics 366 analyzes the data 220, 240 and provides an analysis of the prices in the multi-tier distribution. Part Price Levels metrics 366 include sub-metrics such as, but not limited to: Seller Transaction Price, which is part sales calculated using the seller's actual transaction price for the part; Seller List Price, which is part sales calculated using seller's list price for the part; and Seller Cost Price, which is part sales calculated using seller's cost for the part. If cost price is not available for any transaction, the system may use part dealer net from Brand A part master; MSRP (Manufacturer's Suggested Retail Price) is part sales calculated using the MSRP from the parts master. Dealer Net: These are part sales calculated using dealer net from seller parts master 246.

Another metric 350 is the VIO Metric 368, which determines sales based on the number of vehicles in operation. The VIO metric 368 facilitates the comparison amongst sellers 20 and also accounts for any year over year fluctuations in the sales due to VIO changes. In some examples, the system 100 tracks the following VIO segments:
1-15 Year VIO;
Segment 1 VIO=(MY prior Year−4)-(MY prior Year), for example, if the current Calendar Year is 2014, Segment 1 is 2010-2013
Segment 2 VIO=(MY prior Year−7)-(MY prior Year−5), for example, if the Current Calendar Year is 2014, Segment 1 is 2007-2009
Segment 3 VIO=(MY prior Year−13)-(MY prior Year-8), for example, if the Current Calendar Year 2014, Segment 1 is 2001-2006

Dealer Gross Margin metrics 370 are calculated using actual/transaction price and seller cost. In case the dealer cost is not available on the transaction, the transaction is not included in the margin calculation.

Peer Benchmarks metrics 372 facilitate comparing a seller's performance within a representative group. In some examples, the system 100 calculates and reports the following peer benchmarks:
National: Average, Top 25%, Bottom 25%
Region: Average, Top 25%, Bottom 25%
Area: Average, Top 25%, Bottom 25%
Program Specific Dealer Group: Average, Top 25%, Bottom 25% (TBD)

Year over Year Comparisons metrics 374 calculate following year over year comparisons for various metrics: Year to Date (YTD); Quarter to Date (QTD); Month to Date (MTD).

Table 15 provides a description of some of the commonly used terms in Tables 16-51 for calculating metrics of the analyzer 300.

TABLE 15

| Element | Field Source |
|---|---|
| Quantity (QTY) | Dealer Parts Invoice. Quantity |
| Transaction Price | Dealer Parts Invoice. Unit Price or |
| | Dealer Parts Invoice. Net Price/Dealer |
| | Parts Invoice.Quantity if Unit Price is |
| | null or zero |
| Dealer Net | Brands A Part Master. Dealer Net |
| Warranty Price | Dealer Parts Purchases. Warranty Claim/ |
| | Dealer Parts Purchases. Warranty Quantity |
| Warranty Quantity | Dealer Parts Purchases. Warranty Quantity |
| Claimed (WAR_QTY) | |
| OEM (Original | Brand A (or any other Brands used) |
| Equipment | |
| Manufacturer) | |

As shown in FIG. 3, the modules 310, 312-326, dimensions 330, 332-340, and the measures 350, 352-374 simultaneously analyze the data 220, 230 to provide the reports 152 via the reporter 150.

Below are details on each metric of the analyzer 300 available in the system 100. Each table includes the name of the metrics, the module name (as previously described, a module is a way of grouping or categorizing measures or metrics and reports), the description of the metrics, the method of calculation/formula used, and the source of data that the calculations are based on.

TABLE 16

| Ref ID | MP1 | |
|---|---|---|
| Name | All Total Sales Dollars | |
| Module | Parts | |
| Description | • | Identifies the total parts sales net of returns |
| | | including both genuine and aftermarket parts |
| | • | Sales are available at dealer transaction price |
| Calculation/ | • | SUM(QTY × PRICE) WHERE dealer is either Brand A |
| Formula | | (for Brand A reports)/Brand B (for Brand B Reports) |
| | • | PRICE can be one of the following: DEALER |
| | | TRANSACTION PRICE, DEALERNET |

| | |
|---|---|
| Associated | Dealer Parts Invoices 222 (FIG. 2B) |
| Dataset | |

TABLE 17

| Ref ID | MP2 | |
|---|---|---|
| Name | OEM Total Sales Dollars | |
| Module | Parts | |
| Description | • | Identifies the total OEM parts sales net of |
| | | returns for genuine parts only. |
| | • | Sales are available at different price levels including |
| | | Transaction Price and Dealer Net |
| Calculation/ | • | SUM(QTY × PRICE) WHERE Part Number is in |
| Formula | | PMF And Part PART_INTG is either ‘BOTH’ or |
| | | rand A (for Brand A reports)/Brand B |
| | | (for Brand B Reports) |
| | • | PRICE can be one of the following: DEALER |
| | | TRANSACTION PRICE, DEALERNET |

| | |
|---|---|
| Associated | Dealer Parts Invoices 222 (FIG. 2B) |
| Dataset | Part Master File 246 (FIG. 2C) |

TABLE 18

| Ref ID | MP3 | |
|---|---|---|
| Name | All Wholesale Sales Dollars | |
| Module | Parts | |
| Description | • | Identifies the wholesale parts sales net of returns |
| | | including genuine and aftermarket parts |
| | • | Sales are available at different at dealer transaction price |
| Calculation/ | • | SUM(QTY × PRICE) WHERE dealer is either |
| Formula | | Brand A (for Brand A reports)/Brand B |
| | | (for Brand B Reports) |
| | • | PRICE can be one of the following: |
| | | TRANSACTION PRICE |

| | |
|---|---|
| Associated | Seller Parts Invoices 222 (FIG. 2B) |
| Dataset | |

TABLE 19

| Ref ID | MP4 | |
|---|---|---|
| Name | OEM Wholesale Sales Dollars | |
| Module | Parts | |
| Description | • | Identifies OEM wholesale parts sales net of |
| | | returns for genuine parts only |
| | • | Sales are available at different price levels including |
| | | Transaction Price and Dealer Net |
| Calculation/ | • | SUM(QTY × PRICE) WHERE Part Number is in PMF |
| Formula | | And Part PART_INTG is either ‘BOTH’ or Brand A |
| | | (for Brand A reports)/Brand B (for Brand B Reports) |
| | • | PRICE can be one of the following: DEALER |
| | | TRANSACTION PRICE, DEALERNET |

| | |
|---|---|
| Associated | Seller Parts Invoices 222 (FIG. 2B) |
| Dataset | Part Master File 246 (FIG. 2C) |

TABLE 20

| Ref ID | MP5 | |
|---|---|---|
| Name | OEM Warranty Sales Dollars | |
| Module | Parts | |
| Description | • | Identifies the total warranty parts sales for |
| | | genuine parts only |
| | • | Sales are available at different price levels |
| | | including warranty claim price and Dealer Net |
| Calculation/ | • | SUM(WAR_QTY × PRICE) WHERE Part Number |
| Formula | | is in PMF And Part PART_INTG is either ‘BOTH’ |
| | | Brand A or Brand A (for reports)/Brand B |
| | | (for Brand B Reports) |
| | • | PRICE can be one of the following: DEALER |
| | | Warranty Price |

| | |
|---|---|
| Associated | Seller Part Number Purchases 252 (FIG. 2C) (if the |
| Dataset | seller 20 is selling merchandise for more than one brand |
| | 32, then the seller part number data set 252 is divided |
| | in multiple data sets each including a brand 32 |
| | that the seller 20 is selling) |
| | Part Master File 246 (FIG. 2C) |

TABLE 21

| Ref ID | MP6 | |
|---|---|---|
| Name | Total Customer Returns Dollars | |
| Module | Parts | |
| Description | • | Identifies the total dealer parts returns including |
| | | genuine and aftermarket |
| | • | Sales are available at different price levels |
| | | including dealer transaction price |
| Calculation/ | • | SUM((If(Dealer Parts Invoices.Quantity<0) or if |
| Formula | | (Dealer Parts Invoices.unit price<0) or if |
| | | (Dealer Parts Invoices.Net Price<0)) |
| | | then ABS(QTY)*PRICE |
| | • | PRICE can be one of the following: |
| | | TRANSACTION PRICE |

| | |
|---|---|
| Associated | Seller Parts Invoices 222 (FIG. 2B) |
| Dataset | |

TABLE 22

| Ref ID | MP7 | |
|---|---|---|
| Name | OEM Customer Returns Dollars | |
| Module | Parts | |
| Description | • | Identifies the total dealer parts returns for |
| | | genuine parts only |
| | • | Sales are available at different price levels |
| | | including dealer transaction price and dealer net |
| Calculation/ | • | SUM((If(Dealer Parts Invoices.Quantity<0) or if |
| Formula | | (Dealer Parts Invoices.unit price<0) or if |
| | | (Dealer Parts Invoices.Net Price<0)) then |
| | | ABS(QTY)*(PRICE) WHERE Part Number in |
| | | (OEM Part Master WHERE PART_INTG in |
| | | (‘BOTH’ or Respective OEM ) |
| | • | PRICE can be one of the following: DEALER |
| | | TRANSACTION PRICE, DEALERNET |

| | |
|---|---|
| Associated | Seller Parts Invoices 222 (FIG. 2B) |
| Dataset | Part Master File 246 (FIG. 2C) |

TABLE 23

| Ref ID | MP8 | |
|---|---|---|
| Name | OEM Customer Pay (CP) Sales Dollars | |
| Module | Parts | |
| Description | • | Identifies the total dealer customer pay parts sales |
| | | for genuine parts only |
| | • | Sales are available at different price levels including |
| | | dealer transaction price and dealer net |

| | |
|---|---|
| Calculation/ | OEM Total Sales Dollars (MP2) - OEM Warranty |
| Formula | Sales Dollars (MP5) |
| Associated | Seller Parts Invoices 222 (FIG. 2B) |
| Dataset | Part Master File 246 (FIG. 2C) |
| | Seller Part Number Purchases 252 (FIG. 2C) |
| | (if the seller 20 is selling merchandise for more than |
| | one brand 32, then the seller part number data set |
| | 252 is divided in multiple data sets each including a |
| | brand 32 that the seller 20 is selling) |

TABLE 24

| Ref ID | MP9 | |
|---|---|---|
| Name | OEM Workshop Customer Pay Sales Dollars | |
| Module | Parts | |
| Description | • | Identifies the total dealer customer pay parts sales |
| | | for genuine parts through the workshop |
| | • | Sales are available at different price levels including |
| | | dealer transaction price and dealer net |
| | • | Assumes that warranty sales are all workshop |
| | | and not for wholesale |

| | |
|---|---|
| Calculation/ | OEM Customer Pay (CP) Sales Dollars (MP4) - |
| Formula | OEM Wholesale Sales Dollars (MP4) |
| Associated | Seller Parts Invoices 222 (FIG. 2B) |
| Dataset | Part Master File 246 (FIG. 2C) |
| | Seller Part Number Purchases 252 (FIG. 2C) |
| | (if the seller 20 is selling merchandise for more than |
| | one brand 32, then the seller part number data set 252 |
| | is divided in multiple data sets each including a brand 32 |
| | that the seller 20 is selling) |

TABLE 25

| Ref ID | MP10 | |
|---|---|---|
| Name | OEM Total Sales Dollars Per VIO | |
| Module | Parts | |
| Description | • | Identifies per VIO total OEM parts sales net of |
| | | returns for genuine parts only. |
| | • | Sales are available at different price levels including |
| | | dealer transaction price and dealer net |
| Calculation/ | • | SUM(OEM Total Sales Dollar)/SUM(VIO) |
| Formula | • | Sales can be at the following levels: TRANSACTION |
| | | PRICE, DEALERNET, DN, MSRP |
| | • | VIO is 15 year VIO |
| | • | When calculating at aggregate level, calculate |
| | | numerator and denominator separately and then |
| | | calculate the metric. |

| | |
|---|---|
| Associated | Seller Parts Invoices 222 (FIG. 2B) |
| Dataset | Part Master File 246 (FIG. 2C) |
| | Seller VIO 254 (FIG. 2C) (if the seller 20 is selling |
| | vehicles 34 for more than one brand 32, then the seller |
| | VIO data set 254 is divided in multiple data sets each |
| | including a brand 32 that the seller 20 is selling) |

TABLE 26

| Ref ID | MP11 | |
|---|---|---|
| Name | OEM Wholesale Sales Dollars Per VIO | |
| Module | Parts | |
| Description | • | Identifies per VIO OEM wholesale parts sales net |
| | | of returns for genuine parts only |
| | • | Sales are available at different price levels including |
| | | dealer transaction price and dealer net |
| Calculation/ | • | SUM(OEM Wholesale Sales Dollar)/SUM(VIO) |
| Formula | • | Sales can be at the following levels: TRANSACTION |
| | | PRICE, DEALERNET, DN, MSRP |
| | • | VIO is 15 year VIO |
| | • | When calculating at aggregate level, calculate |
| | | numerator and denominator separately and then |
| | | calculate the metric. |

| | |
|---|---|
| Associated | Seller Parts Invoices 222 (FIG. 2B) |
| Dataset | Part Master File 246 (FIG. 2C) |
| | Seller VIO 254 (FIG. 2C) (if the seller 20 is selling |
| | vehicles 34 for more than one brand 32, then the seller |
| | VIO data set 254 is divided in multiple data sets each |
| | including a brand 32 that the seller 20 is selling) |

TABLE 27

| | |
|---|---|
| Ref ID | MP12 |
| Name | OEM Warranty Sales Dollars Per VIO |
| Module | Parts |
| Description | Identifies per VIO, the total warranty parts sales for |
| | genuine parts only |
| | Sales are available at different price levels including dealer |
| | transaction price and dealer net |
| Calculation/ | SUM(OEM Warranty Sales Dollar)/SUM(VIO) |
| Formula | Sales can be at the following levels: WP, DN, MSRP |
| | (Manufacturer's Suggested Retail Price) |
| | VIO is 15 year VIO |
| | When calculating at aggregate level, calculate numerator |
| | and denominator separately and then |
| | calculate the metric. |
| Associated | Seller Parts Invoices 222 (FIG. 2B) |
| Dataset | Part Master File 246 (FIG. 2C) |
| | Seller VIO 254 (FIG. 2C) (if the seller 20 is selling |
| | vehicles 34 for more than one brand 32, then the seller |
| | VIO data set 254 is divided in multiple data sets each |
| | including a brand 32 that the seller 20 is selling) |

TABLE 28

| | |
|---|---|
| Ref ID | MP13 |
| Name | OEM Customer Returns Dollars Per VIO |
| Module | Parts |
| Description | Identifies the total dealer parts returns for genuine |
| | parts only |
| | Sales are available at different price levels including dealer |
| | transaction price and dealer net |
| Calculation/ | SUM(OEM Customer Returns Dollars)/SUM(VIO) |
| Formula | Sales can be at the following levels: TRANSACTION |
| | PRICE, DEALERNET, DN, MSRP |
| | VIO is 15 year VIO |
| | When calculating at aggregate level, calculate numerator |
| | and denominator separately and then calculate |
| | the metric. |
| Associated | Seller Parts Invoices 222 (FIG. 2B) |
| Dataset | Part Master File 246 (FIG. 2C) |

TABLE 29

| | |
|---|---|
| Ref ID | MP14 |
| Name | OEM Customer Pay (CP) Sales Dollars Per VIO |
| Module | Parts |
| Description | Identifies per VIO total dealer customer pay parts sales for |
| | genuine parts only |
| | Sales are available at different price levels including dealer |
| | transaction price and dealer net |
| Calculation/ | SUM(OEM Customer Pay (CP) Sales Dollars)/SUM(VIO) |
| Formula | VIO is 15 year VIO |
| | When calculating at aggregate level, calculate numerator |
| | and denominator separately and then calculate |
| | the metric. |
| Associated | Seller Parts Invoices 222 (FIG. 2B) |
| Dataset | Part Master File 246 (FIG. 2C) |
| | Seller Part Number Purchases 252 (FIG. 2C) (if the seller |
| | 20 is selling merchandise for more than one brand 32, |
| | then the seller part number data set 252 is divided in |
| | multiple data sets each including a brand 32 |
| | that the seller 20 is selling) |

TABLE 30

| | |
|---|---|
| Ref ID | MP15 |
| Name | OEM Workshop Customer Pay Sales Dollars Per VIO |
| Module | Parts |
| Description | Identifies the total dealer customer pay parts sales for |
| | genuine parts through the workshop |
| | Sales are available at different price levels including dealer |
| | transaction price and dealer net |
| | Assumes that warranty sales are all workshop and not |
| | for wholesale |
| Calculation/ | SUM(OEM Workshop Customer Pay Sales Dollars)/ |
| Formula | SUM(VIO) |
| | VIO is 15 year VIO |
| | When calculating at aggregate level, calculate numerator |
| | and denominator separately and then calculate the metric. |
| Associated | Seller Parts Invoices 222 (FIG. 2B) |
| Dataset | Part Master File 246 (FIG. 2C) |
| | Seller Part Number Purchases 252 (FIG. 2C) (if the seller |
| | 20 is selling merchandise for more than one brand 32, |
| | then the seller part number data set 252 is divided in |
| | multiple data sets each including a brand 32 that the |
| | seller 20 is selling) |

TABLE 31

| | |
|---|---|
| Ref ID | MP16 |
| Name | Total Sales Quantity |
| Module | Parts |
| Description | Identifies the total parts quantity sold net of returns |
| | including both genuine and aftermarket parts |
| Calculation/ | SUM(QTY) |
| Formula | |
| Associated | Dealer Parts Invoices (6.1) |
| Dataset | |

TABLE 32

| | |
|---|---|
| Ref ID | MP17 |
| Name | OEM Total Sales Quantity |
| Module | Parts |
| Description | Identifies the total OEM parts quantity sold net of returns |
| | for genuine parts only. |
| Calculation/ | SUM(QTY) WHERE Part Number is OEM Part And Part |
| Formula | PART_INTG is either ‘BOTH’ or Respective OEM |
| Associated | Seller Parts Invoices 222 (FIG. 2B) |
| Dataset | Part Master File 246 (FIG. 2C) |

TABLE 33

| | |
|---|---|
| Ref ID | MP18 |
| Name | Wholesale Sales Quantity |
| Module | Parts |
| Description | Identifies the wholesale parts sold net of returns |
| | including genuine and aftermarket parts |
| Calculation/ | SUM(QTY) WHERE Part Number is OEM Part And |
| Formula | Part.PART_INTG is either ‘BOTH’ or Respective OEM |
| | and (Transaction is Wholesale) |
| Associated | Seller Parts Invoices 222 (FIG. 2B) |
| Dataset | Part Master File 246 (FIG. 2C) |

TABLE 34

| | |
|---|---|
| Ref ID | MP19 |
| Name | OEM Wholesale Sales Quantity |
| Module | Parts |
| Description | Identifies OEM wholesale parts sold net of returns for |
| | genuine parts only |
| Calculation/ | SUM(QTY) WHERE Part Number is OEM Part And |
| Formula | Part.PART_INTG is either ‘BOTH’ or Respective OEM |
| | and (Transaction is Wholesale) |
| Associated | Seller Parts Invoices 222 (FIG. 2B) |
| Dataset | Part Master File 246 (FIG. 2C) |

TABLE 35

| | |
|---|---|
| Ref ID | MP20 |
| Name | OEM Warranty Sales Quantity |
| Module | Parts |
| Description | Identifies the total warranty parts sold for genuine parts |
| | only |
| Calculation/ | SUM(WAR_QTY) WHERE Part Number is OEM Part |
| Formula | And Part.PART_INTG is either ‘BOTH’ or |
| | Respective OEM |
| Associated | Part Master File (6.13) |
| Dataset | Part Master File 246 (FIG. 2C) |
| | Seller Part Number Purchases 252 (FIG. 2C) (if the seller |
| | 20 is selling merchandise for more than one brand 32, |
| | then the seller part number data set 252 is divided in |
| | multiple data sets each including a brand 32 that th |
| | seller 20 is selling) |

TABLE 36

| | |
|---|---|
| Ref ID | MP21 |
| Name | Total Customer Returns Quantity |
| Module | Parts |
| Description | Identifies the total dealer parts returned including |
| | genuine and aftermarket |
| Calculation/ | SUM((If(Dealer Parts Invoices.Quantity<0) or if(Dealer |
| Formula | Parts Invoices.unit price<0) or if(Dealer Parts Invoices.Net |
| | Price<0)) then ABS(QTY) |
| Associated | Dealer Parts Invoices (6.1) |
| Dataset | Part Master File (6.13) |

TABLE 37

| | |
|---|---|
| Ref ID | MP22 |
| Name | OEM Customer Returns Quantity |
| Module | Parts |
| Description | Identifies the total dealer parts returns for genuine parts |
| | only |
| Calculation/ | SUM((If(Dealer Parts Invoices.Quantity<0) or if(Dealer |
| Formula | Parts Invoices.unit price<0) or if(Dealer Parts Invoices.Net |
| | Price<0)) then ABS(QTY)*ABS(Dealer Parts Invoices.Unit |
| | Price)) WHERE Part Number in (OEM Part Master |
| | WHERE PART_INTG in (‘BOTH’ or Respective |
| | OEM) |
| Associated | Seller Parts Invoices 222 (FIG. 2B) |
| Dataset | Part Master File 246 (FIG. 2C) |

TABLE 38

| | |
|---|---|
| Ref ID | MP23 |
| Name | OEM Customer Pay (CP) Sales Quantity |
| Module | Parts |
| Description | Identifies the total dealer customer pay parts sold for |
| | genuine parts only |
| Calculation/ | OEM Total Sales Quantity (MP17) - OEM Warranty |
| Formula | Sales Quantity (MP20) |
| Associated | Seller Parts Invoices 222 (FIG. 2B) |
| Dataset | Part Master File 246 (FIG. 2C) |
| | Seller Part Number Purchases 252 (FIG. 2C) (if the seller |
| | 20 is selling merchandise for more than one brand 32, then |
| | the seller part number data set 252 is divided in multiple |
| | data sets each including a brand 32 that the seller |
| | 20 is selling) |

TABLE 39

| | |
|---|---|
| Ref ID | MP24 |
| Name | OEM Workshop Customer Pay Sales Quantity |
| Module | Parts |
| Description | Identifies the total dealer customer pay parts sold for |
| | genuine parts through the workshop |
| | Assumes that warranty parts sold are all workshop and not |
| | for wholesale |
| Calculation/ | OEM Customer Pay (CP) Sales Quantity (MP23) - |
| Formula | OEM Wholesale Sales Quantity (MP19) |
| Associated | Seller Parts Invoices 222 (FIG. 2B) |
| Dataset | Part Master File 246 (FIG. 2C) |
| | Seller Part Number Purchases 252 (FIG. 2C) (if the seller |
| | 20 is selling merchandise for more than one brand 32, |
| | then the seller part number data set 252 is divided in |
| | multiple data sets each including a brand 32 that the |
| | seller 20 is selling) |

TABLE 40

| | |
|---|---|
| Ref ID | MP25 |
| Name | OEM Total Sales Quantity Per VIO |
| Module | Parts |
| Description | Identifies per VIO total OEM parts sold net of returns |
| | for genuine parts only. |
| Calculation/ | SUM(OEM Total Quantity Sold)/SUM(VIO) |
| Formula | VIO is 15 year VIO |
| | When calculating at aggregate level, calculate numerator |
| | and denominator separately and then calculate the metric. |
| Associated | Seller Parts Invoices 222 (FIG. 2B) |
| Dataset | Part Master File 246 (FIG. 2C) |
| | Seller VIO 254 (FIG. 2C) (if the seller 20 is selling |
| | vehicles 34 for more than one brand 32, then the seller |
| | VIO data set 254 is divided in multiple data sets each |
| | including a brand 32 that the seller 20 is selling) |

TABLE 41

| | |
|---|---|
| Ref ID | MP26 |
| Name | OEM Wholesale Sales Quantity Per VIO |
| Module | Parts |
| Description | Identifies per VIO OEM wholesale parts sold net of |
| | returns for genuine parts only |
| Calculation/ | SUM(OEM Wholesale Sales Quantity Sold)/SUM(VIO) |
| Formula | VIO is 15 year VIO |
| | When calculating at aggregate level, calculate numerator |
| | and denominator separately and then calculate the metric. |
| Associated | Seller Parts Invoices 222 (FIG. 2B) |
| Dataset | Part Master File 246 (FIG. 2C) |
| | Seller VIO 254 (FIG. 2C) (if the seller 20 is selling |
| | vehicles 34 for more than one brand 32, then the seller |
| | VIO data set 254 is divided in multiple data sets each |
| | including a brand 32 that the seller 20 is selling) |

TABLE 42

| | |
|---|---|
| Ref ID | MP27 |
| Name | OEM Warranty Sales Quantity Per VIO |
| Module | Parts |
| Description | Identifies per VIO, the total warranty parts sold for |
| | genuine parts only |
| Calculation/ | SUM(OEM Warranty Sales Dollar)/SUM(VIO) |
| Formula | VIO is 15 year VIO |
| | When calculating at aggregate level, calculate numerator |
| | and denominator separately and then calculate the metric. |
| Associated | Seller Part Number Purchases 252 (FIG. 2C) (if the seller |
| Dataset | 20 is selling merchandise for more than one brand 32, then |
| | the seller part number data set 252 is divided in multiple |
| | data sets each including a brand 32 that the seller |
| | 20 is selling) |
| | Part Master File 246 (FIG. 2C) |
| | Seller VIO 254 (FIG. 2C) (if the seller 20 is selling vehicles |
| | 34 for more than one brand 32, then the seller VIO data |
| | set 254 is divided in multiple data sets each including |
| | a brand 32 that the seller 20 is selling |

TABLE 43

| | |
|---|---|
| Ref ID | MP28 |
| Name | OEM Customer Returns Quantity Per VIO |
| Module | Parts |
| Description | Identifies the total dealer parts returned for genuine parts |
| Calculation/ | only SUM(OEM Customer Returns Quantity)/SUM(VIO) |
| Formula | VIO is 15 year VIO |
| | When calculating at aggregate level, calculate numerator |
| | and denominator separately and then calculate the metric. |
| Associated | Seller Parts Invoices 222 (FIG. 2B) |
| Dataset | Part Master File 246 (FIG. 2C) |

TABLE 44

| | |
|---|---|
| Ref ID | MP29 |
| Name | OEM Customer Pay (CP) Sales Quantity Per VIO |
| Module | Parts |
| Description | Identifies per VIO total dealer customer pay parts sales |
| | for genuine parts only |
| Calculation/ | SUM(OEM Customer Pay (CP) Sales Quantity)/SUM(VIO) |
| Formula | VIO is 15 year VIO |
| | When calculating at aggregate level, calculate numerator |
| | and denominator separately and then calculate the metric. |
| Associated | Seller Parts Invoices 222 (FIG. 2B) |
| Dataset | Part Master File 246 (FIG. 2C) |
| | Seller Part Number Purchases 252 (FIG. 2C) (if the seller |
| | 20 is selling merchandise for more than one brand 32, then |
| | the seller part number data set 252 is divided in multiple |
| | data sets each including a brand 32 that the seller |
| | 20 is selling) |

TABLE 45

| | |
|---|---|
| Ref ID | MP30 |
| Name | OEM Workshop Customer Pay Sales Quantity Per VIO |
| Module | Parts |
| Description | Identifies the total dealer customer pay parts sales for |
| | genuine parts through the workshop |
| | Assumes that warranty parts sold are all workshop and |
| | not for wholesale |
| Calculation/ | SUM(OEM Workshop Customer Pay Sales Quantity)/ |
| | SUM(VIO) |
| Formula | VIO is 15 year VIO |
| | When calculating at aggregate level, calculate numerator |
| | and denominator separately and then calculate the metric. |
| Associated | Seller Parts Invoices 222 (FIG. 2B) |
| Dataset | Part Master File 246 (FIG. 2C) |
| | Seller Part Number Purchases 252 (FIG. 2C) (if the seller |
| | 20 is selling merchandise for more than one brand 32, |
| | then the seller part number data set 252 is divided in |
| | multiple data sets each including a brand 32 that the |
| | seller 20 is selling) |

TABLE 46

| | |
|---|---|
| Ref ID | ML1 |
| Name | Lost Parts Sales Opportunity Dollars (Loyalty Opportunity $) |
| Module | Loyalty |
| Description | Identifies the Lost Sales Opportunity Dollars (LSO) for genuine parts |
| | over rolling 12-month period. The LSO is calculated at P/N level and |
| | then aggregated as needed. |
| Calculation/ | Measured over rolling 12 month period (includes only the parts |
| Formula | with units sold more than 10 annually) |
| | Lost Sales Opportunity Units = Quantity sold − Quantity |
| | purchased from Brand A − (Beginning Inventory − Ending Inventory) |
| | Lost Sales Opportunity $ = Lost Sales Opportunity × Dealer Net |
| | Lost Sales % = Lost Sales Opportunity $/Sales $ @ Dealer Net |
| | Sales Loyalty % = 1 − Lost Sales % |
| | Does not include bulk engine oil. |
| | Includes all sales types (e.g. Service, Wholesale, Internal, etc.) |
| | Calculation Flow: |
| | Step: 0: Identify Quantity Used (Starting Inventory − Ending |
| | Inventory + Quantity Purchased), Quantity Sold and Quantity |
| | Purchased. |
| | Step 1: If Quantity Sold is less than Quantity Purchased, Loss Sale |
| | Opportunity is 0 |
| | Step 2: If Quantity Used is less than 0 (it is negative), then Loss |
| | Sale Opportunity is equal to Quantity Sold, |
| | Step 3: If Quantity Used is greater than Quantity Sold, Loss Sale |
| | Opportunity is 0 |
| | Step 4: If none of the above conditions trigger calculate: Loss Sale |
| | Opportunity = Quantity sold − Quantity purchased from Brand A − |
| | (Beginning Inventory − Ending Inventory) |
| Associated | Seller Parts Inventory 224 data (FIG. 2B) |
| Dataset | Seller Parts Invoices 222 (FIG. 2B) |
| | Part Master File 246 (FIG. 2C) |
| | Seller Part Number Purchases 252 (FIG. 2C) (if the seller 20 is selling |
| | merchandise for more than one brand 32, then the seller part number |
| | data set 252 is divided in multiple data sets each including a brand 32 |
| | that the seller 20 is selling) |

TABLE 47

| | |
|---|---|
| Ref ID | ML2 |
| Name | Lost Parts Sales Opportunity % |
| Module | Loyalty |
| Description | Identifies Lost Sales Opportunity % for genuine parts |
| Calculation/ | LSO % = Sum(Lost Sales Opportunity Dollars |
| Formula | (ML1))/Sum(QTY Sold) |
| | Note: It is important that LSO Qty and LSO $ is calculated |
| | at part number level by dealer. Then aggregate LSO |
| | QTY and LSP $ based on the context/scope and |
| | then calculate Loyalty %. |
| Associated | Seller Parts Inventory data 224 (FIG. 2B) |
| Dataset | Seller Parts Invoices 222 (FIG. 2B) |
| | Part Master File 246 (FIG. 2C) |
| | Seller Part Number Purchases 252 (FIG. 2C) (if the seller |
| | 20 is selling merchandise for more than one brand 32, |
| | then the seller part number data set 252 is divided in |
| | multiple data sets each including a brand 32 that the |
| | seller 20 is selling) |

TABLE 48

| | |
|---|---|
| Ref ID | ML3 |
| Name | Parts Sales Loyalty % (Loyalty %) |
| Module | Loyalty |
| Description | Identifies Dealer Parts Sales Loyalty % for genuine parts |
| Calculation/ | 100 − LSO % (ML3) |
| Formula | Note: It is important that LSO Qty and LSO $ is calculated |
| | at part number level by dealer. Then aggregate LSO |
| | QTY and LSP $ based on the context/scope and |
| | then calculate Loyalty %. |
| Associated | Seller Parts Inventory Data 224 (FIG. 2B) |
| Dataset | Seller Parts Invoices 222 (FIG. 2B) |
| | Part Master File 246 (FIG. 2C) |
| | Seller Part Number Purchases 252 (FIG. 2C) (if the seller |
| | 20 is selling merchandise for more than one brand |
| | 32, then the seller part number data set 252 is divided |
| | in multiple data sets each including a brand 32 that |
| | the seller 20 is selling) |

TABLE 49

| | |
|---|---|
| Ref ID | MB1 |
| Name | Dealer Gross Margin % |
| Module | Parts |
| Description | Identifies the dealer gross margin on parts on an invoice. |
| | Gross margin is available for various tactical segments |
| Calculation/ | Dealer Transaction Price (TP) − Dealer Cost Price |
| Formula | (CP)/Dealer Transaction Price (TP) |
| | Calculation Logic: |
| | IF ---Check to see if CP exists-- |
| | Dealer Cost Price (CP) is NULL or 0 |
| | THEN ---CP does not exist--- |
| | (IF ---Check to see if DN exists--- |
| | OEM Dealer Net (DN) is NULL or 0 |
| | THEN ---DN and CP do not exist--- |
| | Drop Record |
| | Else ---DN exists-- |
| | Dealer Transaction Price (TP) − OEM Dealer Net |
| | (DN)/Dealer Transaction Price (TP) |
| | END IF) |
| | ELSE ---CP Exists --- |
| | Dealer Transaction Price (TP) − Dealer Cost Price |
| | (CP)/Dealer Transaction Price (TP) END IF |
| Associated | Seller Parts Invoices 222 (FIG. 2B) |
| Dataset | Part Master File 246 (FIG. 2C) |

TABLE 50

| | |
|---|---|
| Ref ID | MB2 |
| Name | Top 25% |
| Module | ALL |
| Description | Average score of the top 25% dealers within the geography |
| | reported on by metric. Not all metrics will have Top 25% |
| | calculated |
| Calculation/ | --Step 1-- |
| Formula | Determine if a high or low score for a given metric |
| | constitutes the top score. |
| | --Step 2-- |
| | Calculate the number of dealers that make up 25% of the |
| | dealers within the geography for the metric being |
| | reported on. If this is not a round number of dealers |
| | always round up. |
| | --Step 3 |
| | For the top set of dealers for each metric (From step 2) |
| | calculate the SUM (numerator)/SUM |
| | (denominator) of the metric. |
| | ** For Total Dollar Metrics calculate the Average of |
| | Total Dollars. |
| | ** |
| Associated | Any Numeric Dataset |
| Dataset | |

TABLE 51

| | |
|---|---|
| Ref ID | MB3 |
| Name | Bottom 25% |
| Module | ALL |
| Description | Average score of the bottom 25% dealers within the |
| | geography reported on by metric. Not all metrics will |
| | have Bottom 25% calculated |
| Calculation/ | --Step 1-- |
| Formula | Determine if a high or low score for a given metric |
| | constitutes the top score. |
| | --Step 2-- |
| | Calculate the number of dealers that make up 25% of the |
| | dealers within the geography for the metric being |
| | reported on. If this is not a round number of dealers |
| | always round up. |
| | --Step 3 |
| | For the bottom set of dealers for each metric (From step 2) |
| | calculate the SUM (numerator)/SUM (denominator). |
| | ** For Total Dollar Metrics calculate the Average of Total |
| | Dollars. |
| | ** |
| Associated | Any Numeric Dataset |
| Dataset | |

Referring back to FIG. 2A, the reporter 150 is in communication with the data store 120 and the analyzer 300. In some implementations, the reporter 150 generates a report 152 based on the modules 310 (e.g., sub-modules 312-326). The reports 152 may include a table or graphical illustration illustrating the sub-modules 312-326 and sales and service trends over a period of time. In some examples, the reporter 150 generates an interactive report 152 for display on an electronic display 206, 116. In some implementations, the seller 20 or the manager 30 views the report 152 on a web browser or a web-based application in communication with the network 15.

In some implementations, the system 100 includes an electronic display 206, 116 in communication with the system data processor 110. The display 206, 116 is configured to display one or more report types 154 based on the modules 310 and the user 20, 30 selects which report type 154 to view. The electronic display 26. 206, 116 may be a part of a handheld device 22 or a display wirelessly or non-wirelessly connected to the system processor 110. In some examples, certain portions of the report are only available to one or the other of the handheld device 22 or the wirelessly connected display 116.

As previously described, the reports 152 are structured based on the analysis context and the organized module 310 (e.g., sub-modules 312-326) of the analyzer 300. In some examples, the reports 152 are of types including parts reports 154a (Table 52) or seller loyalty reports 154b (Table 53). The parts reports 154a include any reports 152 relating to the quantity and/or quality of the sales provided by the seller 20. The loyalty report 154b includes any reports relating to the loyalty of the seller 20 to the manager 30 (e.g., by tactical, by segment . . . etc.). A user 20, 30 may select a type 154a, 154b via a display 26, 116, 206 and the reporter 150 displays on the display 26, 116, 206 the selected report type 154, 154a, 154b. Table 52 provides detailed information relating to the types of parts reports 154a; while Table 53 provides detailed information relating to the types of loyalty reports 154b.

TABLE 52
Parts Report

| Report Type | Description |
|---|---|
| Sales By Tactical Segment | This report provides key sales metrics by tactical segment, |
| | over a specified time period with drill down by |
| | region/area/dealer |
| Sales By Region | This report provides key sales metrics by |
| | region/area/dealer, over a specified time period with drill |
| | down by tactical segment |
| Monthly Sales Trends | This report provides key monthly sales metrics, over a |
| | specified time period with drill down by dealer |
| Sales Growth by Tactical | This report provides key growth trend for key sales metrics |
| Segment | by tactical segment, over a specified time period with drill |
| | down by region/area/dealer |
| Sales Growth by Region | This report provides key growth trend for key sales metrics |
| | by region/area/dealer segment, over a specified time period |
| | with drill down by tactical segment |
| Sales Benchmarks By | This report provides comparison of key sales metrics by |
| Tactical Segment | tactical segment across dealer peer groups (e.g. region, |
| | area, etc.) over a specified time period with drill down by |
| | region/area/dealer |
| Sales Benchmarks By | This report provides comparison of key sales metrics by |
| Region | dealer across dealer peer groups (e.g. region, area, etc.) |
| | over a specified time period with drill down by tactical |
| | segment |

TABLE 53
Loyalty Report

| Report Type | Description |
|---|---|
| Loyalty By | This report provides the loyalty opportunity by tactical |
| Tactical | segment period with drill down by region/area/dealer |
| Segment | |
| Loyalty By | This report provides the loyalty opportunity by |
| Region | region/area/dealer with drill down by tactical segment |
| Loyalty | This report provides comparison of lost sales opportunity |
| Benchmarks | by tactical segment across dealer peer groups (e.g. region, |
| by Tactical | area, etc.) with drill down by region/area/dealer |
| Segment | |
| Loyalty | This report provides comparison of loyalty opportunity |
| Benchmarks | across dealers (e.g. region, area, etc.) with drill down by |
| by Region | tactical segment |

The sales report types described in Table 52 may be further divided into multiple reports, such as, but not limited to: Sales By Tactical Segment (Product Group) (Table 54); Sales By Tactical Segment (Major Tactical Segment) (Table 55); Sales By Tactical Segment (Minor Tactical Segment) (Table 56); Sales By Tactical Segment (HTG) (Table 57); Sales By Tactical Segment (Part Number) (Table 58). Sales By Region (Table 59); Sales By Area (Table 60); Sales By Dealer (Table 61); Monthly Sales Trends (Table 62); Sales Benchmark By Tactical Segment (Product Group) (Table 63); Sales Benchmark By Tactical Segment (Major Tactical Segment) (Table 64); Sales Benchmark By Tactical Segment (Minor Tactical Segment) (Table 65); Sales Benchmark By Tactical Segment (HTG) (Table 66); Sales Benchmark By Region (Main Screen) (Table 67); Sales Benchmark By Region (Table 68); Sales Benchmark By Area (Table 69); Sales Benchmark By Dealer (Dealer 1) (Table 70); Sales Benchmark By Dealer (Dealer 2) (Table 71); Sales Growth Trends By Tactical Segment (Product Group) (Table 72); Sales Growth Trends By Tactical Segment (Major Tactical Segment) (Table 73); Sales Growth Trends By Tactical Segment (Minor Tactical Segment) (Table 74); Sales By Tactical Segment Growth Trends (By HTG) (Table 75); Sales Growth Trends By Region (Table 76); Sales Growth Trends By Area (Table 77); Sales Growth Trends By Dealer (Table 78).

TABLE 54

| Report Name | Sales By Tactical Segment (Product Group) |
|---|---|
| ID | RP1 |
| Module | Parts |
| Accessible | Menu |
| Description/Purpose/ | For a given time period this report provides key |
| Use Case | parts sales metrics for Brands A and B by |
| | product group. |

Report Structure
Report ROWS

| Row Name | Row Description |
|---|---|
| Product Group | Product Groups is the highest level of tactical segment |
| | (Accessories, Collision etc.) |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| Product Group | Varchar(50) | X | Sales By Tactical |
| | | | Segment (By Major |
| | | | Tactical) for the |
| | | | product group |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Total Sales | Currency (Rounded to | MP1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| From | Calendar | Beginning Time period to query data |
| | Dropdown | (Report Includes beginning Month) |
| To | Calendar | Ending Time period to query data |
| | Dropdown | (Report includes ending month) |

TABLE 55

| Report Name | Sales By Tactical Segment (Major Tactical Segment) |
|---|---|
| ID | RP2 |
| Module | Parts |
| Accessible | Menu |
| Description/ | For a given time period this report provides key |
| Purpose/ | parts sales metrics for Brand A/B parts by Major |
| Use Case | Tactical Segment. |

Report Structure
Report ROWS

| Row Name | Row Description |
|---|---|
| Major Tactical | Major Tactical Segment is the next level of tactical |
| Segment | segment (Brakes, etc.) |
| TOTAL | This row returns the Total for all tactical segment and is |
| | appended to the last row of the report (bottom) |

Report COLUMNS

| | | Drilldown/ | Drilldown/Hyperlink |
|---|---|---|---|
| Column Description | Column Format | Hyperlink | Destination |
| Major Tactical | Varchar(50) | X | For selected major |
| Segment | | | tactical segment drill |
| | | | down and showing |
| | | | output for each Minor |
| | | | segment |
| Region | Varchar(50) | X | For selected major |
| | | | tactical segment drill |
| | | | down and showing |
| | | | output for each region |
| Area | Varchar(50) | X | For selected major |
| | | | tactical segment drill |
| | | | down and showing |
| | | | output for each area |
| Dealer | Varchar(50) | X | For selected major |
| | | | tactical segment drill |
| | | | down and showing |
| | | | output for each dealer |

| Column Description | Column Format | Metric ID |
|---|---|---|
| Total Sales | Currency (Rounded to | MP1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| From | Calendar | Beginning Time period to query data |
| | Dropdown | (Report Includes beginning Month) |
| To | Calendar | Ending Time period to query data |
| | Dropdown | (Report includes ending month) |

TABLE 56

| | Sales By Tactical Segment |
|---|---|
| Report Name | (Minor Tactical Segment) |
| ID | RP3 |
| Module | Parts |
| Accessible | Menu |
| Description/Purpose/ | For a given time period this report provides key |
| Use Case | parts sales metrics for Brand A/B parts by Minor |
| | Tactical Segment |

Report Structure
Report ROWS

| Row Name | Row Description |
|---|---|
| Major Tactical | Minor Tactical Segment is the next level of tactical |
| Segment | segment (e.g. Brake Pads etc.) |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| Minor Tactical | Varchar(50) | X | For selected minor |
| Segment | | | tactical segment drill |
| | | | down and showing |
| | | | output for each |
| | | | Minor segment |
| Region | Varchar(50) | X | For selected minor |
| | | | tactical segment drill |
| | | | down and showing |
| | | | output for each |
| | | | region |
| Area | Varchar(50) | X | For selected minor |
| | | | tactical segment drill |
| | | | down and showing |
| | | | output for each area |
| Dealer | Varchar(50) | X | For selected minor |
| | | | tactical segment drill |
| | | | down and showing |
| | | | output for each |
| | | | dealer |

| Column Description | Column Format | Metric ID |
|---|---|---|
| Total Sales | Currency (Rounded to | MP1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| From | Calendar | Beginning Time period to query data |
| | Dropdown | (Report Includes beginning |
| | | Month) |
| To | Calendar | Ending Time period to query data |
| | Dropdown | (Report includes ending |
| | | month) |

TABLE 57

| Report Name | Sales By Tactical Segment (HTG) |
|---|---|
| ID | RP4 |
| Module | Parts |
| Accessible | Menu |
| Description/Purpose/ | For a given time period this report provides key |
| Use Case | parts sales metrics for Brand A/B parts by HTG. |

Report Structure
Report ROWS

| Row Name | Row Description |
|---|---|
| Major Tactical | HTG Tactical Segment is the next level of tactical |
| Segment | segment. |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| HTG | Varchar(50) | X | For selected HTG |
| | | | drill down and |
| | | | showing output for |
| | | | each Part Number |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Total Sales | Currency (Rounded to | MP1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| From | Calendar | Beginning Time period to query data |
| | Dropdown | (Report Includes beginning Month) |
| To | Calendar | Ending Time period to query data |
| | Dropdown | (Report includes ending month) |

TABLE 58

| Report Name | Sales By Tactical Segment (Part Number) |
|---|---|
| ID | RP5 |
| Module | Parts |
| Accessible | Menu |
| Description/Purpose/ | For a given time period this report provides key |
| Use Case | parts sales metrics for Brand A/B parts by P/N. |

Report Structure
Report ROWS

| Row Name | Row Description |
|---|---|
| P/N | Part Number is the next level of tactical segment |
| TOTAL | This row returns the Total for all part numbers and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| Part Number | Varchar(50) | | For selected P/N |
| | | | drill down and |
| | | | showing output for |
| | | | each Part Number |
| Region | Varchar(50) | X | For selected P/N |
| | | | drill down and |
| | | | showing output for |
| | | | each region |
| Area | Varchar(50) | X | For selected P/N |
| | | | drill down and |
| | | | showing output for |
| | | | each area |
| Dealer | Varchar(50) | X | For selected P/N |
| | | | drill down and |
| | | | showing output for |
| | | | each dealer |

| Column Description | Column Format | Metric ID |
|---|---|---|
| Total Sales | Currency (Rounded to | MP1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter | | |
|---|---|---|
| Description | Control Type | Function/Purpose |
| Dealer Code | Autocomplete | Dealer code |
| | Text | |
| Dealer Name | Autocomplete | Dealer Name |
| | Text | |
| Metric | Dropdown | Quantity, $, $/VIO |
| Price | Dropdown | Transaction Price, Dealer Net |
| Region | Dropdown | Dropdown to select specific Region. |
| | | Optional |
| Area | Dependent | Dropdown to select specific area. Optional |
| | Dropdown | |
| From | Calendar | Beginning Time period to query data |
| | Dropdown | (Report Includes beginning Month) |
| To | Calendar | Ending Time period to query data (Report |
| | Dropdown | includes ending month) |

TABLE 59

| Report Name | Sales By Region |
|---|---|
| ID | RP6 |
| Module | Parts |
| Accessible | Menu |
| Description/Purpose/ | For a given time period this report provides key parts sales |
| Use Case | metrics for Brand AB by Region/Area/Dealer. |

Report Structure
Report ROWS

| Row Name | Row Description |
|---|---|
| Region | Region Aggregate |
| TOTAL | This row returns the Total and is appended to the last row of |
| | the report (bottom) |

Report COLUMNS

| | | | Drilldown/ |
|---|---|---|---|
| | | Drilldown/ | Hyperlink |
| Column Description | Column Format | Hyperlink | Destination |
| Region | Varchar (50) | | For selected tactical |
| | | | segment drill down |
| | | | and showing output |
| | | | for each dealer in |
| | | | the region |
| Area | Varchar (50) | X | For selected tactical |
| | | | segment drill down |
| | | | and showing output |
| | | | for each area |
| Dealer | Varchar (50) | X | For selected tactical |
| | | | segment drill down |
| | | | and showing output |
| | | | for each dealer |
| Product Group | Varchar (50) | X | For selected region, |
| | | | drill down the |
| | | | product group |
| Column Description | Column Format | Metric ID | |
| Total Sales | Currency (Rounded to | MP1 | |
| | dollar) or Integer | | |
| Warranty Sales | Currency (Rounded to | MP5 | |
| | dollar) or Integer | | |
| CP Sales | Currency (Rounded to | MP8 | |
| | dollar) or Integer | | |
| Workshop Sales | Currency (Rounded to | MP9 | |
| | dollar) or Integer | | |
| Wholesale Sales | Currency (Rounded to | MP4 | |
| | dollar) or Integer | | |

Report Dimensions

| Filter Description | Control Type | Function/ Purpose |
|---|---|---|
| Dealer Code | Autocomplete Text | Dealer code |
| Dealer Name | Autocomplete Text | Dealer Name |
| Metric | Dropdown | Quantity, $, $/VIO |
| Price Level | Dropdown | Transaction Price, Dealer Net |
| Product Group | Dropdown | Dropdown to select specific Product Group. |
| | | Optional |
| Major Tactical | Dependent | Dropdown to select specific Major. Optional |
| Segment | Dropdown | |
| Minor Tactical | Dependent | Dropdown to select specific Minor. |
| Segment | Dropdown | Optional |
| Region | Dropdown | Dropdown to select specific Region. |
| | | Optional |
| Area | Dependent | Dropdown to select specific area. Optional |
| | Dropdown | |
| Time From | Calendar | Beginning Time period to query data (Report |
| | Dropdown | Includes beginning Month) |
| Time To | Calendar | Ending Time period to query data (Report |
| | Dropdown | includes ending month) |

TABLE 60

| Report Name | Sales By Area |
|---|---|
| ID | RP7 |
| Module | Parts |
| Accessible | Menu |
| Description/Purpose/ | For a given time period this report provides key parts |
| Use Case | sales metrics for Brand AB by Area/Dealer. |

Report Structure
Report ROWS

| Row Name | Row Description |
|---|---|
| Area | Area in the scope selected |
| TOTAL | This row returns the Total and is appended to the last |
| | row of the report (bottom) |

Report COLUMNS

| | | Drilldown/ | Drilldown/Hyperlink |
|---|---|---|---|
| Column Description | Column Format | Hyperlink | Destination |
| Area | Varchar(50) | | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer in |
| | | | the area |
| Product Group | Varchar(50) | X | For selected region, |
| | | | drill down the |
| | | | product group |

| Column Description | Column Format | Metric ID |
|---|---|---|
| Total Sales | Currency (Rounded to | MP1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Product Group | Dropdown | Dropdown to select specific |
| | | Product Group. Optional |
| Major Tactical | Dependent | Dropdown to select specific Major. |
| Segment | Dropdown | Optional |
| Minor Tactical | Dependent | Dropdown to select specific Minor. |
| Segment | Dropdown | Optional |
| From | Calendar | Beginning Time period to query data |
| | Dropdown | (Report Includes beginning Month) |
| To | Calendar | Ending Time period to query data |
| | Dropdown | (Report includes ending month) |

TABLE 61

| Report Name | Sales By Dealer |
|---|---|
| ID | RP8 |
| Module | Parts |
| Accessible | Menu |
| Description/Purpose/ | For a given time period this report provides key parts |
| Use Case | sales metrics for Brand AB by Area/Dealer. |

Report Structure
Report ROWS

| Row Name | Row Description |
|---|---|
| Dealer | Dealers in the scope selected |
| TOTAL | This row returns the Total and is appended to the |
| | last row of the report (bottom) |

Report COLUMNS

| | | Drilldown/ | Drilldown/Hyperlink |
|---|---|---|---|
| Column Description | Column Format | Hyperlink | Destination |
| Dealer | Varchar(50) | | For selected tactical |
| | | | segment drill down |
| | | | and showing output |
| | | | for each dealer in |
| | | | the area |
| Product Group | Varchar(50) | X | For selected region, |
| | | | drill down the |
| | | | product group |

| Column Description | Column Format | Metric ID |
|---|---|---|
| Total Sales | Currency (Rounded to | MP 1 |
| | dollar) or Integer | |
| Warranty Sales | Currency (Rounded to | MP5 |
| | dollar) or Integer | |
| CP Sales | Currency (Rounded to | MP8 |
| | dollar) or Integer | |
| Workshop Sales | Currency (Rounded to | MP9 |
| | dollar) or Integer | |
| Wholesale Sales | Currency (Rounded to | MP4 |
| | dollar) or Integer | |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price Level | Dropdown | Transaction Price, Dealer Net |
| Product Group | Dropdown | Dropdown to select specific |
| | | Product Group. Optional |
| Major Tactical | Dependent | Dropdown to select specific Major. |
| Segment | Dropdown | Optional |
| Minor Tactical | Dependent | Dropdown to select specific Minor. |
| Segment | Dropdown | Optional |
| From | Calendar | Beginning Time period to query data |
| | Dropdown | (Report Includes beginning Month) |
| To | Calendar | Ending Time period to query data |
| | Dropdown | (Report includes ending month) |

TABLE 62

| Report Name | Monthly Sales Trends |
|---|---|
| ID | RP9 |
| Module | Parts |
| Accessible | Menu |
| Description/Purpose/ | For a given time period this report provides key parts sales |
| Use Case | metrics for Brand AB parts by month |

Report Structure
Report ROWS

| Row Name | Row Description |
|---|---|
| Month-Year | Each month-Year within the specified time range selected |
| TOTAL | This row returns the Total and is appended to the last row of |
| | the report (bottom) |

Report COLUMNS

| | | | Drilldown/ |
|---|---|---|---|
| | | Drilldown/ | Hyperlink |
| Column Description | Column Format | Hyperlink | Destination |
| Column Description | Column Format | Metric ID | |
| Total Sales | Currency (Rounded to | MP1 | |
| | dollar) or Integer | | |
| Warranty Sales | Currency (Rounded to | MP5 | |
| | dollar) or Integer | | |
| CP Sales | Currency (Rounded to | MP8 | |
| | dollar) or Integer | | |
| Workshop Sales | Currency (Rounded to | MP9 | |
| | dollar) or Integer | | |
| Wholesale Sales | Currency (Rounded to | MP4 | |
| | dollar) or Integer | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Metric | Dropdown | Quantity, $, $/VIO |
| Price Level | Dropdown | Transaction Price, Dealer Net |
| Product Group | Dropdown | Dropdown to select specific Product Group. |
| | | Optional |
| Major Tactical | Dependent | Dropdown to select specific Major. Optional |
| Segment | Dropdown | |
| Minor Tactical | Dependent | Dropdown to select specific Minor. Optional |
| Segment | Dropdown | |
| Region | Dropdown | Dropdown to select specific Region. |
| | | Optional |
| Area | Dependent | Dropdown to select specific area. Optional |
| | Dropdown | |
| From | Calendar | Beginning Time period to query data (Report |
| | Dropdown | Includes beginning Month) |
| To | Calendar | Ending Time period to query data (Report |
| | Dropdown | includes ending month) |

TABLE 63

| Report Name | Sales Benchmark By Tactical Segment (Product Group) |
|---|---|
| ID | RP10 |
| Module | Parts |
| Accessible | Menu |
| Description/Purpose/ | Report allows for a peer report to be generated for (Dealers, |
| Use Case | Areas and Regions) This report displays will provide |
| | comparative assessment of a competitive group of dealers. |
| | (e.g.: Dealer Peer report would show dealers in area, total area, |
| | total region and national results) |

Report Structure
Report ROWS

| Row Name | Row Description |
|---|---|
| Product Group | Product group for which peer performance is being evaluated. |
| | This includes Collision, Mechanical, etc. |

Report COLUMNS

| | | | Drilldown/ |
|---|---|---|---|
| | | Drilldown/ | Hyperlink |
| Column Description | Column Format | Hyperlink | Destination |
| Product Group | Varchar(50) | X | For selected product |
| | | | group drill down and |
| | | | showing output for |
| | | | each Major Tactical |
| | | | Segment |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |
| Column Description | Column Format | Metric ID | |
| Nation Ave | Currency (Rounded to | Selected | |
| | dollar) or integer | Metric | |
| Top 25 Ave | Currency (Rounded to | Selected | |
| | dollar) or integer | Metric | |

Report Dimensions

| Filter Description | Control Type | Function/ Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Time Scope | Dropdown | Year, Month, Quarter to date |
| Month-Year | Dropdown | Time period to query data (Report Includes |
| | | Month) |

TABLE 64

| Report Name | Sales Benchmark By Tactical Segment (Major Tactical Segment) |
|---|---|
| ID | RP11 |
| Module | Parts |
| Accessible | Menu |
| Description/Purpose/ | Report allows for a peer report to be generated for (Dealers, |
| Use Case | Areas and Regions) by Major tactical segment. This report |
| | will provide comparative assessment of competitive set of |
| | dealers. (e.g.: Dealer Peer report would show dealers in area, |
| | total area, total region and national results). |

Report Structure
Report ROWS

| Row Name | Row Description |
|---|---|
| Major Tactical | Major Tactical Segment for which peer performance is being |
| Segment | evaluated. This includes Brakes, etc. |

Report COLUMNS

| | | | Drilldown/ |
|---|---|---|---|
| | | Drilldown/ | Hyperlink |
| Column Description | Column Format | Hyperlink | Destination |
| Major Tactical | Varchar(50) | X | For selected major |
| Segment | | | tactical segment drill |
| | | | down and showing |
| | | | output for each |
| | | | Minor Tactical |
| | | | Segment |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |
| Column Description | Column Format | Metric ID | |
| National Ave | Currency (Rounded to | Selected | |
| | dollar) or integer | Metric | |
| Top 25 Ave | Currency (Rounded to | Selected | |
| | dollar) or integer | Metric | |

Report Dimensions

| Filter Description | Control Type | Function/Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Time Scope | Dropdown | Year, Month, Quarter to date |
| Month-Year | Dropdown | Time period to query data (Report Includes |
| | | Month) |

TABLE 65

| Report Name | Sales Benchmark By Tactical Segment (Minor Tactical Segment) |
|---|---|
| ID | RP12 |
| Module | Parts |
| Accessible | Menu |
| Description/Purpose/ | Report allows for a peer report to be generated for (Dealers, |
| Use Case | Areas and Regions) by Minor tactical segment. This report |
| | will provide comparative assessment of competitive set of |
| | dealers. (e.g.: Dealer Peer report would show dealers in area, |
| | total area, total region and national results). |

Report Structure
Report ROWS

| Row Name | Row Description |
|---|---|
| Minor Tactical | Minor Tactical Segment for which peer performance is being |
| Segment | evaluated. This includes Brake Pad, etc. |

Report COLUMNS

| | | | Drilldown/ |
|---|---|---|---|
| | | Drilldown/ | Hyperlink |
| Column Description | Column Format | Hyperlink | Destination |
| Minor Tactical | Varchar (50) | X | For selected minor |
| Segment | | | tactical segment drill |
| | | | down and showing |
| | | | output for each HTG |
| | | | Tactical Segment |
| Region | Varchar (50) | X | For selected tactical |
| | | | segment drill down |
| | | | and showing output |
| | | | for each region |
| Area | Varchar (50) | X | For selected tactical |
| | | | segment drill down |
| | | | and showing output |
| | | | for each area |
| Dealer | Varchar (50) | X | For selected tactical |
| | | | segment drill down |
| | | | and showing output |
| | | | for each dealer |
| Column Description | Column Format | Metric ID | |
| National Ave | Currency (Rounded to | Selected | |
| | dollar) or integer | Metric | |
| Top 25 Ave | Currency (Rounded to | Selected | |
| | dollar) or integer | Metric | |

Report Dimensions

| Filter Description | Control Type | Function/ Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Time Scope | Dropdown | Year, Month, Quarter to date |
| | | Time period to query data (Report Includes |
| Month-Year | Dropdown | Month) |

TABLE 66

| Report Name | Sales Benchmark By Tactical Segment (HTG) |
|---|---|
| ID | RP13 |
| Module | Parts |
| Accessible | Menu |
| Description/Purpose/ | Report allows for a peer report to be generated for (Dealers, |
| Use Case | Areas and Regions) by HTG. This report will provide |
| | comparative assessment of competitive set of dealers. (e.g.: |
| | Dealer Peer report would show dealers in area, total area, total |
| | region and national results). |

Report Structure
Report ROWS

| Row Name | Row Description |
|---|---|
| HTG | HTG for which peer performance is being evaluated. |

Report COLUMNS

| | | | Drilldown/ |
|---|---|---|---|
| | | Drilldown/ | Hyperlink |
| Column Description | Column Format | Hyperlink | Destination |
| HTG | Varchar(50) | | |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |
| Column Description | Column Format | Metric ID | |
| National Ave | Currency(Rounded to | Selected | |
| | dollar) or integer | Metric | |
| Top 25 Ave | Currency(Rounded to | Selected | |
| | dollar) or integer | Metric | |

Report Dimensions

| Filter Description | Control Type | Function/ Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Time Scope | Dropdown | Year, Month, Quarter to date |
| Month-Year | Dropdown | Time period to query data (Report Includes |
| | | Month) |

TABLE 67

| Report Name | Sales Benchmark By Region (Main Screen) |
|---|---|
| ID | RP14 |
| Module | Parts |
| Accessible | Menu |
| Description/ | Report allows for a peer report to be generated for |
| Purpose/ | (Dealers, Areas and Regions) This report displays |
| Use Case | will provide comparative assessment of a competitive |
| | group dealers. (e.g.: Dealer Peer report would show |
| | dealers in area, total area, total region and national results) |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Time Scope | Dropdown | Year, Month, Quarter to date |
| Month-Year | Dropdown | Time period to query data |
| | | (Report Includes Month) |

| Search/Selection | Results Type |
|---|---|
| No Selection | Show Region wise benchmarks - RP |
| Region | Show area benchmarks in the region - RP |
| Area | Show dealer benchmarks in the area - RP |
| Dealer Code/ | Show dealer wise benchmark - RP |
| Name | |

TABLE 68

| Report Name | Sales Benchmark By Region |
|---|---|
| ID | RP15 |
| Module | Parts |
| Accessible | Menu |
| Description/Purpose/ | Report allows for a peer report to be generated for regions. |
| Use Case | This report will provide comparative assessment of |
| | competitive set of dealers. (e.g.: Dealer Peer report would |
| | show dealers in area, total area, total region and national |
| | results). |

Report Structure
Report ROWS

| Row Name | Row Description |
|---|---|
| Region | Region Code / Name |

Report COLUMNS

| | | | Drilldown/ |
|---|---|---|---|
| | | Drilldown/ | Hyperlink |
| Column Description | Column Format | Hyperlink | Destination |
| Region | Varchar(50) | | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |
| Column Description | Column Format | Metric ID | |
| Region Ave | Currency (Rounded to | Selected | |
| | dollar) or integer | Metric | |
| | Currency (Rounded to | Selected | |
| National Ave | dollar) or integer | Metric | |

Report Dimensions

| Filter Description | Control Type | Function/ Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Product Group | Dropdown | Dropdown to select specific Product Group. |
| | | Optional |
| Major Tactical | Dependent | Dropdown to select specific Major. Optional |
| Segment | Dropdown | |
| Minor Tactical | Dependent | Dropdown to select specific Minor. Optional |
| Segment | Dropdown | |
| Time Scope | Dropdown | Year, Month, Quarter to date |
| Month-Year | Dropdown | Time period to query data (Report Includes |
| | | Month) |

TABLE 69

| Report Name | Sales Benchmark By Area |
|---|---|
| ID | RP16 |
| Module | Parts |
| Accessible | Menu |
| Description/Purpose/Use | Report allows for a peer report to be generated for Areas. This |
| Case | report will provide comparative assessment of competitive set |
| | of dealers. (e.g.: Dealer Peer report would show dealers in |
| | area, total area, total region and national results). |

Report Structure
Report ROWS

| Row Name | Row Description |
|---|---|
| Area | Area Code/Name |

Report COLUMNS

| | | | Drilldown/Hyperlink |
|---|---|---|---|
| Column Description | Column Format | Drilldown/Hyperlink | Destination |
| Area | Varchar(50) | | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Area Ave | Currency(Rounded to | Selected |
| | dollar) or integer | Metric |
| Region Ave for the | Currency(Rounded to | Selected |
| Area | dollar) or integer | Metric |
| National Ave | Currency(Rounded to | Selected |
| | dollar) or integer | Metric |

Report Dimensions

| Filter Description | Control Type | Function/Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Product Group | Dropdown | Dropdown to select specific Product |
| | | Group. Optional |
| Major Tactical | Dependent | Dropdown to select specific Major. |
| Segment | Dropdown | Optional |
| Minor Tactical | Dependent | Dropdown to select specific Minor. |
| Segment | Dropdown | Optional |
| Time Scope | Dropdown | Year, Month, Quarter to date |
| Month-Year | Dropdown | Time period to query data (Report |
| | | Includes Month) |

TABLE 70

| Report Name | Sales Benchmark By Dealer (Dealer 1) |
|---|---|
| ID | RP17 |
| Module | Parts |
| Accessible | Menu |
| Description/Purpose/Use | Report allows for a peer report to be generated for regions. |
| Case | This report will provide comparative assessment of competitive |
| | set of dealers. (e.g.: Dealer Peer report would show dealers in |
| | area, total area, total region and national results). |

Report Structure
Report ROWS

| Row Name | Row Description |
|---|---|
| Region | Region Code/Name |

Report COLUMNS

| | | | Drilldown/Hyperlink |
|---|---|---|---|
| Column Description | Column Format | Drilldown/Hyperlink | Destination |
| Dealer | Varchar(50) | | |

| Column Description | Column Format | Metric ID |
|---|---|---|
| | Currency(Rounded to | Selected |
| Dealer | dollar) or integer | Metric |
| | Currency(Rounded to | Selected |
| Dealer Area Ave | dollar) or integer | Metric |
| | Currency(Rounded to | Selected |
| Dealer Region Ave | dollar) or integer | Metric |
| | Currency(Rounded to | Selected |
| National Ave | dollar) or integer | Metric |

Report Dimensions

| Filter Description | Control Type | Function/Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Product Group | Dropdown | Dropdown to select specific Product |
| | | Group. Optional |
| Major Tactical | Dependent | Dropdown to select specific Major. |
| Segment | Dropdown | Optional |
| Minor Tactical | Dependent | Dropdown to select specific Minor. |
| Segment | Dropdown | Optional |
| Time Scope | Dropdown | Year, Month, Quarter to date |
| Month-Year | Dropdown | Time period to query data (Report |
| | | Includes Month) |

TABLE 71

| Report Name | Sales Benchmark By Dealer (Dealer 2) |
|---|---|
| ID | RP18 |
| Module | Parts |
| Accessible | Menu |
| Description/Purpose/Use | Report allows for a peer report to be generated for regions. |
| Case | This report will provide comparative assessment of competitive |
| | set of dealers. (e.g.: Dealer Peer report would show dealers in |
| | area, total area, total region and national results). |

Report Structure
Report ROWS

| Row Name | Row Description |
|---|---|
| Product Group | Region Code/Name |
| Major Tactical | |
| Segment | |
| Minor Tactical | Region Code/Name |
| Segment | |

Report COLUMNS

| | | | Drilldown/Hyperlink |
|---|---|---|---|
| Column Description | Column Format | Drilldown/Hyperlink | Destination |
| Tactical Segment | Text | | |
| Name | | | |

| Column Description | Column Format | Metric ID |
|---|---|---|
| Dealer Ave | Currency(Rounded to | Selected |
| | dollar) or integer | Metric |
| Area Ave | Currency(Rounded to | Selected |
| | dollar) or integer | Metric |
| Region Ave | Currency(Rounded to | Selected |
| | dollar) or integer | Metric |
| National Ave | Currency(Rounded to | Selected |
| | dollar) or integer | Metric |

Report Dimensions

| Filter Description | Control Type | Function/Purpose |
|---|---|---|
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Time Scope | Dropdown | Year, Month, Quarter to date |
| Month-Year | Dropdown | Time period to query data (Report |
| | | Includes Month) |

TABLE 72

| Report Name | Sales Growth Trends By Tactical Segment (Product Group) |
|---|---|
| ID | RP19 |
| Module | Parts |
| Accessible | Menu |
| Description/Purpose/Use | Report shows for each product group growth over a period of |
| Case | time (year, month, quarter) |

Report Structure
Report ROWS

| Row Name | Row Description |
|---|---|
| Product Group | Product group for which trend performance is being evaluated. |
| | This includes Collision, Mechanical, etc. |

Report COLUMNS

| | | | Drilldown/Hyperlink |
|---|---|---|---|
| Column Description | Column Format | Drilldown/Hyperlink | Destination |
| Product Group | Varchar(50) | X | For selected product |
| | | | group drill down and |
| | | | showing output for |
| | | | each Major Tactical |
| | | | Segment |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Current | Currency(Rounded to | Selected |
| | dollar) or integer | Metric |
| Previous | Currency(Rounded to | Selected |
| | dollar) or integer | Metric |
| Change % | Currency(Rounded to | Selected |
| | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Time Scope | Dropdown | Year, Month, Quarter |
| Year-Month | Dropdown | Time period to query data (Report |
| | | Includes beginning Month) |

TABLE 73

| | Sales Growth Trends By Tactical Segment |
|---|---|
| Report Name | (Major Tactical Segment) |
| ID | RP20 |
| Module | Parts |
| Accessible | Menu |
| Description/Purpose/Use | Report shows for each major tactical segment growth over a |
| Case | period of time (year, month, quarter) |

Report Structure
Report ROWS

| Row Name | Row Description |
|---|---|
| Major Tactical | Product group for which peer performance is being evaluated. |
| Segment | This includes Brakes, etc. |

Report COLUMNS

| | | | Drilldown/Hyperlink |
|---|---|---|---|
| Column Description | Column Format | Drilldown/Hyperlink | Destination |
| Major Tactical | Varchar(50) | X | For selected product |
| Segment | | | group drill down and |
| | | | showing output for |
| | | | each Minor Tactical |
| | | | Segment |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Current | Currency(Rounded to | Selected |
| | dollar) or integer | Metric |
| Previous | Currency(Rounded to | Selected |
| | dollar) or integer | Metric |
| Change % | Currency(Rounded to | Selected |
| | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Time Scope | Dropdown | Year, Month, Quarter |
| Year-Month | Dropdown | Time period to query data (Report |
| | | Includes beginning Month) |

TABLE 74

| | Sales Growth Trends By Tactical Segment |
|---|---|
| Report Name | (Minor Tactical Segment) |
| ID | RP21 |
| Module | Parts |
| Accessible | Menu |
| Description/Purpose/Use | Report shows for each minor tactical segment growth over a |
| Case | period of time (year, month, quarter) |

Report Structure
Report ROWS

| Row Name | Row Description |
|---|---|
| Major Tactical | Product group for which peer performance is being evaluated. |
| Segment | This includes Brakes, etc. |

Report COLUMNS

| | | | Drilldown/Hyperlink |
|---|---|---|---|
| Column Description | Column Format | Drilldown/Hyperlink | Destination |
| Minor Tactical | Varchar(50) | X | For selected product |
| Segment | | | group drill down and |
| | | | showing output for |
| | | | each HTG Tactical |
| | | | Segment |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Current | Currency(Rounded to | Selected |
| | dollar) or integer | Metric |
| Previous | Currency(Rounded to | Selected |
| | dollar) or integer | Metric |
| Change % | Currency(Rounded to | Selected |
| | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Time Scope | Dropdown | Year, Month, Quarter |
| Year-Month | Dropdown | Time period to query data (Report |
| | | Includes beginning Month) |

TABLE 75

| Report Name | Sales By Tactical Segment Growth Trends (By HTG) |
|---|---|
| ID | RP22 |
| Module | Parts |
| Accessible | Menu |
| Description/Purpose/Use | Report shows for each HTG growth over a period of time (year, |
| Case | month, quarter) |

Report Structure
Report ROWS

| Row Name | Row Description |
|---|---|
| HTG | Product group for which peer performance is being evaluated. |
| | This includes Brake Pads, etc. |

Report COLUMNS

| | | | Drilldown/Hyperlink |
|---|---|---|---|
| Column Description | Column Format | Drilldown/Hyperlink | Destination |
| HTG | Varchar(50) | X | For selected HTG |
| | | | drill down and |
| | | | showing output for |
| | | | each Part Number |
| Region | Varchar(50) | X | For selected tactical |
| | | | segment drill down |
| | | | and showing output |
| | | | for each region |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Current | Currency(Rounded to | Selected |
| | dollar) or integer | Metric |
| Previous | Currency(Rounded to | Selected |
| | dollar) or integer | Metric |
| Growth % | Currency(Rounded to | Selected |
| | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Sales Type | Dropdown | Total Sales, Warranty, CP, Wholesale, |
| | | Workshop |
| Metric Type | Dropdown | $/Dlr, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Time Scope | Dropdown | Year, Month, Quarter |
| Year-Month | Dropdown | Time period to query data (Report |
| | | Includes beginning Month) |

TABLE 76

| Report Name | Sales Growth Trends By Region |
|---|---|
| ID | RP23 |
| Module | Parts |
| Accessible | Menu |
| Description/Purpose/Use | Report shows for the geographical scope growth over a period |
| Case | of time (year, month, quarter) |

Report Structure
Report ROWS

| Row Name | Row Description |
|---|---|
| Region | Region group for which peer performance is being evaluated. |

Report COLUMNS

| | | | Drilldown/Hyperlink |
|---|---|---|---|
| Column Description | Column Format | Drilldown/Hyperlink | Destination |
| Region | Varchar(50) | | For selected tactical |
| | | | segment drill down |
| | | | and showing output |
| | | | for each dealer in |
| | | | the nation |
| Area | Varchar(50) | X | For selected tactical |
| | | | segment drill down |
| | | | and showing output |
| | | | for each area |
| Dealer | Varchar(50) | X | For selected tactical |
| | | | segment drill down |
| | | | and showing output |
| | | | for each dealer |

| Column Description | Column Format | Metric ID |
|---|---|---|
| Current | Currency(Rounded to | Selected |
| | dollar) or integer | Metric |
| Previous | Currency(Rounded to | Selected |
| | dollar) or integer | Metric |
| Change % | Currency(Rounded to | Selected |
| | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | List of various metrics available (OEM |
| | | sales, OEM Wholesale Sales, etc.) |
| Metric Scope | Dropdown | Quantity, $, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Product Group | Dropdown | Dropdown to select specific Product |
| | | Group. Optional |
| Major Tactical | Dependent | Dropdown to select specific Major. |
| Segment | Dropdown | Optional |
| Minor Tactical | Dependent | Dropdown to select specific Minor. |
| Segment | Dropdown | Optional |
| Time Scope | Dropdown | Year, Month, Quarter |
| Year-Month | Dropdown | Time period to query data (Report |
| | | Includes beginning Month) |

TABLE 77

| Report Name | Sales Growth Trends By Area |
|---|---|
| ID | RP24 |
| Module | Parts |
| Accessible | Menu |
| Description/Purpose/Use | Report shows for the geographical scope growth over a period |
| Case | of time (year, month, quarter) |

Report Structure
Report ROWS

| Row Name | Row Description |
|---|---|
| Area | Area group for which peer performance is being evaluated. |

Report COLUMNS

| | | | Drilldown/Hyperlink |
|---|---|---|---|
| Column Description | Column Format | Drilldown/Hyperlink | Destination |
| Area | Varchar(50) | X | For selected tactical |
| | | | segment drill down |
| | | | and showing output |
| | | | for each region |
| Dealer | Varchar(50) | | |

| Column Description | Column Format | Metric ID |
|---|---|---|
| Current | Currency(Rounded to | Selected |
| | dollar) or integer | Metric |
| | Currency(Rounded to | Selected |
| Previous | dollar) or integer | Metric |
| | Currency(Rounded to | Selected |
| Change % | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | List of various metrics available (OEM |
| | | sales, OEM Wholesale Sales, etc.) |
| Metric Scope | Dropdown | Quantity, $, $/VIO |
| Price Level | Dropdown | Transaction Price, Dealer Net |
| Region Hierarchy | Dropdown | Dropdown to select specific Region. |
| | | Optional |
| Area Hierarchy | Dependent | Dropdown to select specific area. |
| | Dropdown | Optional |
| Product Group | Dropdown | Dropdown to select specific Product |
| Hierarchy | | Group. Optional |
| Major Tactical | Dependent | Dropdown to select specific Major. |
| Segment Hierarchy | Dropdown | Optional |
| Minor Tactical | Dependent | Dropdown to select specific Minor. |
| Segment Hierarchy | Dropdown | Optional |
| Time Scope | Dropdown | Year, Month, Quarter |
| Year-Month | Dropdown | Time period to query data (Report |
| | | Includes beginning Month) |

TABLE 78

| Report Name | Sales Growth Trends By Dealer |
|---|---|
| ID | RP25 |
| Module | Parts |
| Accessible | Menu |
| Description/Purpose/Use | Report shows for the geographical scope growth over a period |
| Case | of time (year, month, quarter) |

Report Structure
Report ROWS

| Row Name | Row Description |
|---|---|
| Dealer | Dealers for which peer performance is being evaluated. |

Report COLUMNS

| | | | Drilldown/Hyperlink |
|---|---|---|---|
| Column Description | Column Format | Drilldown/Hyperlink | Destination |
| Dealer | Varchar(50) | | |

| Column Description | Column Format | Metric ID |
|---|---|---|
| Current | Currency(Rounded to | Selected |
| | dollar) or integer | Metric |
| Previous | Currency(Rounded to | Selected |
| | dollar) or integer | Metric |
| Change % | Currency(Rounded to | Selected |
| | dollar) or integer | Metric |

Report Dimensions

| Filter Description | Control Type | Function/Purpose |
|---|---|---|
| Dealer Code | Autocomplete | Dealer code |
| | Text | |
| Dealer Name | Autocomplete | Dealer Name |
| | Text | |
| Metric | Dropdown | List of various metrics available (OEM |
| | | sales, OEM Wholesale Sales, etc.) |
| Metric Scope | Dropdown | Quantity, $, $/VIO |
| Price Level | Dropdown | Transaction Price, Dealer Net |
| Region Hierarchy | Dropdown | Dropdown to select specific Region. |
| | | Optional |
| Area | Dependent | Dropdown to select specific area. |
| | Dropdown | Optional |
| Product Group | Dropdown | Dropdown to select specific Product |
| Hierarchy | | Group. Optional |
| Major Tactical | Dependent | Dropdown to select specific Major. |
| Segment | Dropdown | Optional |
| Minor Tactical | Dependent | Dropdown to select specific Minor. |
| Segment | Dropdown | Optional |
| Time Scope | Dropdown | Year, Month, Quarter |
| Year-Month | Dropdown | Time period to query data (Report |
| | | Includes beginning Month) |

Moreover the loyalty report types described in Table 53 may be further divided into multiple reports, such as, but not limited to: Loyalty By Tactical Segment (Product Group) (Table 79); Loyalty By Tactical Segment (Major Tactical Segment) (Table 80); Loyalty By Tactical Segment (Minor Tactical Segment) (Table 81); Loyalty By Tactical Segment (HTG) (Table 82); Loyalty By Tactical Segment (Part Number) (Table 83); Loyalty By Region (Table 84); Loyalty By Area (Table 85); Loyalty by Dealers (Table 86); Loyalty Summary For Single Dealer (Table 87); and Loyalty Benchmarks (Main Screen) (Table 88).

TABLE 79

| Report Name | Loyalty By Tactical Segment (Product Group) |
|---|---|
| ID | RL1 |
| Module | Parts |
| Accessible | Menu |
| Description/Purpose/ | For a given time period this report provides key lost sales loyalty |
| Use Case | metrics for OEM parts by product group. |

Report Structure
Report ROWS

| Row Name | Row Description |
|---|---|
| Product Group | Product Groups is the highest level of tactical segment |
| | (Accessories, Collision etc.) |
| TOTAL | This row returns the Total for all tactical segment and is |
| | appended to the last row of the report (bottom) |

Report COLUMNS

| | | Drilldown/ | Drilldown/ Hyperlink |
|---|---|---|---|
| Column Description | Column Format | Hyperlink | Destination |
| | | | For selected tactical |
| Product Group | Varchar(50) | X | segment drill down to |
| | | | Major Tactical |
| | | | Segment |
| | | | For selected tactical |
| | | | segment drill down |
| Region | Varchar(50) | X | and showing output for |
| | | | each region |
| | | | For selected tactical |
| Area | Varchar(50) | X | segment drill down |
| | | | and showing output for |
| | | | each area |
| | | | For selected tactical |
| | | | segment drill down |
| Dealer | Varchar(50) | X | and showing output for |
| | | | each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty | % (Rounded to Single | ML3 | |
| % | decimal) | | |
| Change | % (Rounded to Single | Calculated | |
| | decimal) | | |
| 3-Month Trend | Currency (Rounded to | Calculated | |
| | dollar) or Integer | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Region | Dropdown | Dropdown to select specific Region. Optional |
| Area | Dependent | Dropdown to select specific area. Optional |
| | Dropdown | |
| Month - Year | Calendar | Ending Time period to query data (Report |
| | Dropdown | includes ending month) |

TABLE 80

| Report Name | Loyalty By Tactical Segment (Major Tactical Segment) |
|---|---|
| ID | RL2 |
| Module | Parts |
| Accessible | Menu |
| Description/Purpose/ | For a given time period this report provides key lost sales |
| Use Case | loyalty metrics for OEM parts by Major Tactical Segment. |

Report Structure
Report ROWS

| Row Name | Row Description |
|---|---|
| Major Tactical | Major Tactical Segment is the next level of tactical segment |
| Segment | (e.g. Brakes etc.) |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| Major Tactical | Varchar (50) | X | For selected tactical |
| Segment | | | segment drill down to |
| | | | the Minor Tactical |
| | | | Segment |
| Region | Varchar (50) | X | For selected tactical |
| | | | segment drill down |
| | | | and showing output |
| | | | for each region |
| Area | Varchar (50) | X | For selected tactical |
| | | | segment drill down |
| | | | and showing output |
| | | | for each area |
| Dealer | Varchar (50) | X | For selected tactical |
| | | | segment drill down |
| | | | and showing output |
| | | | for each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty % | % (Rounded to Single | ML3 | |
| | decimal) | | |
| Change % | % (Rounded to Single | Calculated | |
| | decimal) | | |
| 3-Month Trend | Currency (Rounded to | Calculated | |
| | dollar) or Integer | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Region | Dropdown | Dropdown to select specific Region. Optional |
| Area | Dependent | Dropdown to select specific area. Optional |
| | Dropdown | |
| Month - Year | Calendar | Ending Time period to query data (Report |
| | Dropdown | includes ending month) |

TABLE 81

| Report Name | Loyalty By Tactical Segment (Minor Tactical Segment) |
|---|---|
| ID | RL3 |
| Module | Parts |
| Accessible | Menu |
| Description/Purpose/ | For a given time period this report provides key lost sales |
| Use Case | loyalty metrics for OEM parts by Minor Tactical Segment. |

Report Structure
Report ROWS

| Row Name | Row Description |
|---|---|
| Minor Tactical | Minor Tactical Segment is the next level of tactical segment |
| Segment | (e.g. Brakes etc.) |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| Minor Tactical | Varchar (50) | X | For selected tactical |
| Segment | | | segment drill down |
| | | | to HTG Tactical |
| | | | Segment |
| Region | Varchar (50) | X | For selected tactical |
| | | | segment drill down |
| | | | and showing output |
| | | | for each region |
| Area | Varchar (50) | X | For selected tactical |
| | | | segment drill down |
| | | | and showing output |
| | | | for each area |
| Dealer | Varchar (50) | X | For selected tactical |
| | | | segment drill down |
| | | | and showing output |
| | | | for each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty % | % (Rounded to Single | ML3 | |
| | decimal) | | |
| Change % | % (Rounded to Single | Calculated | |
| | decimal) | | |
| 3-Month Trend | Currency (Rounded to | Calculated | |
| | dollar) or Integer | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Region | Dropdown | Dropdown to select specific Region. |
| | | Optional |
| Area | Dependent | Dropdown to select specific area. Optional |
| | Dropdown | |
| Month - Year | Calendar | Ending Time period to query data (Report |
| | Dropdown | includes ending month) |

TABLE 82

| Report Name | Loyalty By Tactical Segment (HTG) |
|---|---|
| ID | RL4 |
| Module | Parts |
| Accessible | Menu |
| Description/Purpose/ | For a given time period this report provides key lost sales |
| Use Case | loyalty metrics for OEM parts by HTG |

Report Structure
Report ROWS

| Row Name | Row Description |
|---|---|
| HTG | HTGs the next level of tactical segment |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| HTG | Varchar (50) | X | For selected HTG, |
| | | | drill down to part |
| | | | number |
| Region | Varchar (50) | X | For selected tactical |
| | | | segment drill down |
| | | | and showing output |
| | | | for each region |
| Area | Varchar (50) | X | For selected tactical |
| | | | segment drill down |
| | | | and showing output |
| | | | for each area |
| Dealer | Varchar (50) | X | For selected tactical |
| | | | segment drill down |
| | | | and showing output |
| | | | for each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty | % (Rounded to Single | ML3 | |
| % | decimal) | | |
| Change % | % (Rounded to Single | Calculated | |
| | decimal) | | |
| 3-Month Trend | Currency (Rounded to | Calculated | |
| | dollar) or Integer | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Region | Dropdown | Dropdown to select specific Region. |
| | | Optional |
| Area | Dependent | Dropdown to select specific area. Optional |
| | Dropdown | |
| Month - Year | Calendar | Ending Time period to query data (Report |
| | Dropdown | includes ending month) |

TABLE 83

| Report Name | Loyalty By Tactical Segment (Part Number) |
|---|---|
| ID | RL5 |
| Module | Parts |
| Accessible | Menu |
| Description/Purpose/ | For a given time period this report provides key lost sales |
| Use Case | loyalty metrics for OEM parts by Part Number |

Report Structure
Report ROWS

| Row Name | Row Description |
|---|---|
| Part Number | Part Number |
| TOTAL | This row returns the Total for all tactical segment and is |
| | appended to the last row of the report (bottom) |

Report COLUMNS

| | | | Drilldown/ |
|---|---|---|---|
| | | Drilldown/ | Hyperlink |
| Column Description | Column Format | Hyperlink | Destination |
| Part Number | Varchar (50) | | |
| | | | For selected tactical |
| Region | Varchar (50) | X | segment drill down |
| | | | and showing output |
| | | | for each region |
| Area | Varchar (50) | X | For selected tactical |
| | | | segment drill down |
| | | | and showing output |
| | | | for each area |
| | | | For selected tactical |
| Dealer | Varchar (50) | X | segment drill down |
| | | | and showing output |
| | | | for each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty | % (Rounded to Single | ML3 | |
| % | decimal) | | |
| Change % | % (Rounded to Single | Calculated | |
| | decimal) | | |
| 3-Month Trend | Currency (Rounded to | Calculated | |
| | dollar) or Integer | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Region Hierarchy | Dropdown | Dropdown to select specific Region. |
| | | Optional |
| Area Hierarchy | Dependent | Dropdown to select specific area. Optional |
| | Dropdown | |
| Month - Year | Calendar | Ending Time period to query data (Report |
| | Dropdown | includes ending month) |

TABLE 84

| Report Name | Loyalty By Region |
|---|---|
| ID | RL6 |
| Module | Parts |
| Accessible | Menu |
| Description/Purpose/ | For a given time period this report provides key Lost Sales |
| Use Case | metrics for OEM parts by Nation |

Report Structure
Report ROWS

| Row Name | Row Description |
|---|---|
| Region | National Aggregate |
| TOTAL | This row returns the Total and is appended to the last row of |
| | the report (bottom) |

Report COLUMNS

| | | | Drilldown/ |
|---|---|---|---|
| | | Drilldown/ | Hyperlink |
| Column Description | Column Format | Hyperlink | Destination |
| Region | Varchar (50) | | For selected tactical |
| | | | segment drill down |
| | | | and showing output |
| | | | for each region |
| Area | Varchar (50) | X | For selected tactical |
| | | | segment drill down |
| | | | and showing output |
| | | | for each area |
| Dealer | Varchar (50) | X | For selected tactical |
| | | | segment drill down |
| | | | and showing output |
| | | | for each dealer |
| Product Group | Varchar (50) | X | For selected tactical |
| | | | segment drill down |
| | | | and showing output |
| | | | for each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty | % (Rounded to Single | ML3 | |
| % | decimal) | | |
| Change | % (Rounded to Single | Calculated | |
| decimal) | | | |
| 3-Month Trend | Currency (Rounded to | Calculated | |
| | dollar) or Integer | | |
| National Loyalty % | % (Rounded to Single | ML3 | |
| | decimal) | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Product Group | Dropdown | Dropdown to select specific Product Group. |
| Hierarchy | | Optional |
| Major Tactical | Dependent | Dropdown to select specific Major. Optional |
| Segment | Dropdown | |
| Minor Tactical | Dependent | Dropdown to select specific Minor. |
| Segment | Dropdown | Optional |
| Month - Year | Calendar | Ending Time period to query data (Report |
| | Dropdown | includes ending month) |

TABLE 85

| Report Name | Loyalty By Area |
|---|---|
| ID | RL7 |
| Module | Parts |
| Accessible | Menu |
| Description/Purpose/ | For a given time period this report provides key Lost Sales |
| Use Case | metrics for OEM parts by Nation/Region/Area/Dealer. |

Report Structure
Report ROWS

| Row Name | Row Description |
|---|---|
| Area | Area details |
| TOTAL | This row returns the Total and is appended to the last row of |
| | the report (bottom) |

Report COLUMNS

| | | | Drilldown/ |
|---|---|---|---|
| | | Drilldown/ | Hyperlink |
| Column Description | Column Format | Hyperlink | Destination |
| Area | Varchar (50) | | For selected tactical |
| | | | segment drill down |
| | | | and showing output |
| | | | for each dealer in |
| | | | the region |
| Dealer | Varchar (50) | X | For selected tactical |
| | | | segment drill down |
| | | | and showing output |
| | | | for each dealer |
| Product | Varchar (50) | X | For selected tactical |
| | | | segment drill down |
| | | | and showing output |
| | | | for each dealer |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty | % (Rounded to Single | ML3 | |
| % | decimal) | | |
| Change % | % (Rounded to Single | Calculated | |
| | decimal) | | |
| 3-Month Trend | Currency (Rounded to | Calculated | |
| | dollar) or Integer | | |
| National Loyalty % | % (Rounded to Single | ML3 | |
| | decimal) | | |
| Region Loyalty % | % (Rounded to Single | ML3 | |
| | decimal) | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Product Group | Dropdown | Dropdown to select specific Product Group. |
| | | Optional |
| Major Tactical | Dependent | Dropdown to select specific Major. Optional |
| Segment | Dropdown | |
| Minor Tactical | Dependent | Dropdown to select specific Minor. |
| Segment | Dropdown | Optional |
| Month - Year | Calendar | Ending Time period to query data (Report |
| | Dropdown | includes ending month) |

TABLE 86

| Report Name | Loyalty by Dealers |
|---|---|
| ID | RL8 |
| Module | Parts |
| Accessible | Menu |
| Description/Purpose/ | For a given time period this report provides key Lost Sales |
| Use Case | metrics for OEM parts by dealer. |

Report Structure
Report ROWS

| Row Name | Row Description |
|---|---|
| Dealer | Dealer Code and Name |
| TOTAL | This row returns the Total and is appended to the last row of the |
| | report (bottom) |

Report COLUMNS

| | | | Drilldown/ |
|---|---|---|---|
| | | Drilldown/ | Hyperlink |
| Column Description | Column Format | Hyperlink | Destination |
| Dealer | Varchar (50) | | |
| Product Group | Varchar (50) | X | |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Prey Month Loyalty | % (Rounded to Single | ML3 | |
| % | decimal) | | |
| Change % | % (Rounded to Single | Calculated | |
| | decimal) | | |
| 3-Month Trend | Currency (Rounded to | Calculated | |
| | dollar) or Integer | | |
| Area - Loyalty % | % (Rounded to Single | ML3 | |
| | decimal) | | |
| Region Loyalty % | % (Rounded to Single | ML3 | |
| | decimal) | | |
| National Loyalty % | % (Rounded to Single | ML3 | |
| | decimal) | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Product Group | Dropdown | Dropdown to select specific Product Group. |
| | | Optional |
| Major Tactical | Dependent | Dropdown to select specific Major. Optional |
| Segment | Dropdown | |
| Minor Tactical | Dependent | Dropdown to select specific Minor. Optional |
| Segment | Dropdown | |
| Month - Year | Calendar | Ending Time period to query data (Report |
| | Dropdown | includes ending month) |

TABLE 87

| Report Name | Loyalty Summary For Single Dealer |
|---|---|
| ID | RL9 |
| Module | Parts |
| Accessible | Menu |
| Description/Purpose/ | For a given time period this report provides key Lost Sales |
| Use Case | metrics for OEM parts by dealer. |

Report Structure
Report ROWS

| Row Name | Row Description |
|---|---|
| Product Group | This row show product groups |
| Major Tactical | This row results for major tactical segment |
| Segments | |
| Minor Tactical | This row results for minor tactical segment |
| Segments | |
| Total - Brand A/B | This row shows results for all OEM Parts |
| Parts Only | |
| Total - Brand A/B | This row shows results for all Parts including OEM and non |
| Parts and Non Brand | OEM |
| A Parts | |

Report COLUMNS

| | | | Drilldown/ |
|---|---|---|---|
| | | Drilldown/ | Hyperlink |
| Column Description | Column Format | Hyperlink | Destination |
| Tactical Segment | Text | | |
| Column Description | Column Format | Metric ID | |
| Loyalty Opportunity $ | Currency (Rounded to | ML1 | |
| | dollar) or Integer | | |
| Loyalty % | % (Rounded to Single | ML3 | |
| | decimal) | | |
| Area ? Loyalty % | % (Rounded to Single | ML3 | |
| | decimal) | | |
| Region Loyalty % | % (Rounded to Single | ML3 | |
| | decimal) | | |
| National Loyalty % | % (Rounded to Single | ML3 | |
| | decimal) | | |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Product Group | Dropdown | Dropdown to select specific Product Group. |
| | | Optional |
| Major Tactical | Dependent | |
| Segment | Dropdown | Dropdown to select specific Major. Optional |
| Minor Tactical | Dependent | |
| Segment | Dropdown | Dropdown to select specific Minor. Optional |
| Month - Year | Calendar | Ending Time period to query data (Report |
| | Dropdown | includes ending month) |

TABLE 88

| Report Name | Loyalty Benchmarks (Main Screen) |
|---|---|
| ID | RP10 |
| Module | Parts |
| Accessible | Menu |
| Description/ | Report allows for a peer report to be generated for |
| Purpose/ | (Dealers, Areas and Regions) This report displays |
| Use Case | will provide comparative assessment of a competitive |
| | group dealers. (e.g.: Dealer Peer report would show |
| | dealers in area, total area, total region and national |
| | results) |

Report Dimensions

| Filter Description | Control Type | Function/ Purpose |
|---|---|---|
| Dealer Code | Autocomplete | Dealer code |
| | Text | |
| Dealer Name | Autocomplete | Dealer Name |
| | Text | |
| Sales Type | Dropdown | Total Sales, Warranty, CP, Wholesale, |
| | Workshop | |
| Metric Type | Dropdown | $/Dlr, $/VIO |
| Price Level | Dropdown | Transaction Price, Dealer Net |
| Region | Dropdown | Dropdown to select specific Region. |
| | | Optional |
| Area | Dependent | Dropdown to select specific area. |
| | Dropdown | Optional |
| Time Scope | Dropdown | Year, Month, Quarter to date |
| Month-Year | Dropdown | Time period to query data |
| | | (Report Includes Month) |

| Search/Selection | Results Type |
|---|---|
| No Selection | Show Region wise benchmarks - RP |
| Region | Show area benchmarks in the region - RP |
| Area | Show dealer benchmarks in the area - RP |
| Dealer Code/Name | Show dealer wise benchmark - RP |

Multiple users may access the system application 114 to view the available reports 154. There user may be a seller 20, a manager 30 (a corporate manager 30a or a field manager 30b), or a specialist 30d. In some examples, the role of a seller 20 is an individual who has interests in the operations of its own specific sales operation (e.g., dealership); therefore, the seller 20 may view and access information pertaining only to its own dealership. The corporate manager 30a may be a non-seller individual belonging to a specific brand organization, and oversees the brand as a nation; therefore, the corporate manager 30a may view information relating to all sellers 20 belonging to the specific brand. The field manager 30b may be a non-seller individual belonging to either a first brand 32 or a second brand 32 and tied to particular region/area of the brand 32; therefore, the corporate manager 30a may view information for all sellers 20 belonging to his or her brand 32 within the region/area. A specialist may have special permissions, typically they are used for special programs (e.g. wholesale specialist) and the access is restricted to specific information; therefore, this role may be defined per request.

In some implementations, different users are granted different levels of reports. The system 100 identifies the user and based on the user identification, the system 100 determines the reports that are available to the user.

In some examples, the system 100 uses SAML (Security Assertion Markup Language) SSO (Single Sign On). SAML is an XML-based open standard data format for exchanging authentication and authentication data between parties, in particular, between an identity provider and a service provider. SSO is a property of access control of multiple related but independent software systems, which allows a user to log in to a system 100 once and the user gains access to all the systems without having to log in at each of the independent software systems.

In other examples, the system 100 uses direct secured login, which provides an access point for users 20, 30. The user name and passwords are stored within the application and maintain no outside dependencies. This access will be granted selectively with approval from the project business owner. The system 100 may use other methods for securely authenticating the user 20, 30.

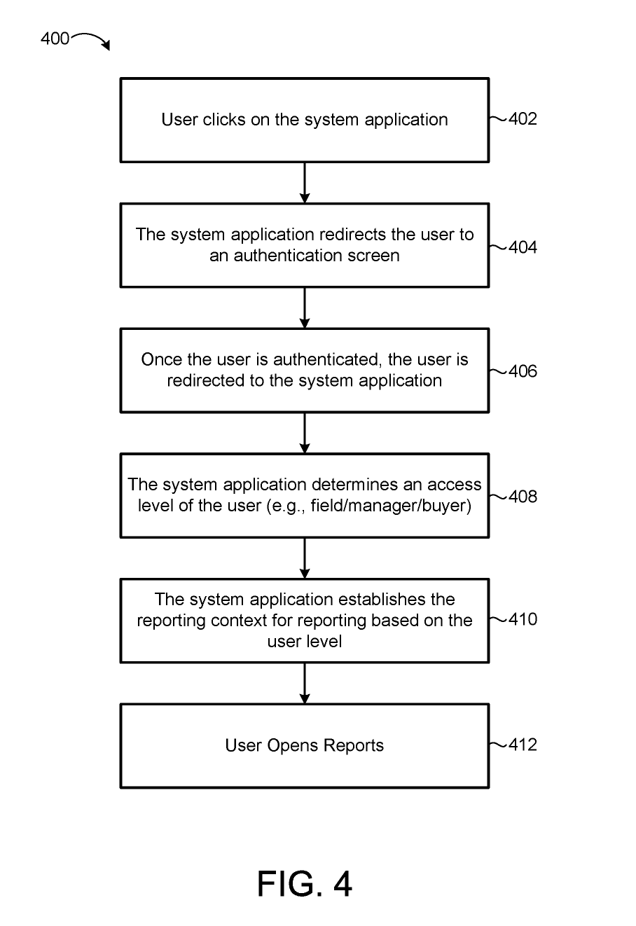

Referring to FIG. 4, in some implementations, a process of user authentication 400 is shown. At block 402, a user 20, 30 initiates the system application 202 executing on the system 100. At block 404, the system application 202 redirects the user 20, 30 to an authentication screen displayed on a display 26, 116, 206. At block 406, and after the user 20, 30 enters his username and password, and both are authenticated, the user 20, 30 is then redirected to the system application 202. At block 408, the system application 202 determines an access level of the user 20, 30 (e.g., seller 20, corporate manager 30a, field manager 30). At block 410, the system application 202 determines the reports 154 based on the user type. Finally, at block 412, the system application 202 makes available to the user 20, 30 the reports 154 associated with the user's authentication level.

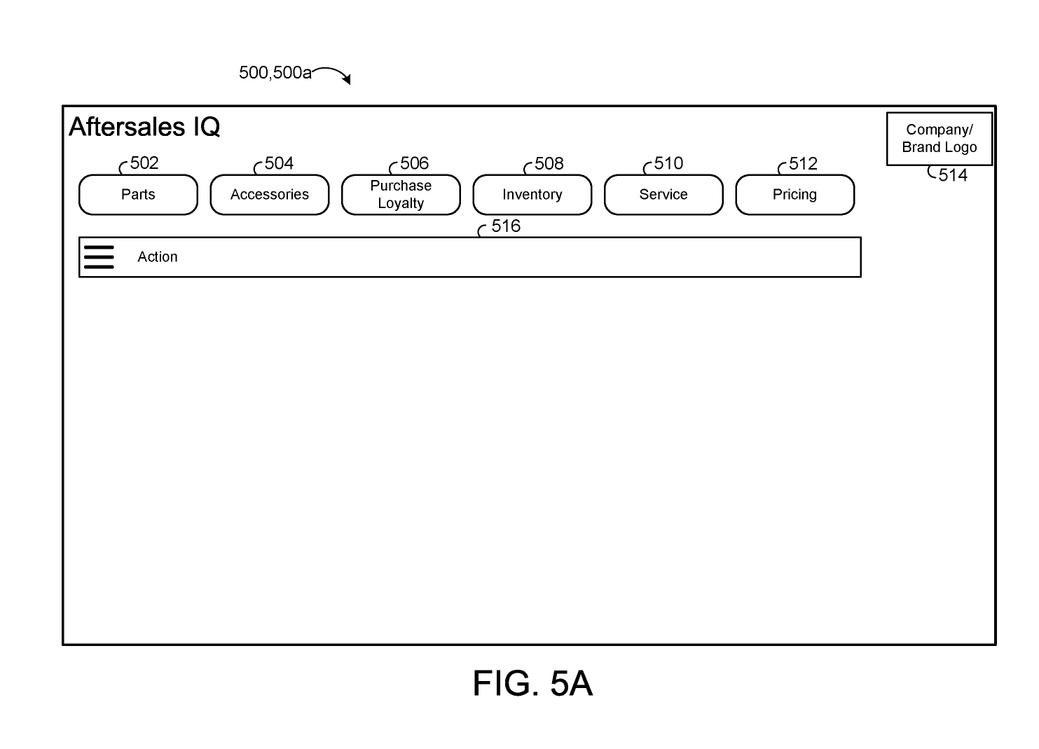

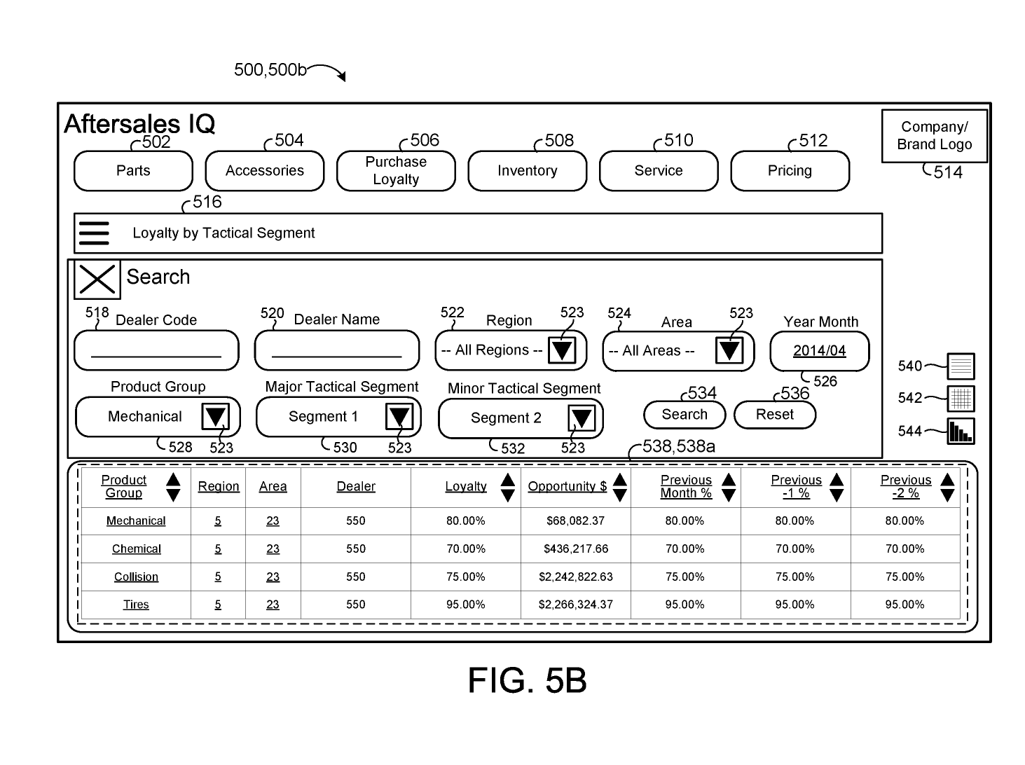

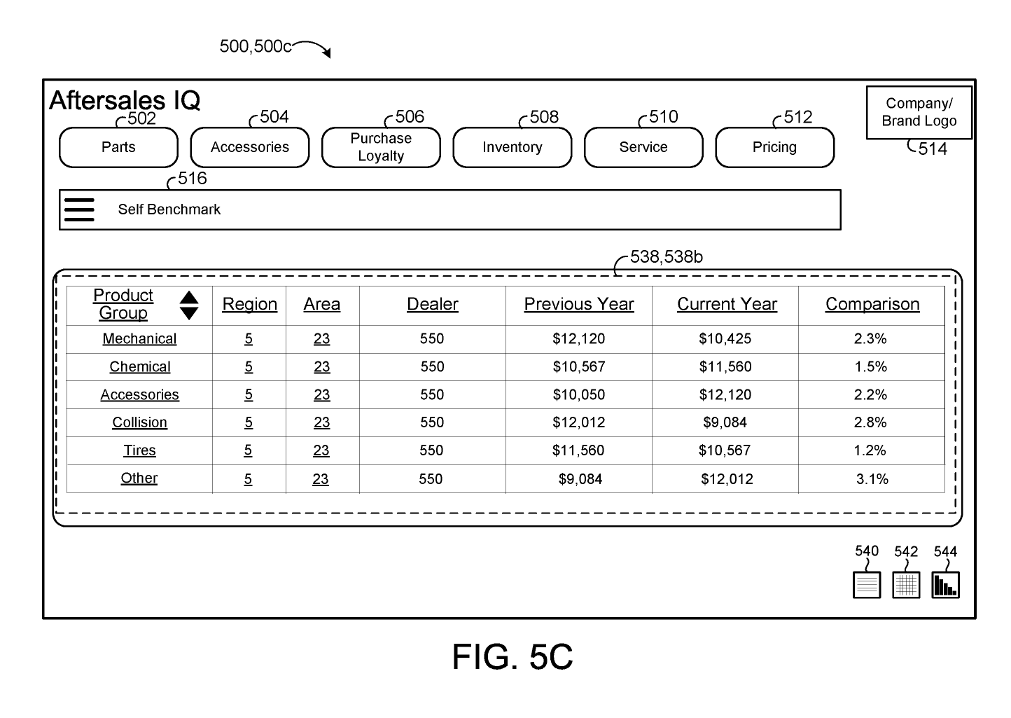

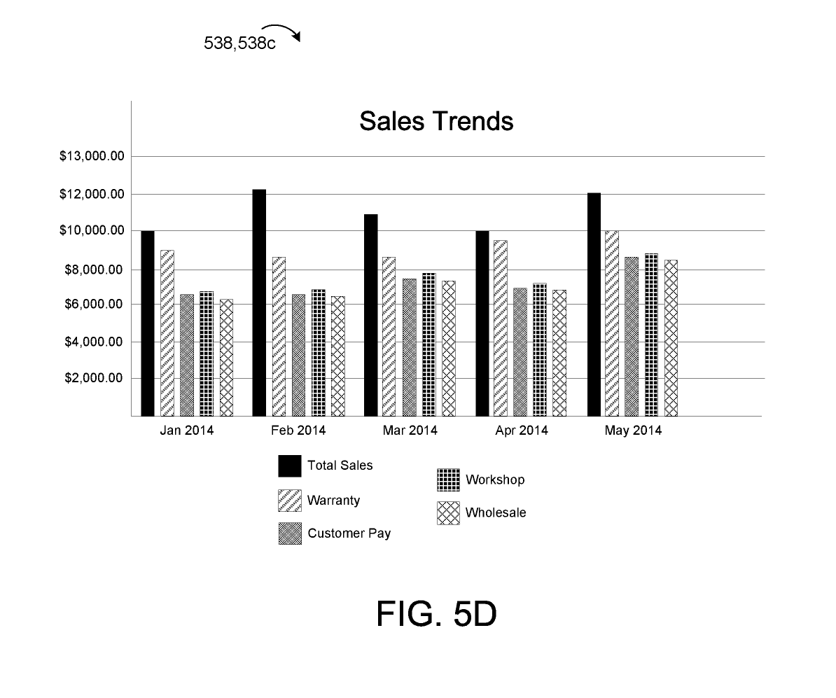

Referring to FIGS. 5A-5C, in some implementations, once the system 100 authenticates a user 20, 30 and determines the access level of the user 20, 30, the system 100 displays on a display 26, 116, 206 a main screen 500a. The main screen 500 displays custom menus, navigation elements and icons. Referring to FIG. 5A, in some implementations, the main screen 500a includes a parts button 502, an accessories button 504, a purchase loyalty button 506, an inventory button 508, a service button 510, and a pricing button 512. A user 20, 30 may select any one of the buttons 502-512 to view the available reports 154 that relate to the selected button 502-512. In some implementations, the user 20, 30 may hover over the button 502-512 and a list of the available reports 154 relating to the hovered over button appears, allowing the user 20, 30 to make a selection of which report 152 to view. Once the user 20, 30 selects the report 152 that he or she wants to view, the report name appears in block 516 and the report 152 is displayed as shown in FIGS. 5B-5D. In some examples, the system 100 displays a logo 514 or the brand name of the brand 32 of products 34 (e.g., vehicles) that are sold or the brand or name of the seller 20 selling the products 34.

Referring to FIG. 5B, in some examples, the system allows the user 20, 30 to search for specific information within a selected report 516 in a search screen 500b. For example, the user 20, 30 may enter a dealer code 518, a dealer name 520, a region 522, an area 524, a date range 526, a product group 528 (e.g., parts group), a major tactical segment 530, or a minor tactical segment 532. In some examples, the listed selections include a drop down menu 523 allowing the user 20, 30 to make a selection from a predetermined menu rather than entering data. Once the user 20, 30 enters the search criteria 518-532, the user 20, 30 may select a Search button 534 allowing the system 100 to search and display the search results 538, or a Reset button 536 that clears the user entered search criteria 518-532.

In some implementations, the search screen 500b includes one or more buttons 540, 542, 544 that display the search information in different ways. For example, a first button 540 may display the report 152 in a report format, a second button 542 may display the report 152 in a list format, and a third button 544 may display the report 152 in a chart format. Other report formats may be possible as well. In some examples, the report is a Tabular report display, purely a numerical view of the system's results for a given time period. These reports allow the user 20, 30 to traverse down to the lowest level of detail and inversely back up to the highest level (using bread crumbs). These reports feature export options. The system may display Trend reports as bar charts with Time following the X axis of the illustration. These reports can show one or many metrics for a single dimension see results 538c in FIG. 5D. Another type of report is the Heat Map Reports (or Benchmarking) see benchmark screen 500c (FIG. 5C), which shows the performance of one specific seller 20 (Region, Area or Dealer) versus the performance against their respective peer groups. If the point being benchmarked is performing better than the peer group, the peer will be highlighted green and inversely if they are performing worse it will be highlighted in red. Yet another report type may be the Dashboard Report, which is the highest graphical representation of the key metric. These illustrations give a quick visual representation of how a metric is performing.

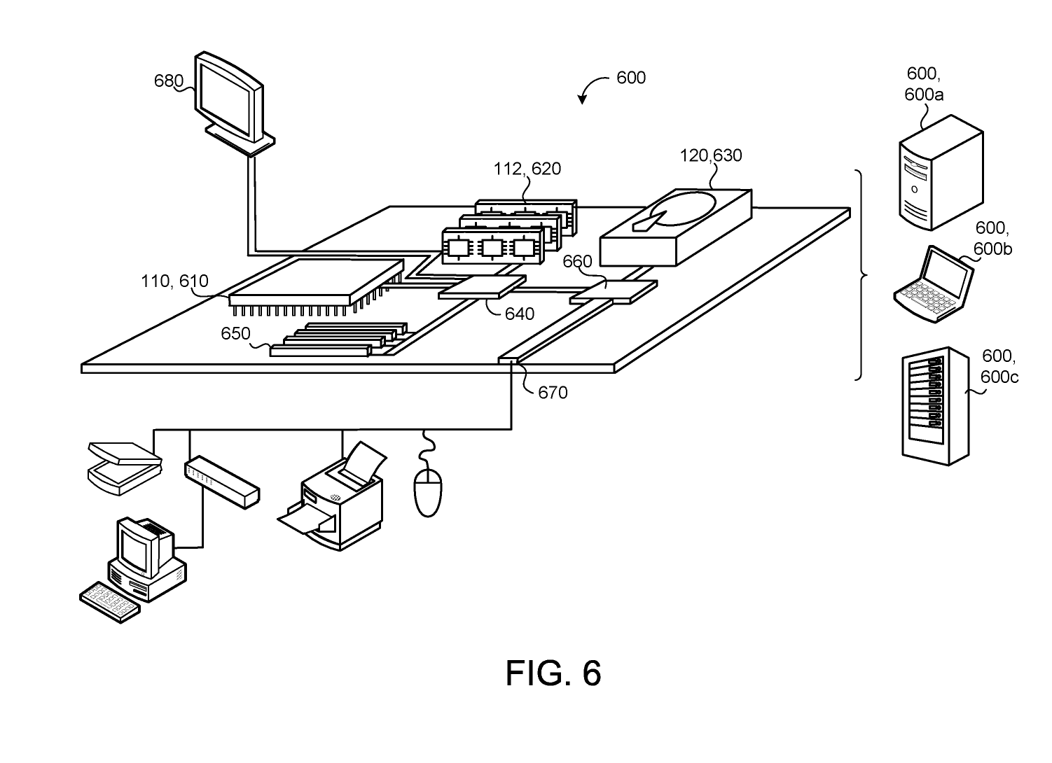

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to the low speed bus 670 and storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 112, 620 or on the storage device 120, 630 to display graphical information for a graphical user interface (GUI) on an external input/output device, such as a display 680 coupled to a high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 112, 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 120, 630 is capable of providing mass storage for the computing device 600. In some implementations, the storage device 120, 630 is a computer-readable medium. In various different implementations, the storage device 120, 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 112, 620, the storage device 120, 630, or memory on processor 110, 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and low-speed expansion port 670. The low-speed expansion port 670, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in FIG. 6. For example, it may be implemented as a standard server 600 or multiple times in a group of such servers 600a, as a laptop computer 600b, or as part of a rack server system 600c.

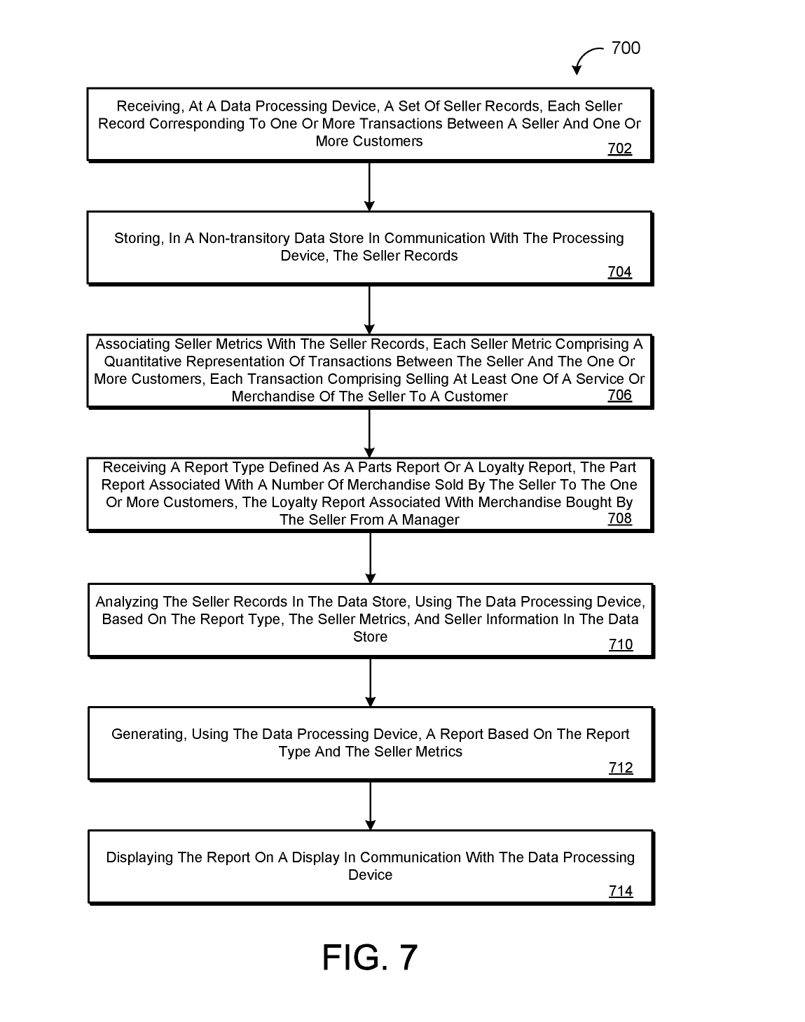

Referring to FIG. 7, in some implementations, the method 700 analyzes seller transactional data 210 and displays them on a display 116, 206. At block 702, the method 700 includes receiving, at a data processing device 110, 610, a set of seller records 220 (i.e., seller transactional data). Each seller transactional data or seller record 220 includes one or more transactions between a seller 20 and one or more customers 10 (e.g., transactional data 210). At block 704, the method 700 includes storing, in a non-transitory data store 112, 120, 620, 630 in communication with the processing device 110, 610, the seller transactional data 220. At block 706, the method 700 includes associating seller metrics 352-374 with the seller transactional data 220, each seller metric 352-374 includes a quantitative representation of transactions between the seller 20 and the one or more customers 10. Each transaction is associated with transactional information 210 (including sales information 212 and service information 214) and includes selling at least one of a service or merchandise (e.g., product 34, part 36, accessories 38) of the seller 20 to a customer 10. At block 708, the method 700 includes receiving, at the data processing device 110, 610, a report type 154 defined as a parts report 154a or a loyalty report 154b, the parts report 154a associated with a number of merchandise sold by the seller 20 to the one or more customers 10, the loyalty report 154b associated with merchandise bought by the seller 20 from a manager 30. At block 710, the method 700 includes analyzing the seller transactional data 220 in the data store 112, 120, 620, 630, using the data processing device 110, 610, based on the report type 154, the seller metrics 352-374, and seller information (e.g., internal seller data 240) in the data store 112, 120, 620, 630. At block 712, the method 700 includes generating, using the data processing device 110, 610, a report based on the report type 154 and the seller metrics 352-374. Finally, at block 714, the method 700 includes displaying the report 152 on a display 116, 206 in communication with the data processing device 110, 610.

In some implementations, the method 700 includes receiving, at the processing device 110, 610, a user name and a password; and authenticating the user name and password by comparing the user name and password with a user name and password previously stored in the data store 112, 120, 620, 630. The method 700 may also include determining a report type 154 based on the user name and password.

The method 700 may group the seller records 220 into modules 310, 312-326. The modules 310, 312-326 are defined as categorizing seller records 220 based on one or more metrics 352-374. In some implementations, the merchandise includes vehicles 34, vehicle parts 36, and vehicle accessories 38, and the seller 20 is a vehicle dealership. The merchandise may be associated with one or more vehicle brands 32. In some examples, the method 700 further includes analyzing the seller transactional data 220 in the data store 112, 120, 620, 630, using the data processing device 110, 610, based on one or more dimensions 330, 332-340, the dimensions 330, 332-340 defined as data elements categorizing the seller metrics 352-374 of the seller transactional data 220 into non-overlapping regions.

In some implementations, the existing seller information (e.g., internal seller data 240) defines information associated with the seller 20. The existing seller information 240 includes at least one of: seller master data 242 including a seller name and a seller address; a seller purchase objective 244 defining an amount of sales within a period of time; a part master file 246 defining vehicle part numbers; a part item categories file 248; a seller purchases file 250 defining purchases made by the seller 20 from the manager 30 based on a monetary value; a seller parts number purchase file 252 defining the part numbers, quantities, and pricing; a seller vehicle-in-operation 254 file defining a number of vehicles sold by the seller 20 to customers 10 that are on the road; an area and region master file 256 defining area and region codes associated with seller locations; or a tactical segment master file 258 defining merchandise classification. In some examples, the loyalty reports 154b includes at least one of: a comparison of sales of a first seller 20 and sales of a second seller 20 during a time period, a region, or an area; a comparison of sales of a seller 20 during a first time period and a second time period; or a comparison of sales of a seller 20 of a first merchandise and a second merchandise. The parts report 154a may include a total number of sales corresponding to at least one of: a period of time, a seller geographical region; or a specific brand.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a data processing device, a set of seller records, each seller record corresponding to one or more transactions between a seller and one or more customers;
storing, in a non-transitory data store in communication with the processing device, the seller records;
associating seller metrics with the seller records, each seller metric comprising a quantitative representation of transactions between the seller and the one or more customers, each transaction comprising selling at least one of a service or merchandise of the seller to a customer;
receiving, at the data processing device, a report type defined as a parts report or a loyalty report, the parts report associated with a number of merchandise sold by the seller to the one or more customers, the loyalty report associated with merchandise bought by the seller from a manager;
analyzing the seller records in the data store, using the data processing device, based on the report type, the seller metrics, and seller information in the data store;
generating, using the data processing device, a report based on the report type and the seller metrics; and
displaying the report on a display in communication with the data processing device.

2. The method of claim 1, further comprising:
receiving, at the processing device, a user name and a password;
authenticating the user name and password by comparing the user name and password with a user name and password previously stored in the data store; and
determining a report type based on the user name and password.

3. The method of claim 1, further comprising grouping the seller records into modules, the modules defined as categorizing seller records based on one or more metrics.

4. The method of claim 1, wherein the merchandise includes vehicles, vehicle parts, and vehicle accessories, and the seller is a vehicle dealership.

5. The method of claim 4, wherein the merchandise is associated with one or more vehicle brands.

6. The method of claim 1, further comprising analyzing the seller records in the data store, using the data processing device, based on one or more dimensions, the dimensions defined as data elements categorizing the seller metrics of the seller records into non-overlapping regions.

7. The method of claim 1, wherein the seller information defines information associated with the seller, the seller information including at least one of:
seller master data including a seller name and a seller address;
a seller purchase objective defining an amount of sales within a period of time;
a part master file defining vehicle part numbers;
a part item categories file;
a seller purchases file defining purchases made by the seller from the manager;
a seller vehicle-in-operation file defining a number of vehicles sold by the seller to customers that are on the road;
an area and region master file defining area and region codes associated with seller locations; or
a tactical segment master file defining merchandise classification.

8. The method of claim 1, wherein the loyalty report comprises at least one of:
a comparison of sales of a first seller and sales of a second seller during a time period, a region, or an area;
a comparison of sales of a seller during a first time period and a second time period; or
a comparison of sales of a seller of a first merchandise and a second merchandise.

9. The method of claim 1, wherein the parts report comprises a total number of sales corresponding to at least one of: a period of time, a seller geographical region; or a specific brand.

10. A system comprising:
a non-transitory data store; and
a data processing device in communication with the data store, the data processing device executing a set of instructions that cause the data processing device to:
receive a set of seller records, each seller record corresponding to one or more transactions between a seller and one or more customers;
store the seller records in the data store;
associate seller metrics with the seller records, each seller metric comprising a quantitative representation of transactions between the seller and the one or more customers, each transaction comprising selling at least one of a service or merchandise of the seller to a customer;
receive a report type defined as a parts report or a loyalty report, the part report associated with a number of merchandise sold by the seller to the one or more customers, the loyalty report associated with merchandise bought by the seller from a manager;
analyze the seller records in the data store based on the report type, the seller metrics, and seller information in the data store;
generate a report based on the report type and the seller metrics; and
displaying the report on a display in communication with the data processing device.

11. The system of claim 10, wherein the data processing device:
receives a user name and a password;
authenticates the user name and password by comparing the user name and password with a previously stored user name and password; and
determines a report type based on the user name and password.

12. The system of claim 10, wherein the data processing device groups the seller records into modules, the modules defined as categorizing seller records based on one or more metrics.

13. The system of claim 10, wherein the merchandise includes vehicles, vehicle parts, and vehicle accessories, and the seller is a vehicle dealership.

14. The system of claim 13, wherein the merchandise is associated with one or more vehicle brands.

15. The system of claim 10, wherein the data processing device analyzes the seller records in the data store, using the data processing device based on one or more dimensions, the dimensions defined as data elements categorizing the seller metrics of the seller records into non-overlapping regions.

16. The system of claim 10, wherein the seller information defines information associated with the seller, the seller information includes at least one of:
a seller master data defining one or more seller information including a seller name and a seller address;
seller purchase objective defining an amount of sales within a period of time;
a part master file defining vehicle part numbers; part item categories file;
a seller purchases file defining purchases made by the seller from the manager;
seller vehicle-in-operation file defining a number of vehicles sold by the seller to customers that are on the road;
area and region master file defining area and region codes associated with seller locations; or
tactical segment master file defining merchandise classification.

17. The system of claim 10, wherein the loyalty report comprises at least one of:
a comparison of sales of a first seller and sales of a second seller during a time period, a region, or an area;
a comparison of sales of a seller during a first time period and a second time period; or
a comparison of sales of a seller of a first merchandise and a second merchandise.

18. The system of claim 10, wherein the parts report comprises a total number of sales corresponding to at least one of: a period of time, a seller geographical region; or a specific brand.
